(19) United States
(12) Patent Application Publication
(10) Pub. No.: US 2023/0399565 A1
(43) Pub. Date: Dec. 14, 2023

(54) POLYMER DYES AND USES THEREOF

(71) Applicant: Beckman Coulter, Inc., Brea, CA (US)

(72) Inventors: Massimiliano Tomasulo, Miami, FL (US); Mukesh Mudgal, Miami, FL (US); Arunkumar Easwaran, Miami, FL (US); Sergei Gulnik, San Jose, CA (US)

(21) Appl. No.: 18/207,983

(22) Filed: Jun. 9, 2023

Related U.S. Application Data
(60) Provisional application No. 63/350,798, filed on Jun. 9, 2022.

(51) Int. Cl. C09K 11/06

(52) U.S. Cl. CPC C09K 11/06; C09K 2211/1011

(57) ABSTRACT

The present disclosure provides fused dihydrophenanthrene (DHP) monomers and fluorescent fused DHP polymers, water-soluble fluorescent polymers and copolymers, water-soluble fluorescent polymer complexes, and their use in methods for detecting an analyte in a sample.

### CROSS-REFERENCES TO RELATED APPLICATIONS

This application claims the benefit of priority to U.S. Provisional Application No. 63/350,798 filed Jun. 9, 2022, which is herein incorporated by reference in its entirety.

### FIELD OF THE DISCLOSURE

This disclosure relates to fused dihydrophenanthrene (DHP) fluorescent monomers and polymers, water-soluble fused DHP fluorescent polymers, water-soluble fused DHP tandem fluorescent polymers, water-soluble fused DHP fluorescent polymer complexes, water-soluble fused DHP tandem fluorescent polymer complexes, and their use in methods for detecting analytes in a biological sample.

### BACKGROUND OF THE DISCLOSURE

Water-soluble fluorescent polymers can be used in a variety of biological applications by generating signals in response to laser light excitation which can be monitored in real time and provide simple and rapid methods for the detection of biological targets and events.

Brightness of a dye is an overall contribution from the extinction coefficient (ε, measure of the amount of light absorbed at a particular wavelength) and fluorescence quantum yield (Φ, measure of the light emitted in the form of radiation from its singlet excited state). Many of the reported organic violet dyes such as coumarin, BODIPY, cyanine, squaraine, etc. are single molecules and show relatively low extinction coefficient in the range of 10,000-70,000 M⁻¹ cm⁻¹ at 405 nm. It has been shown that molecules having multiple chromophores exhibit higher ε value due to the overall contribution from different chromophores. There are various reports on dendrimeric, polymeric backbone and other scaffold approaches where a single molecule contains multiple chromophores.

Many reported polymeric dyes are hydrophobic and were first applied in material applications such as light emitting diodes, solar cells, flat panel displays, etc. Further efforts in polymeric dye technology have targeted improving compatibility with aqueous conditions, dye brightness, and refining spectra properties for additional uses. There is a need for water-soluble fluorescent polymers for biological applications which are excitable with, for example, a laser in the range of 355 nm to 405 nm, for example, a 405 nm or a 355 nm laser. Therefore, identification of novel water-soluble polymeric cores is needed to expand the availability of water-soluble polymeric dyes for use in biological applications, including for the detection of analytes and use in diagnostic kits, etc.

The present disclosure addresses these and other disadvantages of prior art polymers and complexes and methods for detecting analytes in a sample.

### SUMMARY OF THE DISCLOSURE

The present disclosure generally provides novel, water-soluble fluorescent polymers, water-soluble fluorescent polymer tandems, water-soluble fluorescent polymers conjugated to a specific binding partner, their complexes, and methods for detecting analytes in a sample using the complexes comprising the water-soluble DHP fluorescent polymers conjugated to a binding partner.

This disclosure provides a fluorescent polymer comprising at least one monomer or co-monomer having a structure of any one of Formula (A1)-(A6):

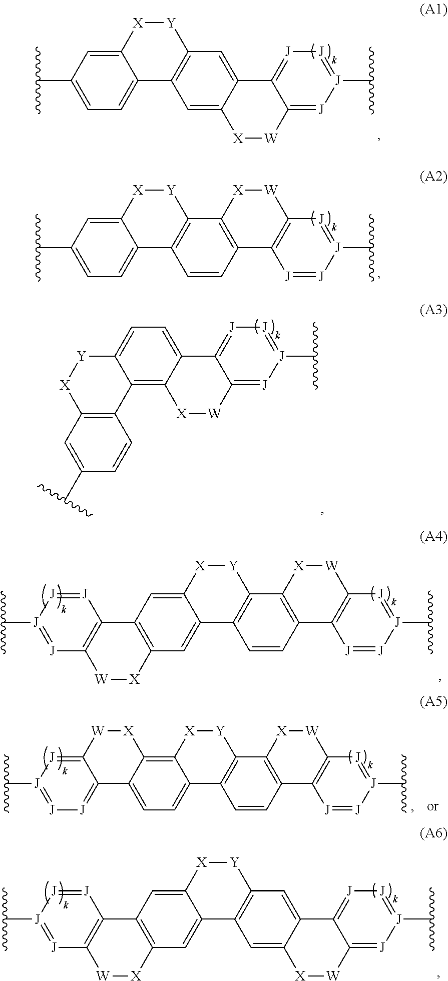

wherein
each [symbol] in A1-A6 is a site for covalent attachment to the unsaturated backbone of the fluorescent polymer, such as any other component of the polymer described in Formula (I);
each X is independently selected from the group consisting of CH₂, CR¹R², CHR¹, CR², X′R¹R², NH, NR¹, O, S, SO, SO₂, SONHR², PR⁷, PO(R⁷)₂, POR², P(O)OH, PONHR², and SiR¹R²;
each Y is independently selected from the group consisting of CH₂, CR¹R², CHR¹, CR², X′R¹R², NH, NR¹, O, S, SO, SO₂, SONHR², PR⁷, PO(R⁷)₂, POR², P(O)OH, PONHR², and SiR¹R²;
each X′ is independently selected from the group consisting of a C and Si;
each W is independently selected from the group consisting of a covalent bond and Y; when W is a bond X is directly bonded to both rings;
and at least one of W, X, or Y comprises a water-solubilizing moiety;
each J is independently selected from the group consisting of CH, N, NH, S, O, Se, and Si;
each R¹ is independently selected from the group consisting of a water-solubilizing moiety, alkyl, alkene, alkyne, cycloalkyl, haloalkyl, (hetero)aryloxy, (hetero)arylamino, aryl, heteroaryl, a PEG group, carboxylic acid, ammonium alkyl salt, ammonium alkyloxy salt, ammonium oligoether salt, sulfonate alkyl salt, sulfonate alkoxy salt, sulfonate oligoether salt, sulfonamido oligoether, sulfonamide, sulfinamide, phosphonamidate, phosphinamide,

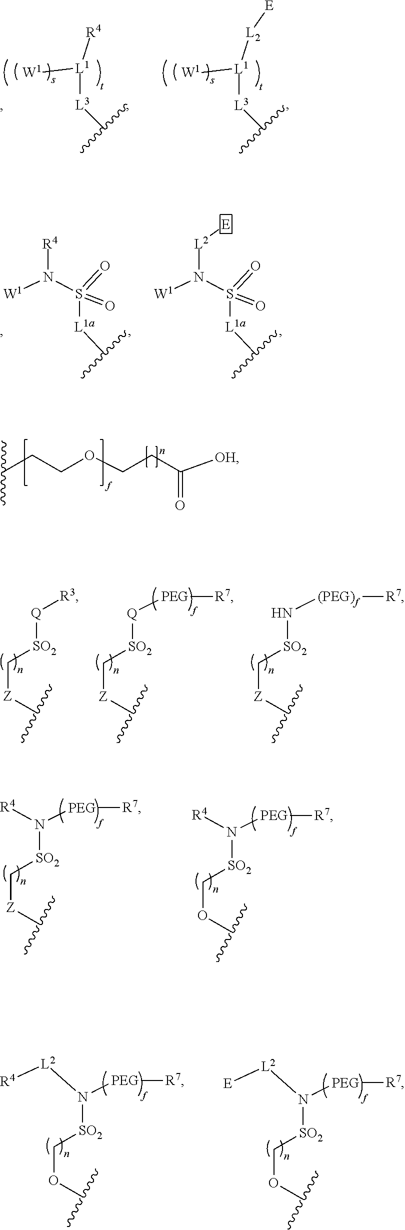

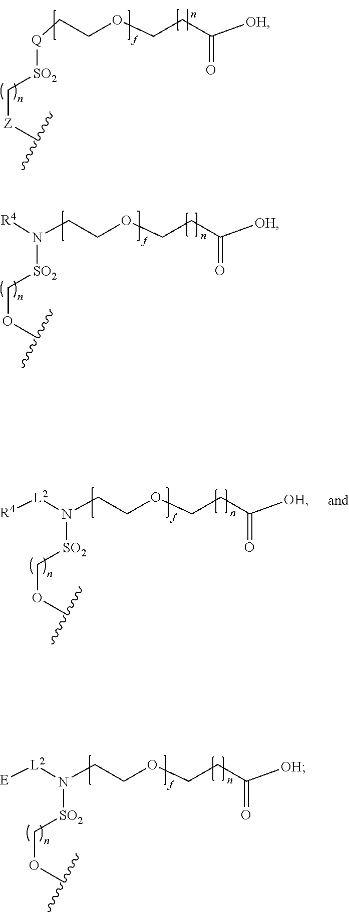

each R² is independently selected from the group consisting of a water-solubilizing moiety, a linker moiety, hydrogen, alkyl, alkene, alkyne, cycloalkyl, haloalkyl, (hetero)aryloxy, aryl, heteroaryl, (hetero)arylamino, sulfonamide-PEG, phosphoramide-PEG, ammonium alkyl salt, ammonium alkyloxy salt, ammonium oligoether salt, sulfonate alkyl salt, sulfonate alkoxy salt, sulfonate oligoether salt, sulfonamido oligoether, sulfonamide, sulfinamide, phosphonamidate, phosphinamide,

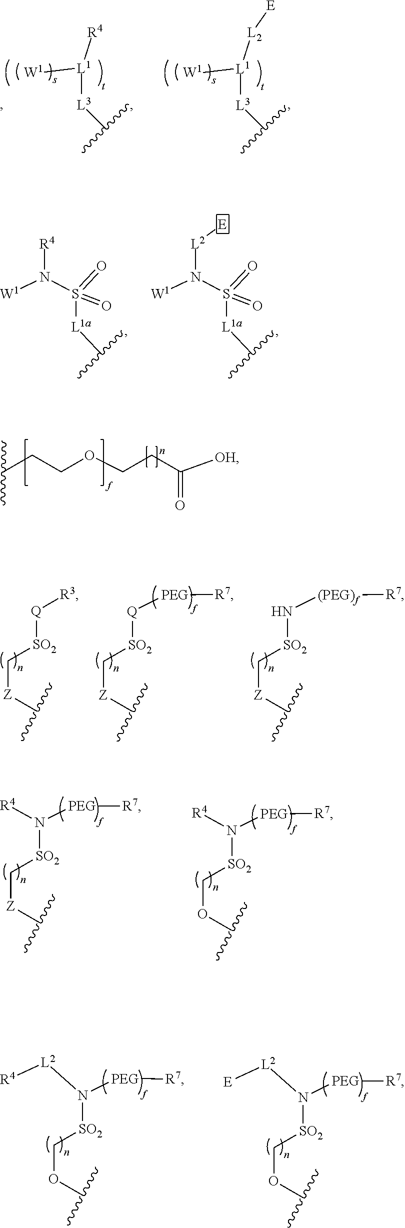

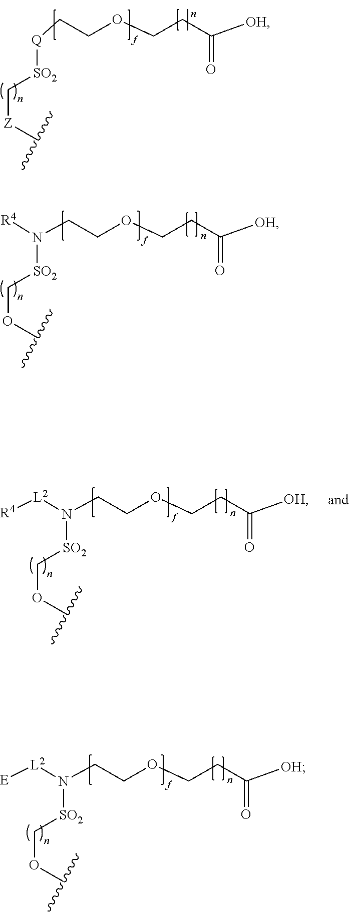

each R³ is independently a water-solubilizing moiety;
Q is a bond, NR⁴, CHR⁴, or —CH₂;
Z is CH₂, O, CHR⁴, or NR⁴;
R⁴ is H, alkyl, PEG, a water-solubilizing moiety, a linked water-solubilizing moiety, a linker moiety, a chromophore, a linked chromophore, a binding partner, a linked binding partner, functional moiety, a linked functional moiety, a PEG group, a linked PEG group, L²-E, carboxylic amine, amine, carbamate, carboxylic acid, carboxylate ester, maleimide, activated ester, N-hydroxysuccinimidyl, hydrazine, hydrazide, hydrazone, azide, alkyne, alkene, tetrazine, aldehyde, thiol, or protected groups thereof;
W¹ is a water-solubilizing moiety;
L¹, L², and L³ are linker moieties;
E is an independently selected chromophore, functional moiety, substrate or binding partner;
each R⁷ is independently selected from the group consisting of H, hydroxyl, C₁-C₁₂ alkyl, C₂-C₁₂ alkene, C₂-C₁₂ alkyne, C₃-C₁₂ cycloalkyl, C₁-C₁₂ haloalkyl, C₁-C₁₂ alkoxy, C₂-Cis (hetero)aryloxy, C₂-C₁₅ (hetero)arylamino, C₂-C₁₂ carboxylic acid, C₂-C₁₂ carboxylate ester, and C₁-C₁₂ arylalkyloxy;
at least one of R¹, R², R³, or R⁴ comprises a water-solubilizing moiety;
each f is independently an integer from 0 to 50;
each k is independently 0, 1, or 2;
each n is independently an integer from 1 to 20;
s is 1 or 2; and
t is 0, 1, 2, or 3.

Each linker moiety may independently be selected from the group consisting of L¹, L², and L³.

Linking moieties L¹, L², and L³ may independently be, but are not limited to, a covalent bond, C₁₋₈ alkylene, 2- to 8-membered heteroalkylene. In some embodiments, the linker is a single atom, a linear chain, a branched chain, a cyclic moiety. In some embodiments, the linker is chain of between 2 and 100 backbone atoms (e.g., carbon atoms) in length, such as between 2 and 50 backbone atoms in length or between 2 and 20 atoms backbone atoms in length. In certain cases, one, two, three, four or five or more carbon atoms of a linker backbone can be optionally replaced with sulfur, nitrogen, or oxygen. The bonds between backbone atoms can be saturated or unsaturated; typically, not more than one, two, or three unsaturated bonds will be present in a linker backbone. The linker can include one or more substituent groups (e.g., an alkyl group or an aryl group). A linker can include, without limitation, oligo(ethylene glycol); ethers; thioethers; tertiary amines; and alkylene groups (i.e., divalent alkyl radicals), which can be straight or branched. The linker backbone can include a cyclic group, for example, a divalent aryl radical, a divalent heterocyclic radical, or a divalent cycloalkyl radical, where 2 or more atoms, e.g., 2, 3, or 4 atoms, of the cyclic group are included in the backbone.

In some embodiments, L¹ comprises a sulfonamide, a sulfonimide, a sultam, a disulfinamide, an amide, a phosphonamide, a phosphonamidate, a phosphinamide, a selenoonamide, a seleninamde, or a secondary amine. In some embodiments, L¹ comprises a sulfonamide, an amide, a phosphonamide, or a secondary amine. In some cases, L¹ is a linker moiety optionally terminated with L²-E. In some cases, L² comprises a linear or branched, saturated or unsaturated C₁₋₃₀ alkylene group; wherein one or more carbon atoms in the C₁₋₃₀ alkylene group is optionally and independently replaced by O, S, NR^{a}; wherein two or more groupings of adjacent carbon atoms in the C₁₋₃₀ alkylene are optionally and independently replaced by —NR^{a}(CO)— or —(CO)NR^{a}—; and wherein each R^{a} is independently selected from H and C₁₋₆ alkyl; and wherein each R^{a} is independently selected from H and C₁₋₆ alkyl.

In some embodiments, L² is a linker moiety optionally terminated with a functional moiety selected from amine, carbamate, carboxylic acid, carboxylate, maleimide, activated ester, N-hydroxysuccinimidyl, hydrazine, hydrazide, hydrazone, azide, alkyne, aldehyde, thiol, and protected groups thereof, optionally for conjugation to a chromophore, substrate, or a binding partner;

In some embodiments, L³ is selected from the group consisting of a covalent bond, C₁₋₈ alkylene, 2- to 8-membered heteroalkylene (e.g., a divalent alkoxy linker such as —O-alkyl), C₃₋₈ cycloalkylene, C₆₋₁₀ arylene, 5- to 12-membered heteroarylene, 5- to 12-membered heterocyclylene, an amine, —NHC(O)L^{a}-, —C(O)NHL^{a}-, —C(O)L^{a}-, and combinations thereof, wherein L^{a} is selected from the group consisting of C₁₋₈ alkylene and 2- to 8-membered heteroalkylene.

In some cases, L¹, L² and L³ together form the following:

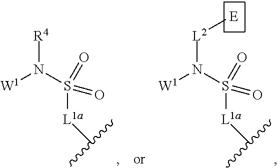

wherein L^{1a} is a linker moiety.

In some cases, L^{1a} is selected from the group consisting of a covalent bond, C₁₋₈ alkylene, 2- to 8-membered heteroalkylene (e.g., a divalent alkoxy linker), C₃₋₈ cycloalkylene, C₆₋₁₀ arylene, 5- to 12-membered heteroarylene, 5- to 12-membered heterocyclylene, —NHC(O)L^{a}-, —C(O)NHL^{a}-, —C(O)L^{a}-, and combinations thereof, wherein L^{a} is selected from the group consisting of C₁₋₈ alkylene and 2- to 8-membered heteroalkylene In some embodiments, L^{1a} is selected from the group consisting of a covalent bond, C₁₋₈ alkylene, 2- to 8-membered heteroalkylene, —NHC(O)L^{a}-, —C(O)NHL^{a}-, and —C(O)L^{a}-.

In some embodiments, L³ is a trivalent arylalkyl moiety having: a first point of attachment to a first L¹ moiety (or a first L^{1a} moiety); a second point of attachment to a second L¹ moiety (or a second L^{1a} moiety); and a third point of attachment to an A monomer. For example, some embodiments of the disclosure provide conjugated polymers having two or more E groups, such as chromophores, attached as shown in Formula (L³-1):

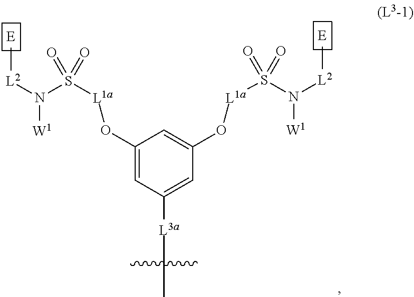

wherein L^{3a} is selected from the group consisting of a covalent bond, C₁₋₈ alkylene, 2- to 8-membered heteroalkylene, —NHC(O)L^{a}-, —C(O)NHL^{a}-, and —C(O)L^{a}-; L^{1a} is C₁₋₈ alkylene or 2- to 8-membered heteroalkylene; and the wavy line is the point of the attachment to the A monomer.

In some embodiments, each E is an independently selected chromophore (e.g., and independently selected fluorophore). In some embodiments, all of the E moieties in the polymer have the same fluorophore structure.

In some embodiments, W¹ is a water solubilizing moiety selected from ethylene glycol, PEG groups, carboxy groups including but not limited to carboxylic acids and carboxylates, polyvinyl alcohols, glycols, peptides, polyphosphates, polyalcohols, sulfonates, phosphonates, boronates, amines, ammoniums, sulfoniums, phosphonium, alcohols, polyols, oxazolines, zwitterionic derivatives, carbohydrates, nucleotides, polynucleotides, substituted PEG groups, substituted carboxy groups including but not limited to substituted carboxylic acids and substituted carboxylates, substituted glycols, substituted peptides, substituted polyphosphates, substituted polyalcohols, substituted sulfonates, substituted phosphonates, substituted boronates, substituted amines, substituted ammoniums, substituted sulfoniums, substituted phosphonium, alcohols, substituted zwitterionic derivatives, substituted carbohydrates, substituted nucleotides, substituted polynucleotides, or combinations thereof.

In some cases, W¹ comprises one or more ethylene glycol monomers. In some cases, W comprises PEG.

The fluorescent polymer can be water-soluble.

The disclosure provides a fluorescent tandem polymer comprising a fluorescent polymer comprising:
at least one monomer or co-monomer having a structure of Formula (A1)-(A6):

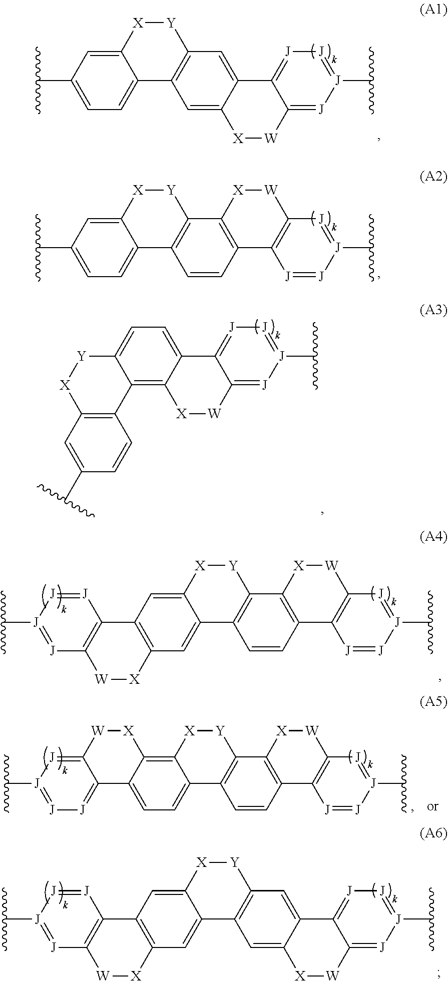

and
a signaling chromophore covalently linked to the polymeric dye in energy-receiving proximity therewith,
wherein each [symbol] in A1-A6 is a site for covalent attachment to the unsaturated backbone of the fluorescent polymer; and
   X, Y, W, J, and k are as previously defined.

In some embodiments, the fluorescent polymer tandem polymer can be water-soluble. In some embodiments, the fluorescent tandem polymer may comprise a specific binding partner covalently linked to the polymer.

The disclosure provides a labeled specific binding partner, comprising a fluorescent polymer comprising:
at least one monomer or co-monomer having a structure of Formula (A1)-(A6):

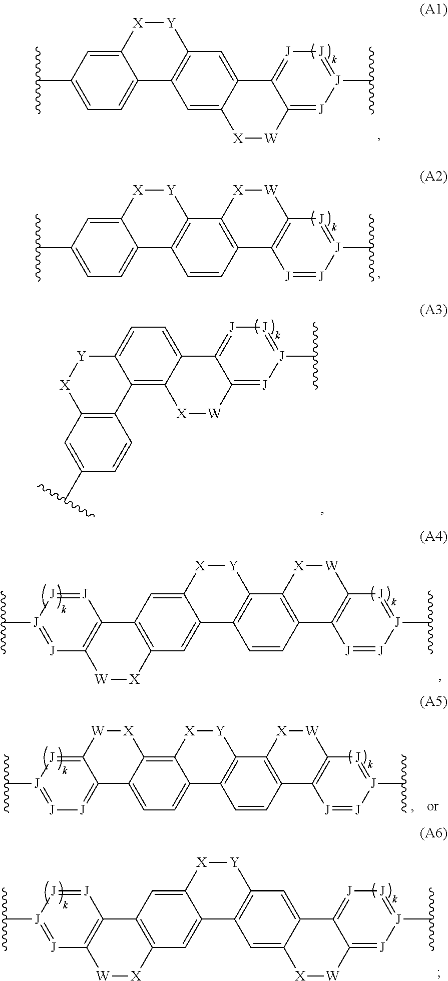

and
a specific binding partner covalently linked to the polymer,
wherein each [symbol] in A1-A6 is a site for covalent attachment to the unsaturated backbone of the fluorescent polymer; and
wherein X, Y, W, J, and k are as previously defined.

In some embodiments, the specific binding partner may comprise a polymer that is water soluble. In some embodiments, the specific binding partner may comprise a polymer that is a fluorescent tandem polymer.

The present disclosure provides a fluorescent polymer having the structure of Formula (I):

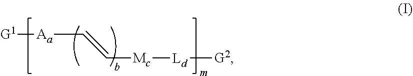

wherein:
A is selected from the group consisting of

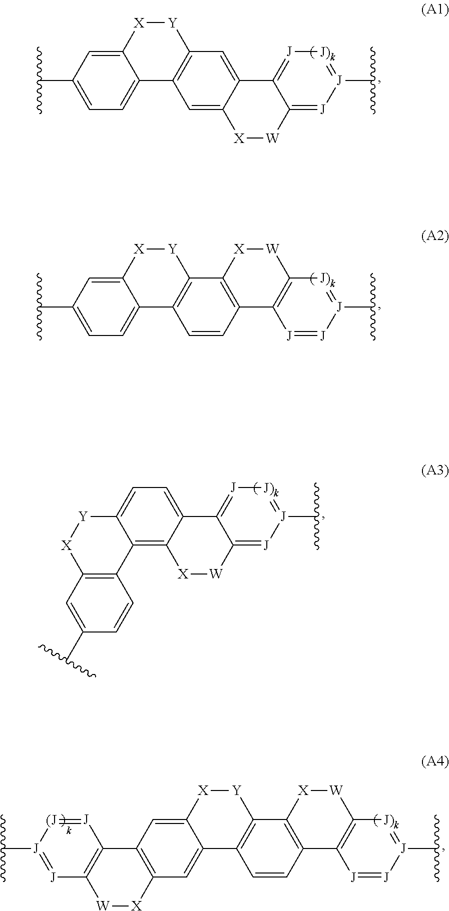

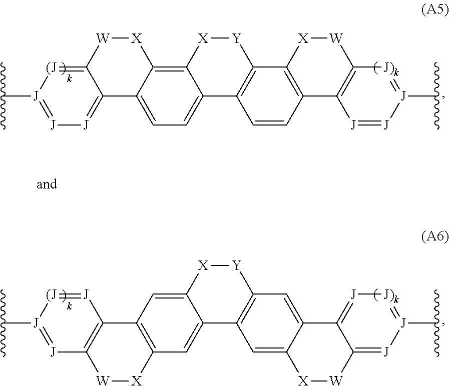

wherein
each [symbol] in A1-A6 is a site for covalent attachment to any other component of the polymer described in Formula (I);
X, Y, W, J, and k are as previously defined;
each optional L is a linker;
each optional M is a polymer modifying unit evenly or randomly distributed along the polymer main chain and is optionally substituted with one or more optionally substituted R¹, R², R³, or R⁴ groups;
G¹ and G² are each independently selected from an unmodified polymer terminus and a modified polymer terminus, optionally conjugated to E;
a, c, and d define the mol % of each unit within the structure which each can be evenly or randomly repeated and where each a is a mol % from 10 to 100%, each c is a mol % from 0 to 90%, and each d is a mol % from 0 to 25%;
each b is independently 0 or 1;
m is an integer from 1 to about 10,000.

The fluorescent polymer having the structure of Formula (I) may be a water-soluble fluorescent polymer.

In some embodiments, G¹ and G² are each independently selected from the group consisting of hydrogen, halogen, alkyne, optionally substituted aryl, optionally substituted heteroaryl, halogen substituted aryl, silyl, diazonium salt, triflate, acetyloxy, azide, sulfonate, phosphate, boronic acid substituted aryl, boronic ester substituted aryl, boronic ester, boronic acid, optionally substituted tetrahydropyrene (THP), optionally substituted fluorene, optionally substituted dihydrophenanthrene (DHP), aryl or heteroaryl substituted with one or more pendant chains terminated with a functional moiety selected from amine, carbamate, carboxylic acid, carboxylate, maleimide, activated ester, N-hydroxysuccinimidyl, hydrazine, hydrazide, hydrazone, azide, alkyne (e.g., cycloakyne), alkene (e.g., cycloalkene), tetrazine, aldehyde, thiol, and protected groups thereof for conjugation to a substrate, or a binding partner.

In some embodiments, each optional linker L is independently selected from the group consisting of an aryl or heteroaryl group evenly or randomly distributed along the polymer main chain and that is substituted with one or more pendant chains terminated with a functional group selected from amine, carbamate, carboxylic acid, carboxylate, maleimide, activated ester, N-hydroxysuccinimidyl, hydrazine, hydrazide, hydrazone, azide, alkyne, alkene, tetrazine, aldehyde, thiol, and protected groups thereof optionally conjugated to E.

In some embodiments, each optional L is a linker independently selected from the group consisting of:

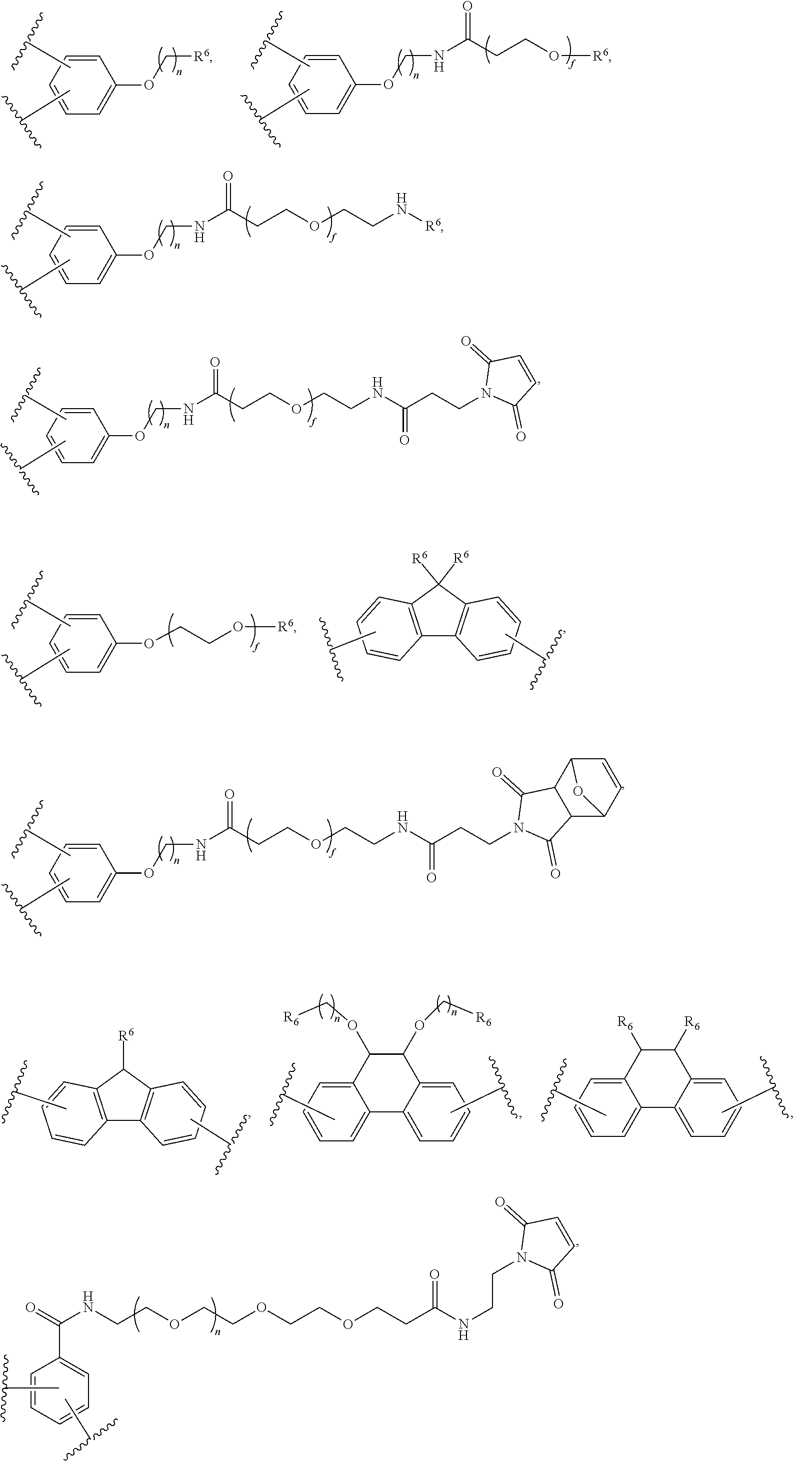

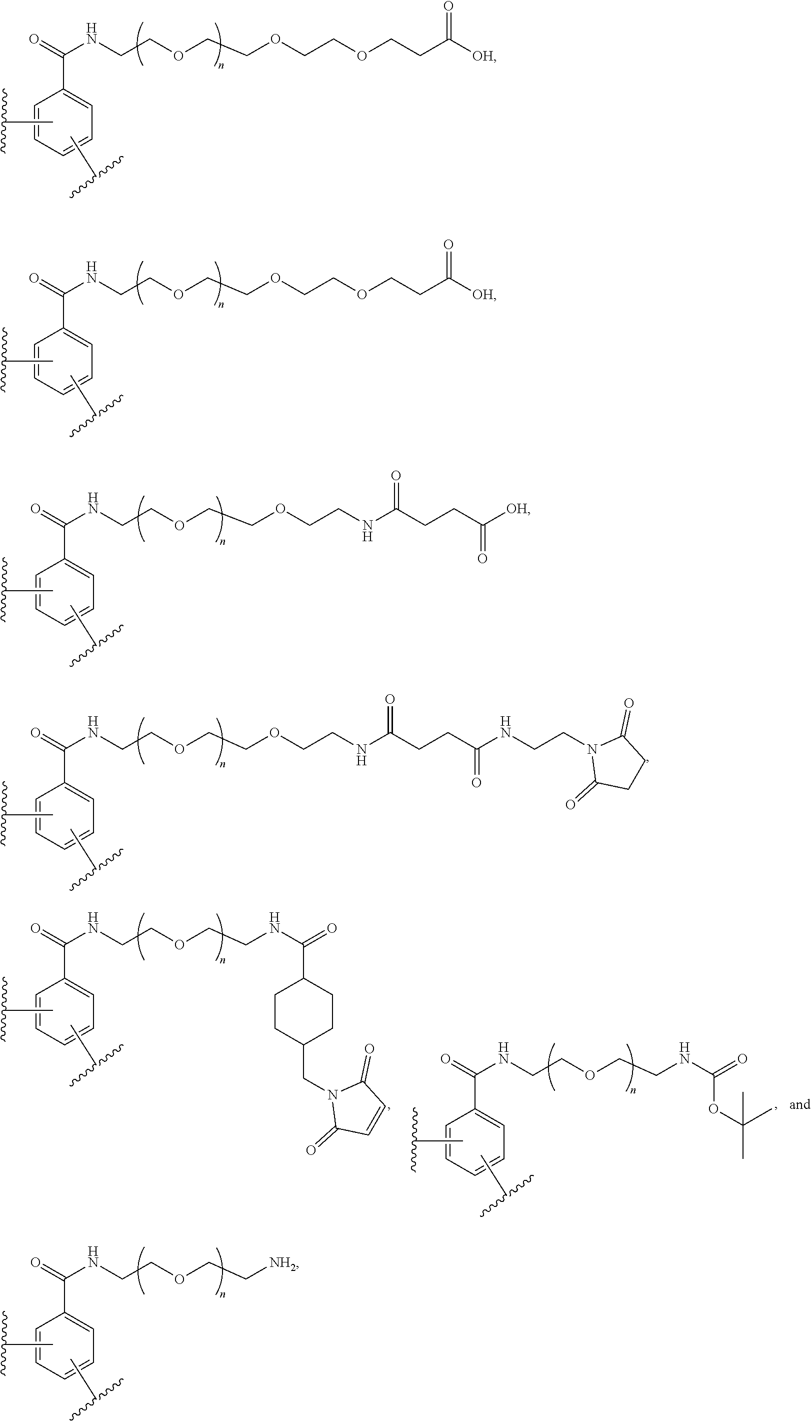

wherein
each R⁶ is independently selected from the group consisting of H, OH, SH, NHCOO-t-butyl, (CH₂)ₙCOOH, (CH₂)ₙCOOCH₃, (CH₂)ₙNH₂, (CH₂)ₙNH—(CH₂)ₙ—CH₃, (CH₂)ₙNHCOOH, (CH₂)ₙNHCO—(CH₂)ₙ—CO—(CH₂)ₙ—CH₃, (CH₂)ₙNHCOO—(CH₂)ₙ CH₃, (CH₂)ₙNHCOOC(CH₃)₃, (CH₂)ₙNHCO(C₃-C₁₂)cycloalkyl, (CH₂)ₙNHCO(CH₂CH₂O)_{f} (C₁-C₆) alkyl, (CH₂)ₙNHCO(CH₂)ₙCOOH, (CH₂)ₙNHCO(CH₂)ₙCOO(CH₂)ₙCH₃, (CH₂)ₙ(OCH₂CH₂)_{f}OCH₃, N-maleimide, halogen, C₂-C₁₂ alkene, C₂-C₁₂ alkyne, C₃-C₁₂ cycloalkyl, C₁-C₁₂ halo alkyl, C₁-C₁₂ (hetero)aryl, C₁-C₁₂ (hetero)arylamino, benzyl optionally substituted with one or more halogen, hydroxyl, C₁-C₁₂ alkoxy, or (OCH₂CH₂)_{f}OCH₃,

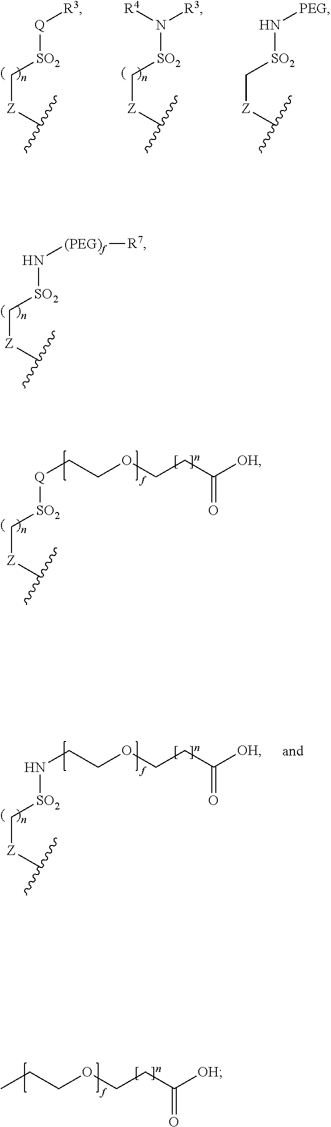

wherein
each of R³, R⁴, R⁷, Z, Q, f, and n are each as described above.

In some embodiments, each optional M is independently an optionally substituted arylene or optionally substituted heteroarylene.

The fluorescent polymer having the structure of Formula (I) may be a water-soluble fluorescent polymer.

In some cases, the water-soluble fluorescent polymer of the disclosure has a structure selected from the group consisting of Formulas (IIa), (IIb), (IIc), (IId), (IIe), (IIf), and (IIg):

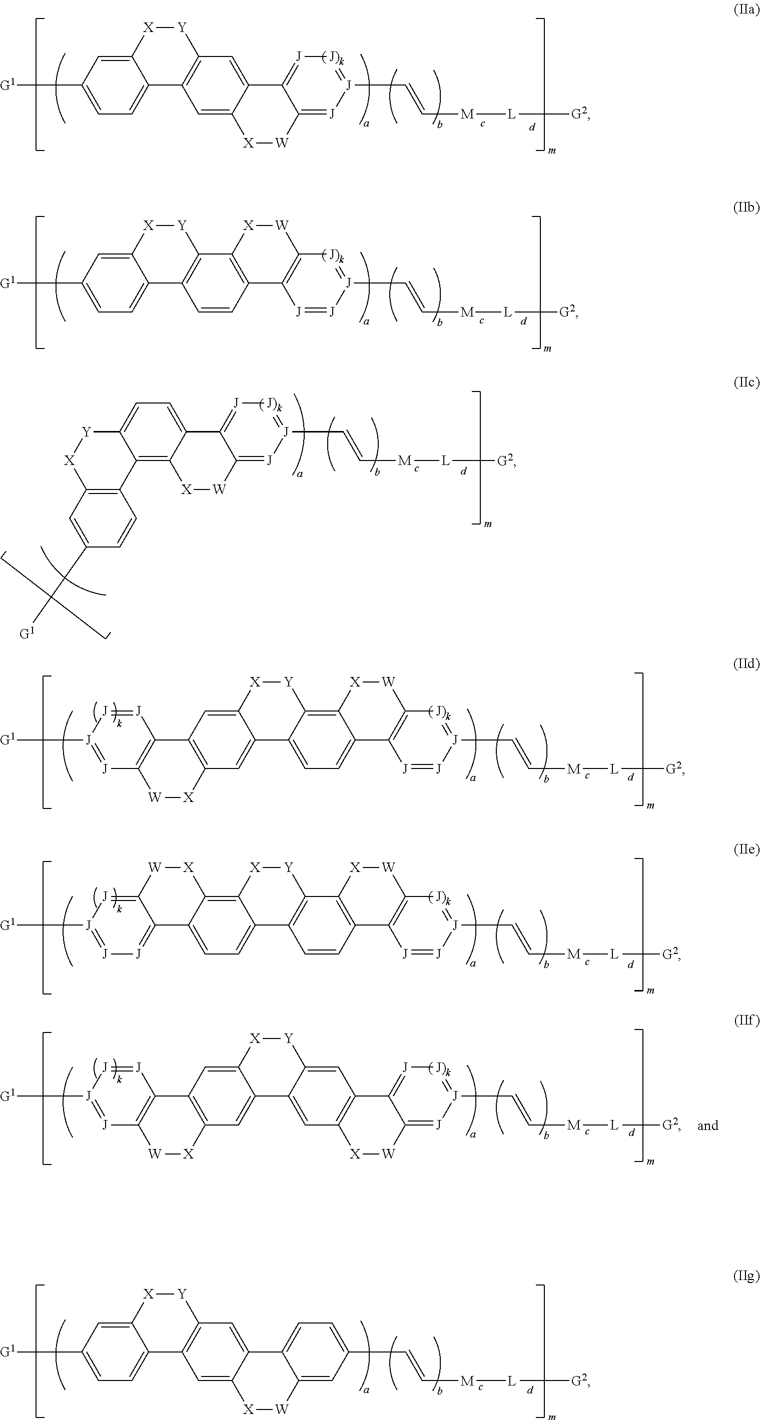

wherein
each of X, Y, W, M, L, J, G¹, G², a, b, c, d, k, and m are as described above.

In some cases, the fluorescent polymer of the present disclosure has a structure selected from the group consisting of Formulas (IIIa)-(IIIi):

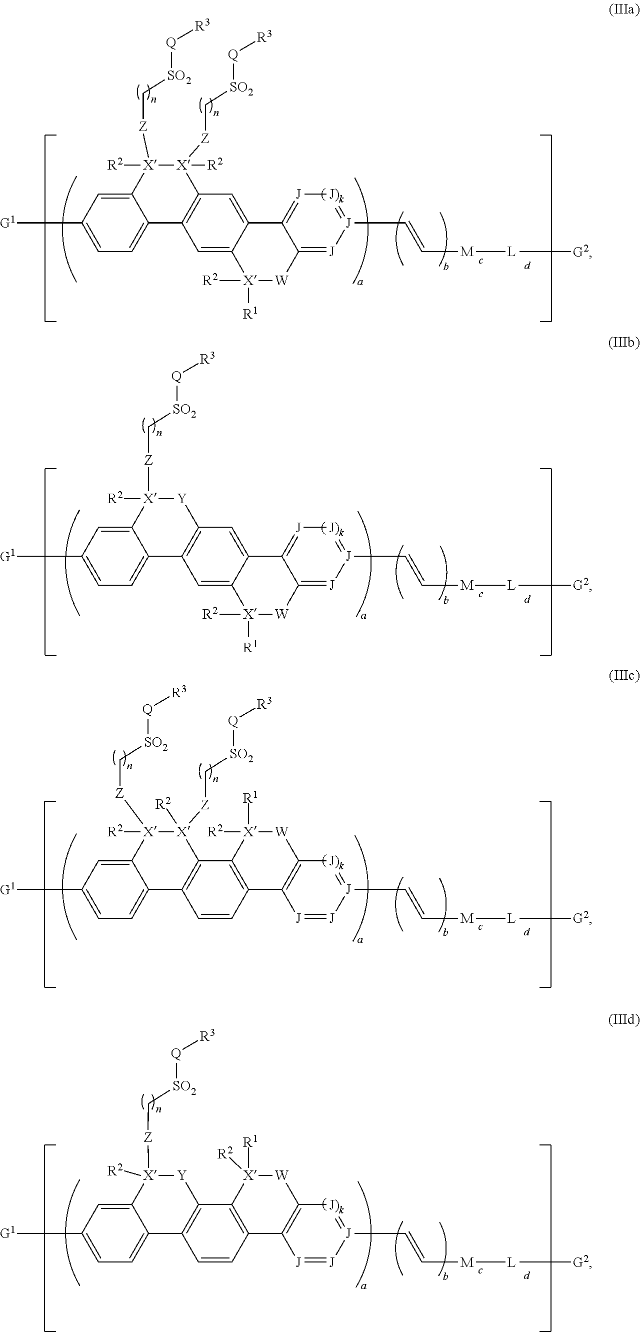

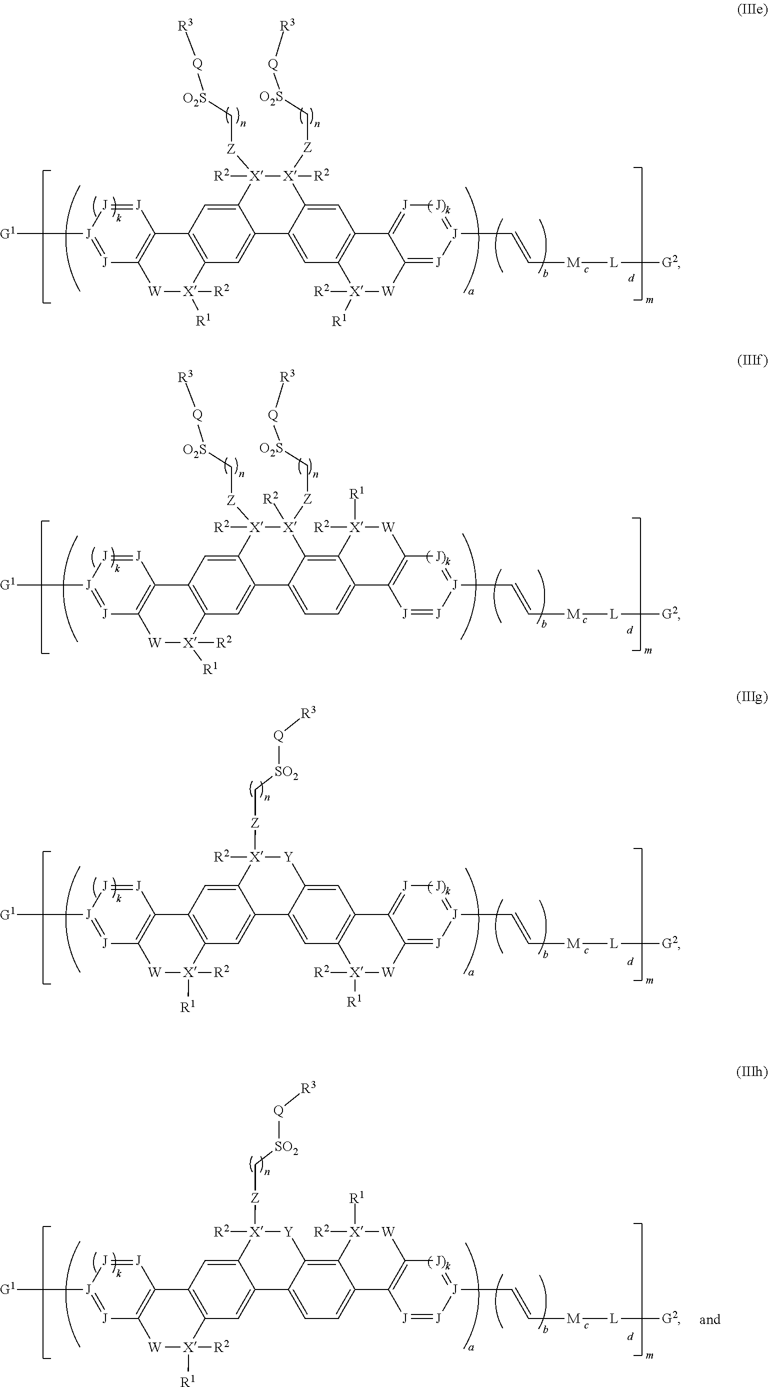

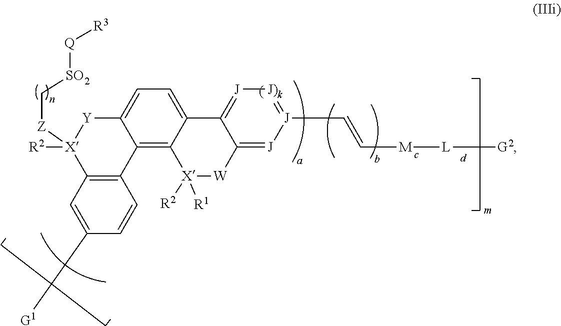

wherein
each X′ is independently C or Si; and
each of Y, Z, W, R¹, R², R³, M, L, J, G¹, G², Q, a, b, c, d, k, m, and n are as described above.

In some cases, the fluorescent polymer of the present disclosure has a structure selected from the group consisting of Formulas (IVa), (IVb), (IVc), (IVd), (IVe), (IVf), (IVg), (IVh), and (IVi):

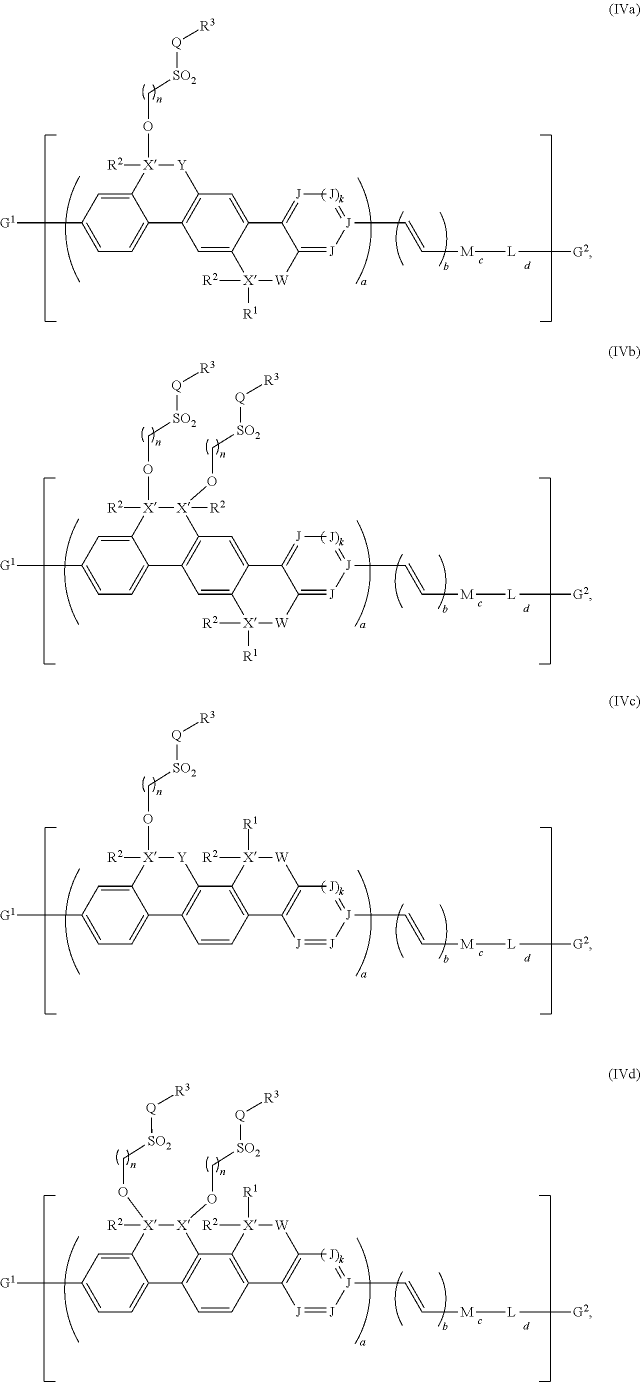

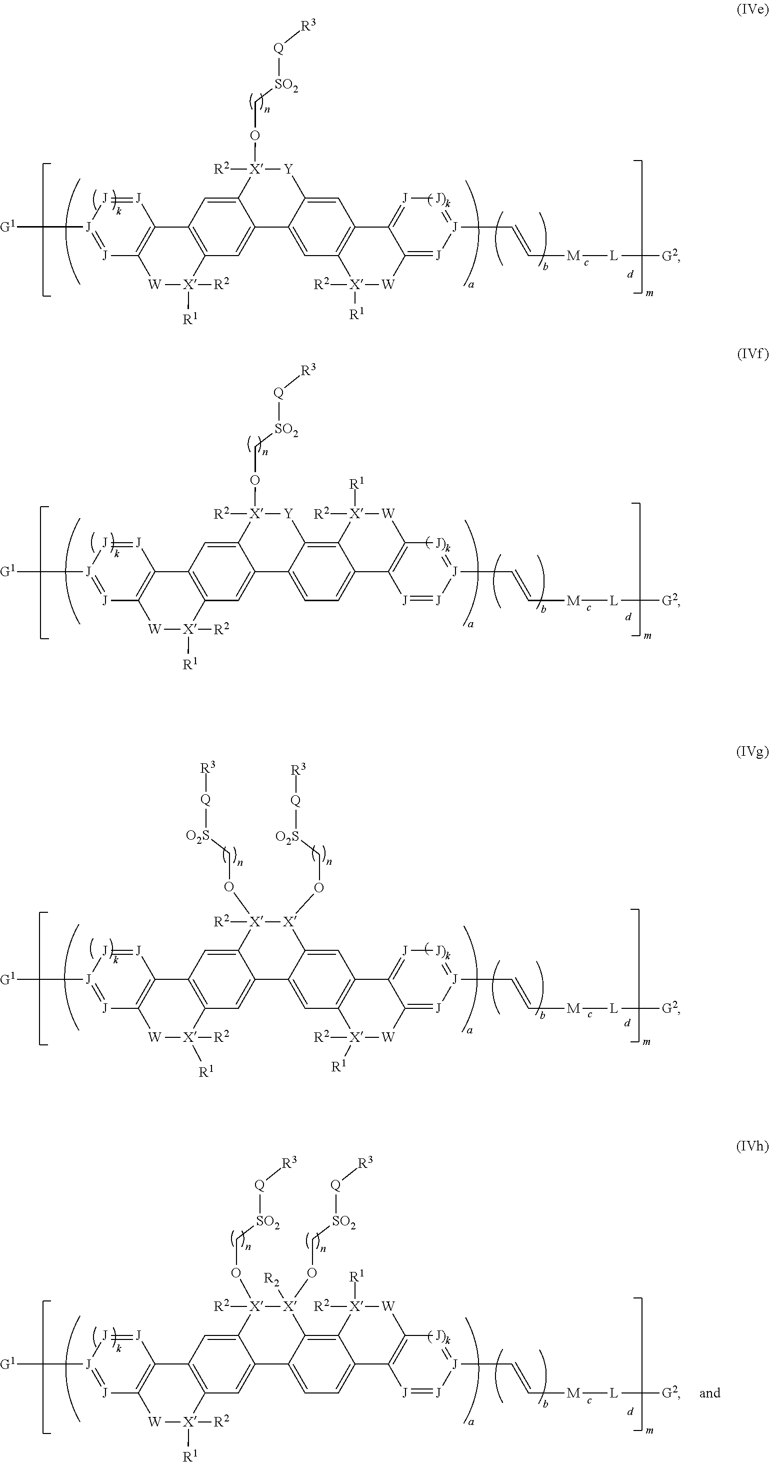

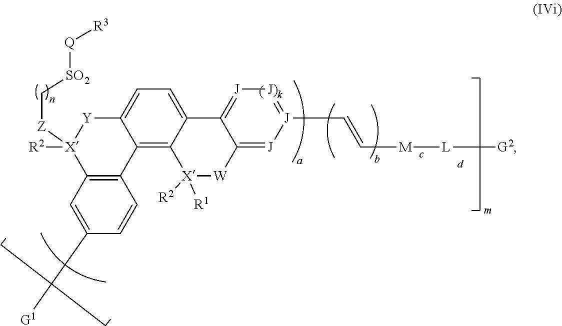

wherein
each X′ is independently C or Si; and
each of Y, Z, W, R¹, R², R³, M, L, J, G¹, G², Q, a, b, c, d, k, m, and n are as described above.

In some cases, the fluorescent polymer of the present disclosure has a structure selected from the group consisting of Formulas (Va), (Vb), and (Vc):

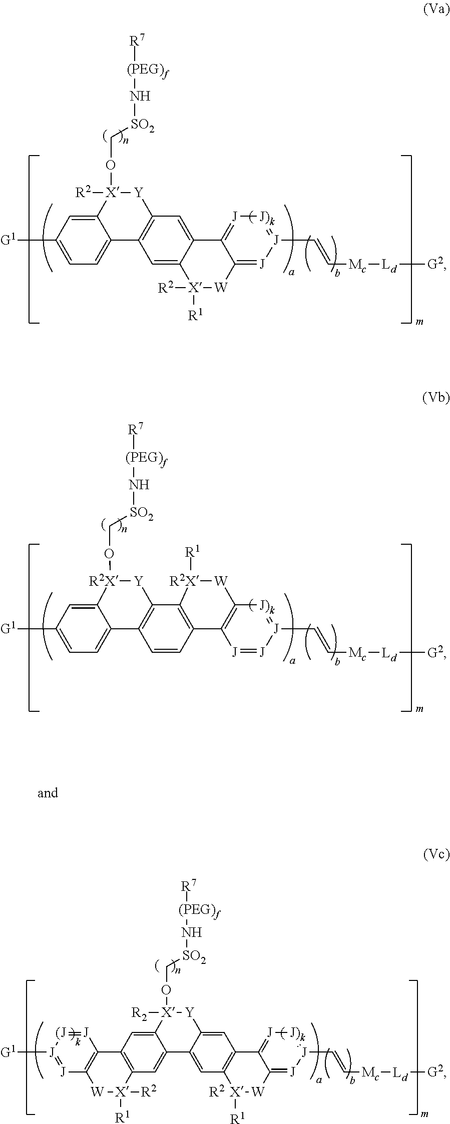

wherein
each X′ is independently C or Si; and
each of Y, Z, W, R¹, R², R⁷, M, L, J, G¹, G², a, b, c, d, f, k, m, and n are as described above.

In some cases, the fluorescent polymer of the present disclosure has a structure selected from the group consisting of Formulas (VIa), (VIb), (VIc), (VId), (VIe), (VIf), (VIg), and (VIh):

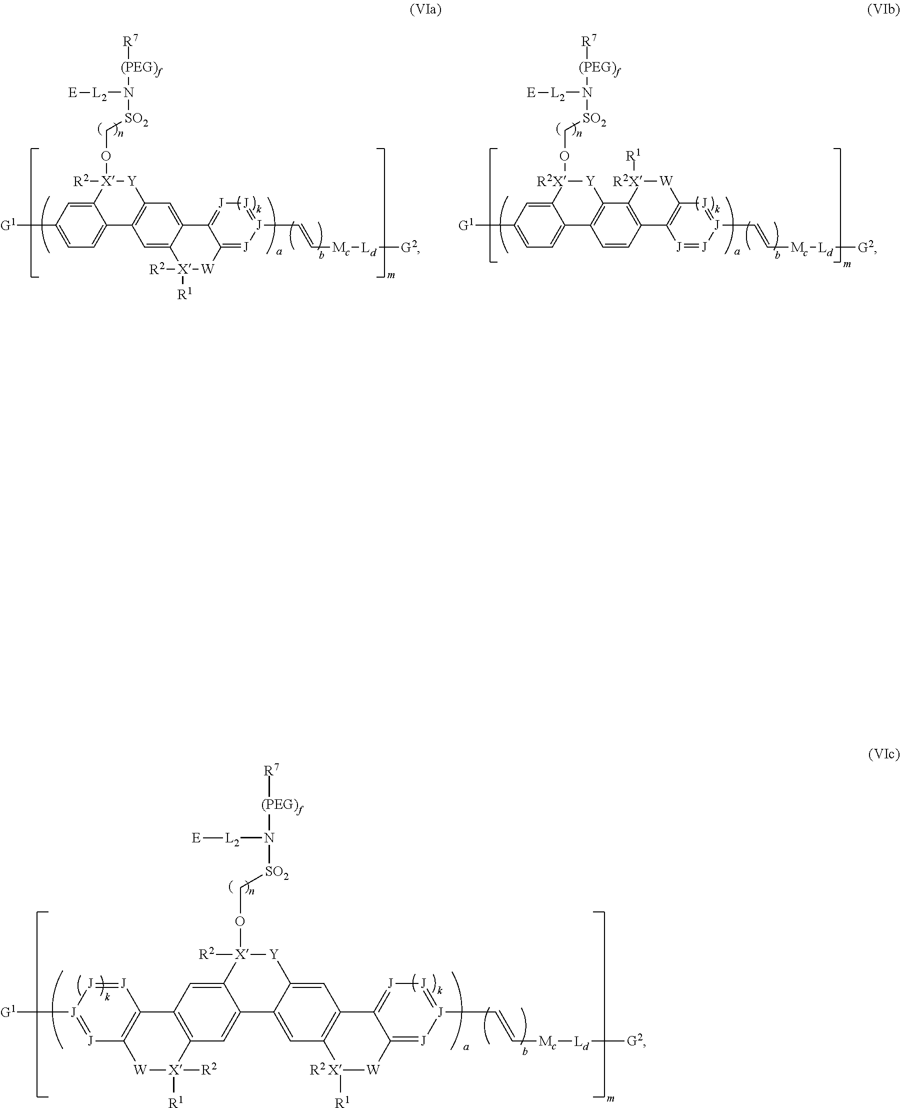

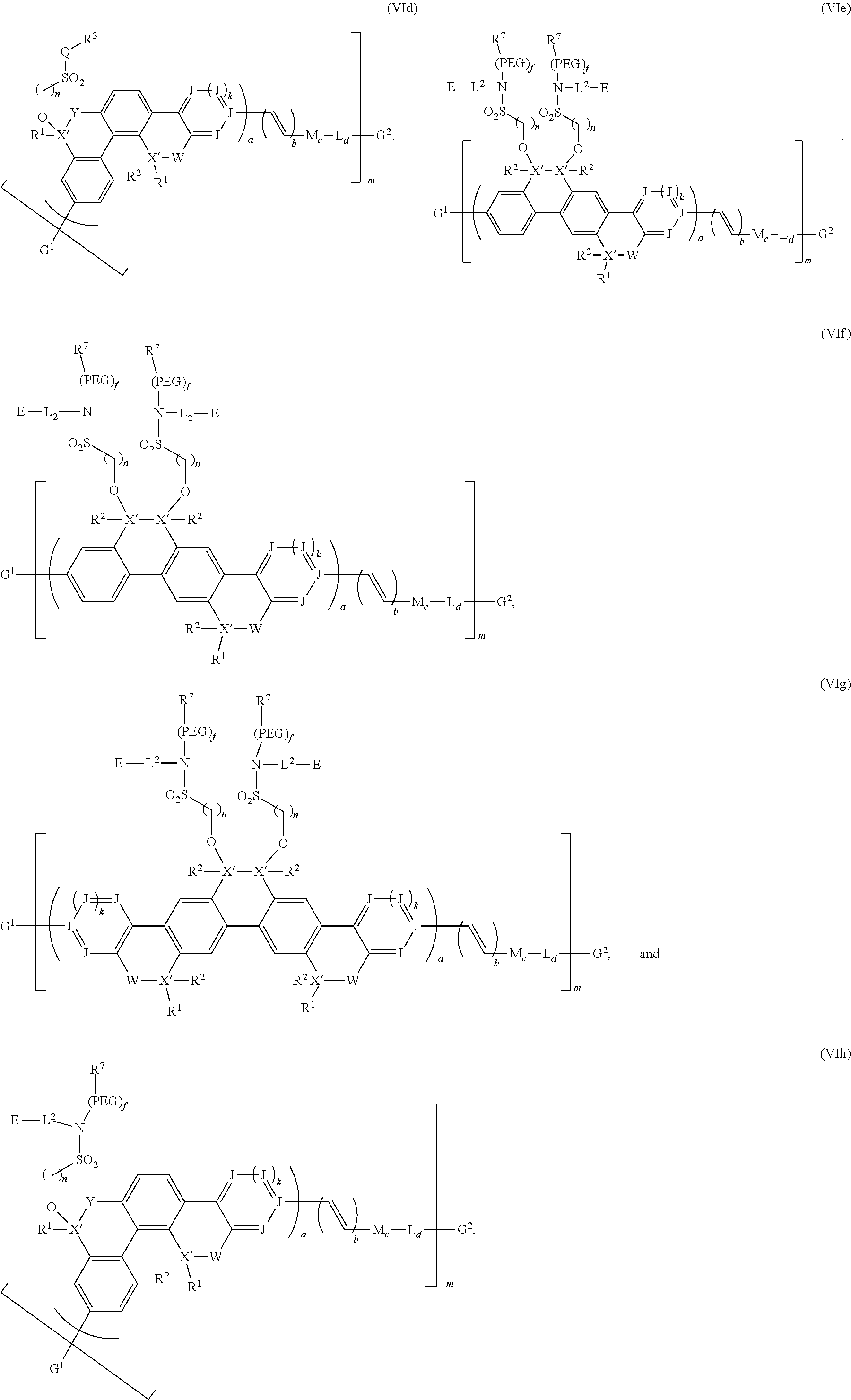

each X′ is independently C or Si; and
each of Y, Z, W, R¹, R², R⁷, M, L, J, G¹, G², a, b, c, d, f, k, m, and n are as described above.

In some cases, the fluorescent polymer of the present disclosure has a structure selected from the group consisting of Formulas (VIIa), (VIIb), and (VIIc):

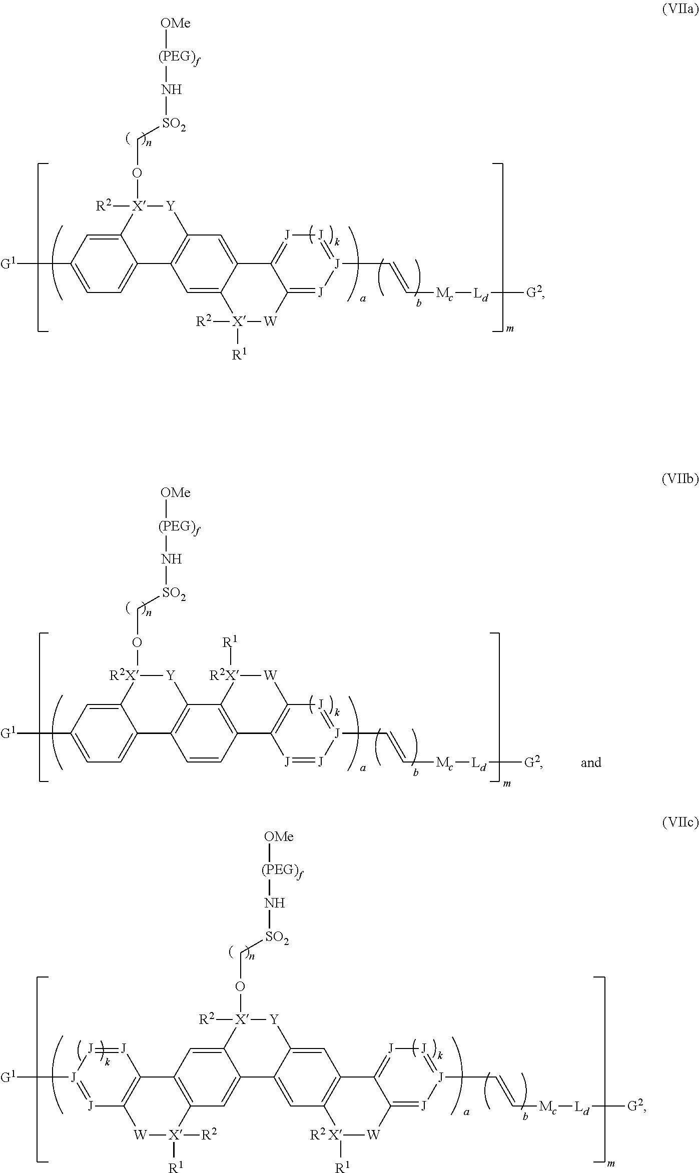

wherein
each X′ is independently C or Si; and
each of Y, Z, W, R¹, R², M, L, J, G¹, G², a, b, c, d, f, k, m, and n are as described above.

In some cases, the fluorescent polymer of the present disclosure has a structure selected from the group consisting of Formulas (VIIIa), (VIIIb), (VIIIc), (VIIIe), (VIIIf), (VIIIg), (VIIIh), and (VIIIi):

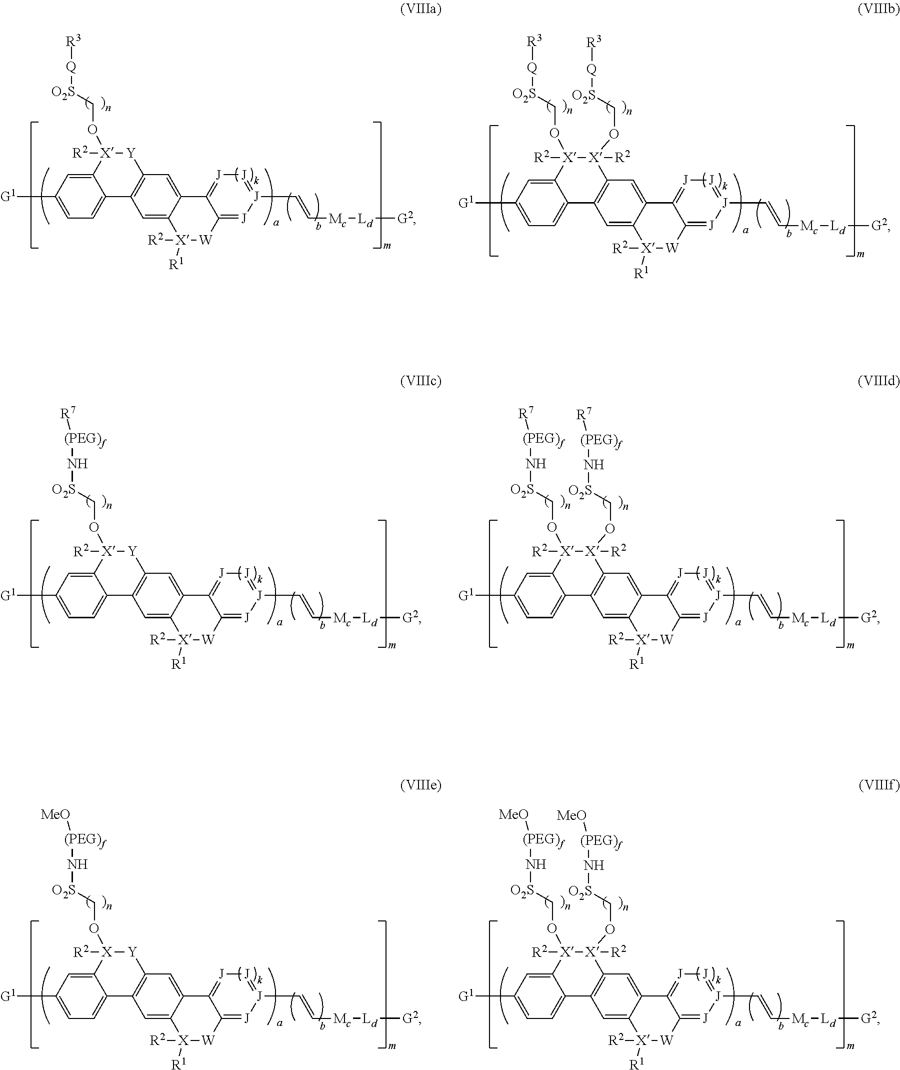

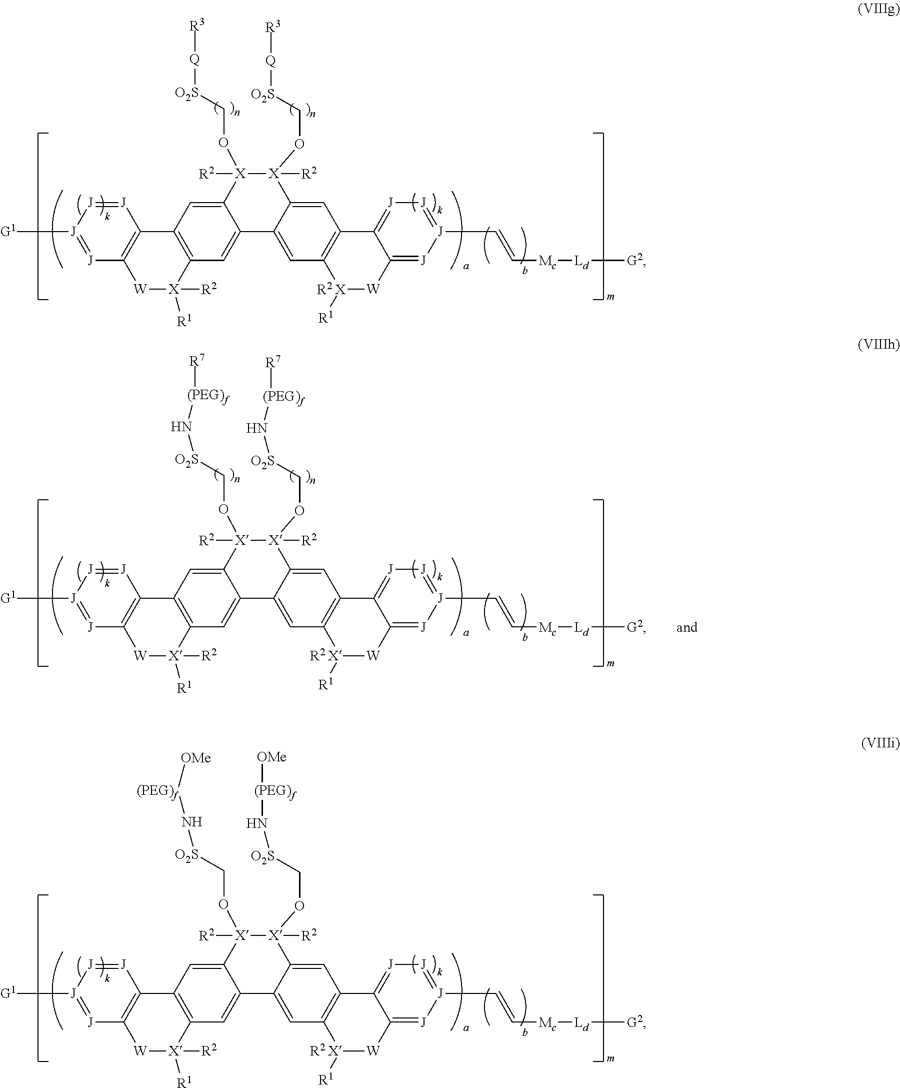

wherein
each X′ is independently C or Si;
each of Y, Z, W, R^{f}, R², R³, R⁷, J, G^{f}, G², a, f, k, m, and n are as described above; and W is CR¹R² or SiR¹R².

In some cases, the fluorescent polymer of the present disclosure has a structure selected from the group consisting of Formulas (IXa), (IXb), and (IXc):

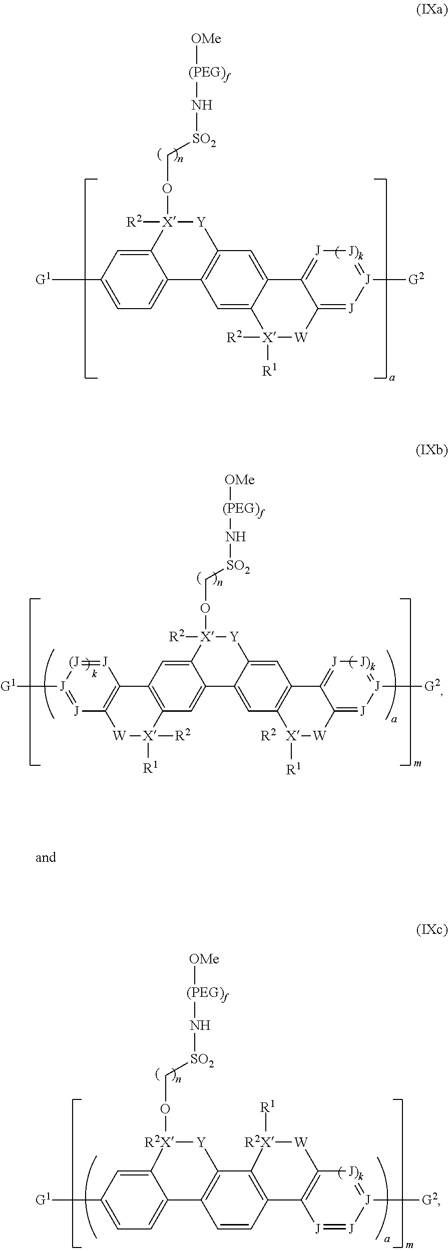

wherein
each X′ is independently C or Si; and
each of Y, Z, W, R^{f}, R², J, G¹, G², a, f, k, m, and n are as described above.

In some cases, the fluorescent polymer of the present disclosure has a structure selected from the group consisting of Formulas (Xa), (Xb), (Xc), (Xd), (Xe), and (Xf):

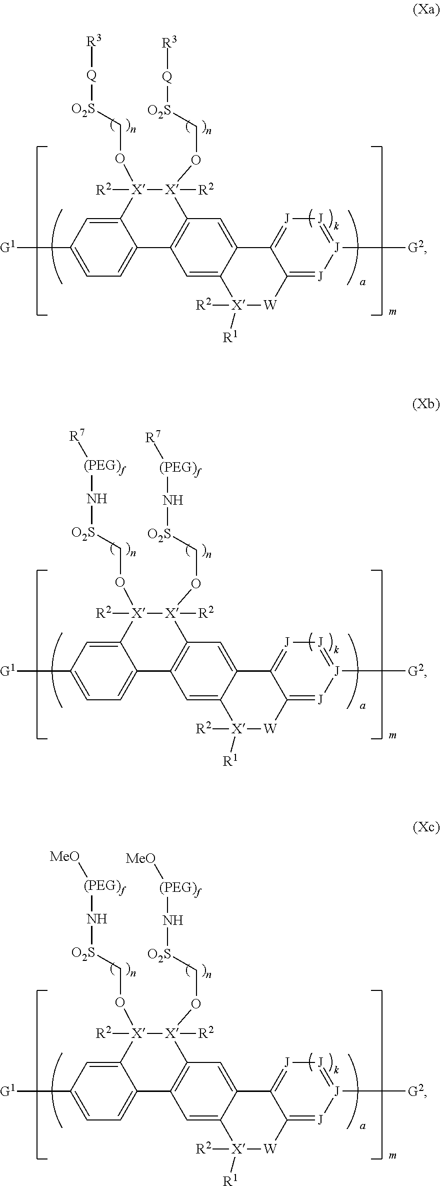

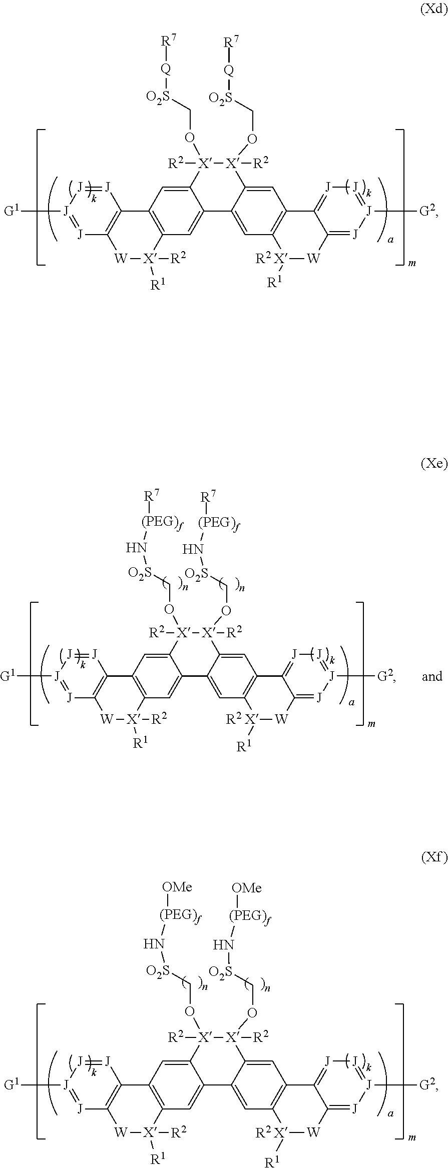

wherein
each X′ is independently C or Si; and
each of Y, Z, W, R¹, R², R³, R⁷, M, L, J, G¹, G², Q, a, b, c, d, f, k, m, and n are as described above.

In some aspects, the present disclosure provides a fluorescent copolymer having the structure of Formula (I), wherein A comprises at least two different monomeric units selected from the group consisting of Formula (A1), (A2), (A3), (A4, (A5), (A6), and (A7):

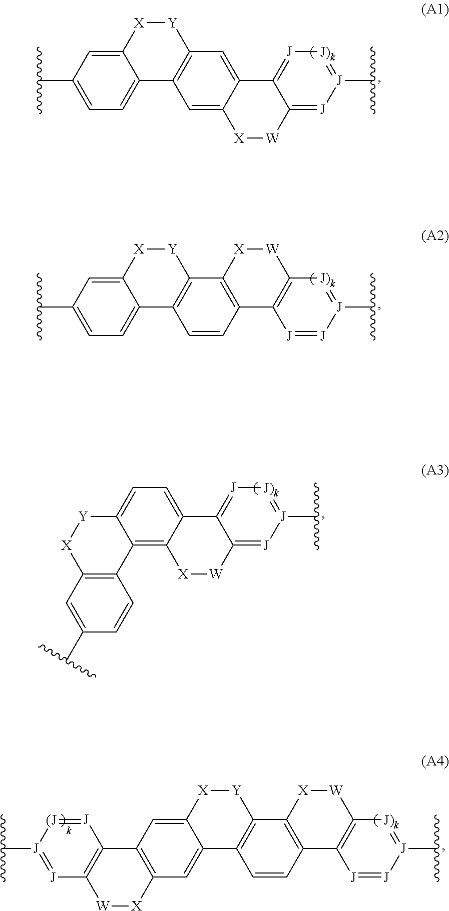

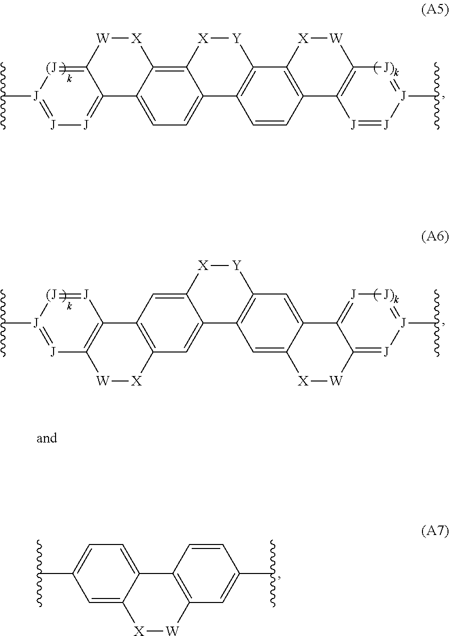

wherein
each [symbol] in A1-A7 is a site for covalent attachment to the unsaturated backbone of the fluorescent polymer, including any other component of the polymer described in Formula (I);
X, Y, W, J, R¹, R², and k are as previously defined.

In some embodiments, the fluorescent copolymer of the present disclosure is water soluble.

In some cases, the fluorescent copolymer of the present disclosure is a copolymer comprising a structure selected from the group consisting of Formulas (XIa), (XIb), (XIc), (XId), (XIe), (XIf), (XIg), and (XIh):

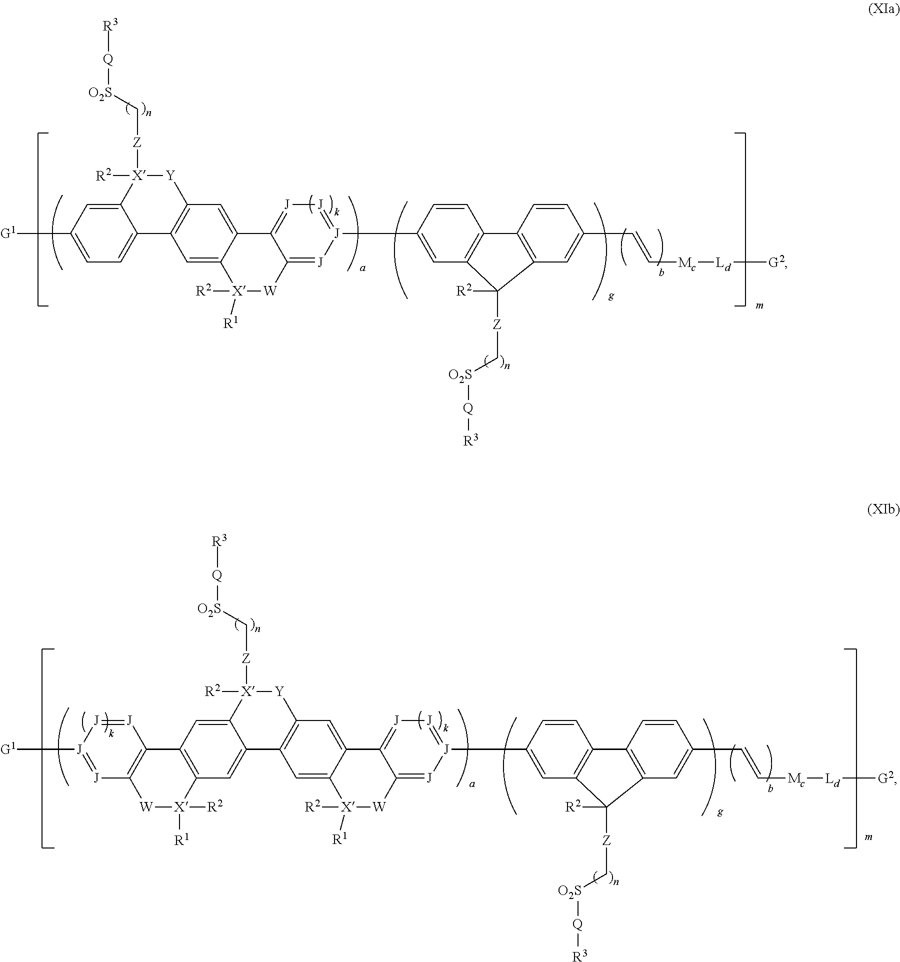

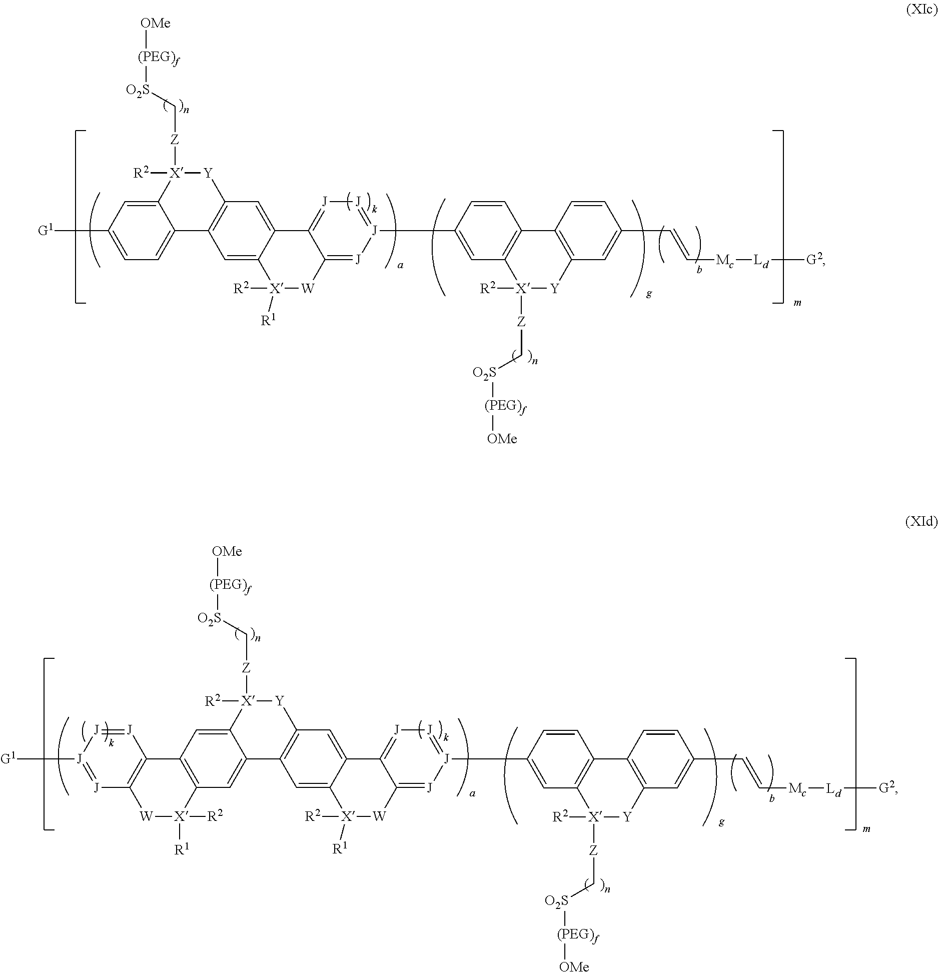

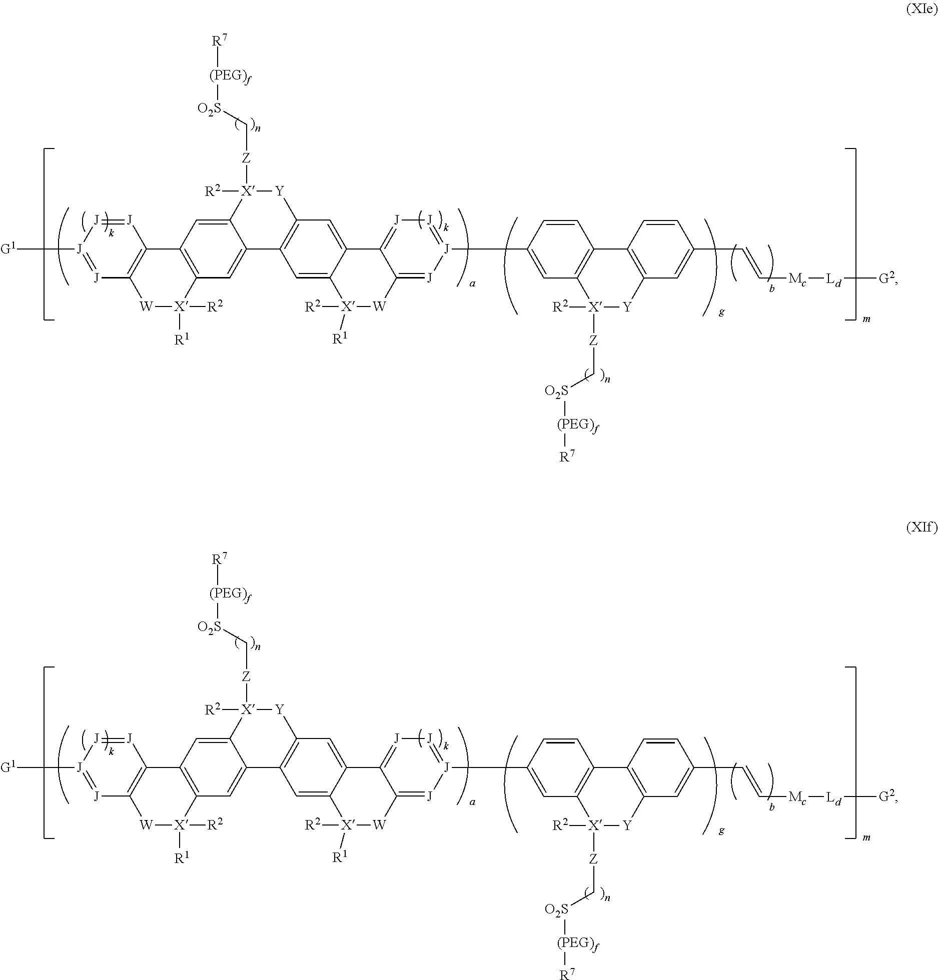

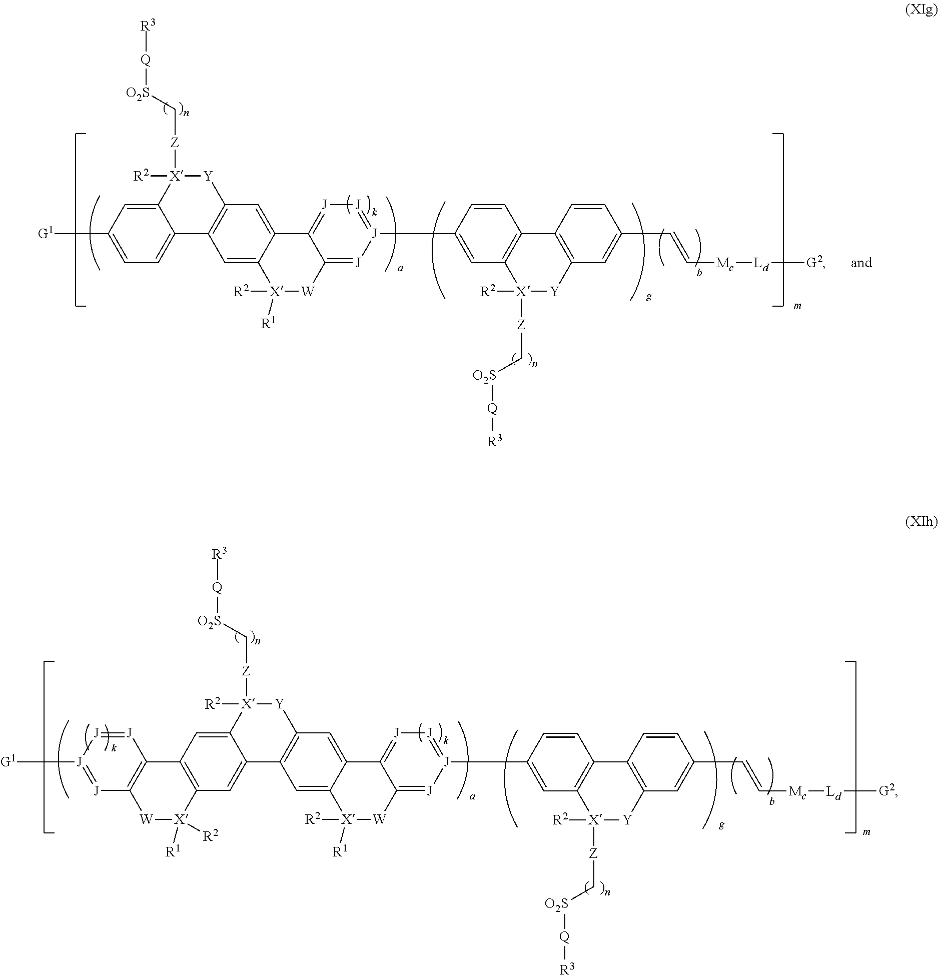

wherein
each X′ is independently C or Si;
each of Y, Z, W, R¹, R², R³, R⁷, M, L, J, G¹, G², Q, a, b, c, d, f, k, m, and n are as described above; and
g defines the mol % of the corresponding unit within the structure which can be evenly or randomly repeated, wherein g is from 10 to 100%.

In some cases, the fluorescent copolymer of the present disclosure has a structure selected from the group consisting of Formulas (XIa)-(XIb):

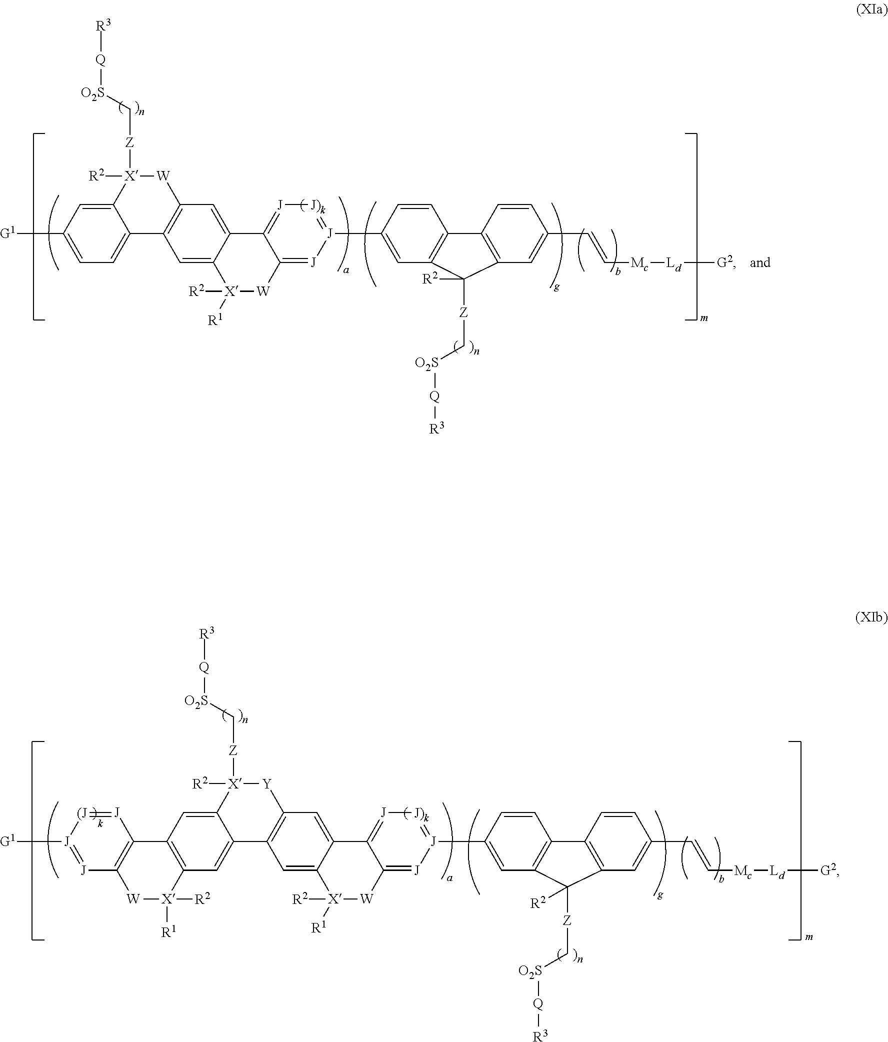

wherein
each X′ is independently C or Si; and
each of Y, Z, W, R¹, R², R³, R⁷, M, L, J, G¹, G², Q, a, b, c, d, f, k, m, and n are as described above.

In some aspects, the present disclosure provides a water-soluble fluorescent tandem polymer comprising a fluorescent polymer having the structure of any of Formulas I-XI as disclosed above and an acceptor dye or signaling chromophore covalently linked to the polymer.

In some embodiments, the present disclosure provides a conjugated water-soluble fluorescent polymer complex comprising a fluorescent polymer or fluorescent tandem polymer having the structure of any of Formulas I-XI as disclosed above and a binding partner attached to the polymer. The conjugated fluorescent polymer forms a fluorescent polymer complex when the binding partner conjugated to the fluorescent polymer or fluorescent tandem polymer interacts with a target analyte.

In some aspects, the present disclosure provides a method for detecting a target analyte in a sample comprising:
providing a sample that is suspected of containing the target analyte; and
contacting the sample with a binding partner conjugated to a fluorescent polymer or fluorescent tandem polymer having the structure of any of Formulas I-XI as disclosed above, wherein the binding partner is capable of interacting with the target analyte.

In some embodiments, the method further comprises, applying a light source to the sample that can excite the polymer or tandem polymer; and detecting whether light is emitted from the conjugated water-soluble fluorescent polymer complex (i.e., binding partner conjugated to the fluorescent polymer).

In some embodiments, the binding partner is a protein, peptide, affinity ligand, antibody, antibody fragment, carbohydrate, lipid, nucleic acid or an aptamer. In some embodiments, the binding partner is an antibody.

In some embodiments, the method is configured for flow cytometry. In some embodiments, the conjugated water-soluble fluorescent polymer complex consists essentially of a water-soluble fluorescent polymer and a binding partner. In some embodiments, the conjugated water-soluble fluorescent polymer complex consists essentially of a water-soluble fluorescent polymer and an antibody. In some embodiments, the binding partner is bound to a substrate. In some embodiments, the water-soluble fluorescent polymer is bound to a substrate. In some embodiments, the analyte is a protein expressed on a cell surface.

In some embodiments, the method is configured for cell sorting. In some embodiments, the binding partner is bound to a substrate. In some embodiments, the analyte is a protein expressed on a cell surface.

In some embodiments, the method is configured as an immunoassay. In some embodiments, the method further comprises providing additional binding partners for detecting additional analytes simultaneously.

A kit is provided comprising at least one fluorescent polymer, fluorescent tandem polymer, or labeled specific binding partner according to the disclosure.

### BRIEF DESCRIPTION OF THE DRAWINGS

FIG. 1 shows an exemplary procedure for tandem polymer dye formation and antibody conjugation from an example carboxylic water-soluble fluorescent polymer according to the present disclosure.

FIG. 2A shows an absorption spectrum of a fluorescent polymer containing fused DHP monomer, according to example 5 of the present disclosure.

FIG. 2B shows an emission spectrum of a fluorescent polymer containing fused DHP monomer, according to example 5 of the present disclosure.

### DETAILED DESCRIPTION

### I. General

The present disclosure provides novel fluorescent polymers and tandem polymers, in particular, water-soluble fluorescent polymers and tandem polymers, and methods for detecting analytes in a sample using conjugated fluorescent polymer complexes comprising the fluorescent polymers or tandem polymers conjugated to binding partners. The fluorescent polymers and tandem polymers of the present disclosure demonstrate water solubility and significantly increased brightness compared to other dyes. The fluorescent tandem polymers comprise the fluorescent polymers covalently linked to an acceptor dye.

### II. Definitions

The abbreviations used herein have their conventional meaning within the chemical and biological arts.

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the present disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “organic group” as used herein refers to any carbon-containing functional moiety. Examples can include an oxygen-containing group such as an alkoxy group; aryloxy group; aralkyloxy group; oxo(carbonyl) group; an amine group, including alkyl amine amine esters, and sulfonamide groups; a carboxyl group including a carboxylic acid, carboxylate, and a carboxylate ester; a sulfur-containing group such as an alkyl and aryl sulfide group, thiol, thiol reactive group, and sulfone group; maleimide; iodoacetamide; azide group; alkyne group; and other heteroatom-containing groups. Non-limiting examples of organic groups include OR, OOR, OC(O)N(R)₂, CN, CF₃, OCF₃, R, C(O)R, methylenedioxy, ethylenedioxy, N(R)₂, N₃, S(H)R, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which one or more hydrogen atoms contained therein are replaced by one or more non-hydrogen atoms.

The term “group” or “substituent” as used herein refers to a group that can be or is substituted onto a molecule or onto an organic group. Examples of substituents or functional groups include, but are not limited to, a halogen (e.g., F, Cl, Br, and I); alkyne; an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, imides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The subject fluorescent polymers can include one or more “functional group(s)” that provide for bioconjugation or attachment of an acceptor dye. In some cases, such functionality may be used to covalently attach a biomolecule or binding partner such as a protein, peptide, affinity ligand, antibody, antibody fragment, polynucleotide, or aptamer. In some cases the functional group may be selected from the group consisting of an orthogonal group, amine, carbamate, carboxylic acid, carboxylate, maleimide, activated ester, N-hydroxysuccinimidyl, hydrazine, hydrazide, hydrazone, isothiocyanato, azide, alkyne, alkene, tetrazine, aldehyde, thiol, and protected groups thereof for conjugation to a substrate, acceptor dye, functional moiety, or binding partner. The functional group may be protected or unprotected.

As used herein, the term “activated ester” or “active esters” by itself or as part of another substituent refers to carboxyl-activating groups employed in peptide chemistry to promote facile condensation of a carboxyl group with a free amino group of an amino acid derivative. Descriptions of these carboxyl-activating groups are found in general textbooks of peptide chemistry, for example K. D. Kopple, “Peptides and Amino Acids”, W. A. Benjamin, Inc., New York, 1966, pp. 50-51 and E. Schroder and K. Lubke, “The Peptides”; Vol. 1, Academic Press, New York, 1965, pp. 77-128 which are each incorporated herein by reference in their entireties.

As used herein, the term “ammonium” by itself or as part of another substituent refers to a cation having the formula NHR₃⁺ where each R group, independently, is hydrogen or a substituted or unsubstituted alkyl, aryl, aralkyl, or alkoxy group. Preferably, each of the R groups is hydrogen.

As used herein, the term “oligoether” is understood to mean an oligomer containing structural repeat units having an ether functionality. As used herein, an “oligomer” is understood to mean a molecule that contains one or more identifiable structural repeat units of the same or different formula.

The term “hydrocarbon” or “hydrocarbyl” as used herein refers to a molecule or functional group that includes carbon and hydrogen atoms. The term can also refer to a molecule or functional group that normally includes both carbon and hydrogen atoms but wherein some or all the hydrogen atoms are substituted with other functional groups. The term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain embodiments there is no hydrocarbyl group. A hydrocarbylene group is a diradical hydrocarbon, e.g., a hydrocarbon that is bonded at two locations.

As used herein, the term “alkyl” by itself or as part of another substituent refers to a straight or branched, saturated, aliphatic radical having the number of carbon atoms indicated. Alkyl groups can be optionally substituted alkyl groups. For example, C₁-C₆ alkyl includes, but is not limited to, methyl, ethyl, propyl, isopropyl, butyl, isobutyl, sec-butyl, tert-butyl, pentyl, isopentyl, hexyl, etc. Other alkyl groups include, but are not limited to heptyl, octyl, nonyl, decyl, etc. Alkyl can include any number of carbons, such as 1-2, 1-3, 1-4, 1-5, 1-6, 1-7, 1-8, 1-9, 1-10, 2-3, 2-4, 2-5, 2-6, 3-4, 3-5, 3-6, 4-5, 4-6 and 5-6. The alkyl group is typically monovalent, but can be divalent, such as when the alkyl group links two moieties together.

As used herein, the term “cycloalkyl” by itself or as part of another substituent refers to a saturated or partially unsaturated, monocyclic, fused bicyclic or bridged polycyclic ring assembly containing from 3 to 12 ring atoms, or the number of atoms indicated monocyclic rings include, for example, cyclopropyl, cyclobutyl, cyclopentyl, cyclohexyl, and cyclooctyl. Bicyclic and polycyclic rings include, for example, norbornane, decahydronaphthalene and adamantane. For example, C₃₋₈cycloalkyl includes cyclopropyl, cyclobutyl, cyclopentyl, cyclohexyl, cyclooctyl, and norbornane.

As used herein, the term “haloalkyl” by itself or as part of another substituent refers to alkyl as defined above where some or all of the hydrogen atoms are substituted with halogen atoms. Halogen (halo) preferably represents chloro or fluoro, but may also be bromo or iodo. For example, haloalkyl includes trifluoromethyl, flouromethyl, 1,2,3,4,5-pentafluoro-phenyl, etc. The term “perfluoro” defines a compound or radical which has at least two available hydrogens substituted with fluorine. For example, perfluorophenyl refers to 1,2,3,4,5-pentafluorophenyl, perfluoromethane refers to 1,1,1-trifluoromethyl, and perfluoromethoxy refers to 1,1,1-trifluoromethoxy.

As used herein, the term “halogen” by itself or as part of another substituent refers to fluorine, chlorine, bromine and iodine.

As used herein, the term “alkoxy” by itself or as part of another substituent refers to an alkyl group, as defined above, having an oxygen atom that connects the alkyl group to the point of attachment. Alkoxy groups include, for example, methoxy, ethoxy, propoxy, iso-propoxy, butoxy, 2-butoxy, iso-butoxy, sec-butoxy, tert-butoxy, pentoxy, hexoxy, etc. The alkoxy groups can be further substituted with a variety of substituents described within. For example, the alkoxy groups can be substituted with halogens to form a “halo-alkoxy” group.

As used herein, the term “alkene” or “alkenyl” by itself or as part of another substituent refers to either a straight chain, branched chain, or cyclic hydrocarbon, having at least one double bond between two carbon atoms. Examples of alkene groups include, but are not limited to, vinyl, propenyl, isopropenyl, 1-butenyl, 2-butenyl, isobutenyl, butadienyl, 1-pentenyl, 2-pentenyl, isopentenyl, 1,3-pentadienyl, 1,4-pentadienyl, 1-hexenyl, 2-hexenyl, 3-hexenyl, 1,3-hexadienyl, 1,4-hexadienyl, 1,5-hexadienyl, 2,4-hexadienyl, or 1,3,5-hexatrienyl. The alkene group is typically monovalent, but can be divalent, such as when the alkenyl group links two moieties together.

As used herein, the term “alkyne” or “alkynyl” by itself or as part of another substituent refers to either a straight chain or branched hydrocarbon, having at least one triple bond between two carbon atoms. Examples of alkynyl groups include, but are not limited to, acetylenyl, propynyl, 1-butynyl, 2-butynyl, isobutynyl, sec-butynyl, butadiynyl, 1-pentynyl, 2-pentynyl, isopentynyl, 1,3-pentadiynyl, 1,4-pentadiynyl, 1-hexynyl, 2-hexynyl, 3-hexynyl, 1,3-hexadiynyl, 1,4-hexadiynyl, 1,5-hexadiynyl, 2,4-hexadiynyl, or 1,3,5-hexatriynyl. The alkynyl group is typically monovalent, but can be divalent, such as when the alkynyl group links two moieties together.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acyl group can optionally also include heteroatoms within the meaning herein. Examples of acyl groups include, but are not limited to, a nicotinoyl group (pyridyl-3-carbonyl) acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

As used herein, the term “aryl” by itself or as part of another substituent refers to cyclic aromatic hydrocarbon groups that do not contain heteroatoms in the aromatic ring assembly. “Aryl” groups can be a monocyclic or fused bicyclic, tricyclic or greater, aromatic ring assembly containing 6 to 16 ring carbon atoms. For example, aryl may be, but is not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, benzyl or naphthyl. “Arylene” means a divalent radical derived from an aryl group. Aryl groups can be mono-, di- or tri-substituted by one, two or three radicals selected from alkyl, alkoxy, aryl, hydroxy, halogen, cyano, amino, amino-alkyl, trifluoromethyl, alkylenedioxy and oxy-C₂-C₃-alkylene; all of which are optionally further substituted, for instance as hereinbefore defined; or 1- or 2-naphthyl; or 1- or 2-phenanthrenyl. Alkylenedioxy is a divalent substitute attached to two adjacent carbon atoms of phenyl, e.g. methylenedioxy or ethylenedioxy. Oxy-C₂-C₃-alkylene is also a divalent substituent attached to two adjacent carbon atoms of phenyl, e.g. oxyethylene or oxypropylene. An example for oxy-C₂-C₃-alkylene-phenyl is 2,3-dihydrobenzofuran-5-yl.

Preferred as aryl is naphthyl, phenyl or phenyl mono- or disubstituted by alkoxy, phenyl, halogen, alkyl or trifluoromethyl, especially phenyl or phenyl-mono- or disubstituted by alkoxy, halogen or trifluoromethyl, and in particular phenyl.

As used herein, the term “aryloxy” by itself or as part of another substituent refers to a O-aryl group, wherein aryl is as defined above. An aryloxy group can be unsubstituted or substituted with one or two suitable substituents. The term “phenoxy” refers to an aryloxy group wherein the aryl moiety is a phenyl ring. The term “(hetero)aryloxy” as used herein means an O-heteroaryl group, wherein heteroaryl is as defined below. The term “(hetero)aryloxy” is used to indicate the moiety is either an aryloxy or (hetero)aryloxy group.

The term “aralkyl” as used herein refers to alkyl groups as defined herein in which a hydrogen or carbon bond of an alkyl group is replaced with a bond to an aryl group as defined herein. Representative aralkyl groups include benzyl and phenylethyl groups and fused (cycloalkylaryl)alkyl groups such as 4-ethyl-indanyl. Aralkenyl groups are alkenyl groups as defined herein in which a hydrogen or carbon bond of an alkyl group is replaced with a bond to an aryl group as defined herein.

As used herein, the term “heteroaryl” by itself or as part of another substituent refers to a monocyclic or fused bicyclic or tricyclic aromatic ring assembly containing 5 to 16 ring atoms, where from 1 to 4 of the ring atoms are a heteroatom each N, O or S. For example, heteroaryl includes pyridyl, indolyl, indazolyl, quinoxalinyl, quinolinyl, isoquinolinyl, benzothienyl, benzofuranyl, furanyl, pyrrolyl, thiazolyl, benzothiazolyl, oxazolyl, isoxazolyl, triazolyl, tetrazolyl, pyrazolyl, imidazolyl, thienyl, or any other radicals substituted, especially mono- or di-substituted, by, e.g., alkyl, nitro or halogen. Pyridyl represents 2-, 3- or 4-pyridyl, advantageously 2- or 3-pyridyl. Thienyl represents 2- or 3-thienyl. Quinolinyl represents preferably 2-, 3- or 4-quinolinyl. Isoquinolinyl represents preferably 1-, 3- or 4-isoquinolinyl. Benzopyranyl, benzothiopyranyl represents preferably 3-benzopyranyl or 3-benzothiopyranyl, respectively. Thiazolyl represents preferably 2- or 4-thiazolyl, and most preferred, 4-thiazolyl. Triazolyl is preferably 1-, 2- or 5-(1,2,4-triazolyl). Tetrazolyl is preferably 5-tetrazolyl.

In some embodiments, heteroaryl is pyridyl, indolyl, quinolinyl, pyrrolyl, thiazolyl, isoxazolyl, triazolyl, tetrazolyl, pyrazolyl, imidazolyl, thienyl, furanyl, benzothiazolyl, benzofuranyl, isoquinolinyl, benzothienyl, oxazolyl, indazolyl, or any of the radicals substituted, especially mono- or di-substituted.

In some embodiments, substituents for the aryl and heteroaryl groups are varied and are selected from: -halogen, —OR′, —OC(O)R′, —NR′R″, —SR′, —R′, —CN, —NO₂, —CO₂R′, —CONR′R″, —C(O)R′, —OC(O)NR′R″, —NR″C(O)R′, —NR″C(O)₂R′, —NR′—C(O)NR″R′″, —NH—C(NH₂)═NH, —NR′C(NH₂)═NH, —NH—C(NH₂)═NR′, —S(O)R′, —S(O)₂R′, —S(O)₂NR′R″, —N₃, —CH(Ph)₂, perfluoro(C₁-C₄)alkoxy, and perfluoro(C₁-C₄)alkyl, in a number ranging from zero to the total number of open valences on the aromatic ring system; and where R′, R″ and R′″ are independently selected from hydrogen, (C₁-C₅)alkyl and heteroalkyl, unsubstituted aryl and heteroaryl, (unsubstituted aryl)-(C₁-C₄)alkyl, and (unsubstituted aryl)oxy-(C₁-C₄)alkyl.

Two of the substituents on adjacent atoms of the aryl or heteroaryl ring may optionally be replaced with a substituent of the formula -T-C(O)—(CH₂)_{q}—U—, wherein T and U are independently —NH—, —O—, —CH₂— or a single bond, and q is an integer of from 0 to 2. Alternatively, two of the substituents on adjacent atoms of the aryl or heteroaryl ring may optionally be replaced with a substituent of the formula -A-(CH₂)ₜ—B—, wherein A and B are independently —CH₂—, —O—, —NH—, —S—, —S(O)—, —S(O)₂—, —S(O)₂NR′— or a single bond, and r is an integer of from 1 to 3. One of the single bonds of the new ring so formed may optionally be replaced with a double bond. Alternatively, two of the substituents on adjacent atoms of the aryl or heteroaryl ring may optionally be replaced with a substituent of the formula —(CH₂)ₛ—X′—(CH₂)ₜ—, where s and t are independently integers of from 0 to 3, and X′ is —O—, —NR′—, —S—, —S(O)—, —S(O)₂—, or —S(O)₂NR′—. The substituent R′ in —NR′— and —S(O)₂NR′— is selected from hydrogen or unsubstituted (C₁-C₆)alkyl.

As used herein, the terms “polyethylene glycol”, “PEG”, “polyethylene oxide” or “PEO” refer to the family of biocompatible water-solubilizing linear polymers based on the ethylene glycol monomer unit described by the formula —(CH₂—CH₂—O—)ₙ- or a derivative thereof. In some embodiments, “n” is 5000 or less, 1000 or less, 500 or less, 200 or less, 100 or less, 50 or less, 40 or less, 30 or less, 20 or less, 15 or less, such as 3 to 15, or 10 to 15. It is understood that the PEG polymeric group may be of any convenient length and may include a variety of terminal groups and/or further substituent groups, including but not limited to, alkyl, aryl, hydroxyl, amino, acyl, carboxylic acid, carboxylate ester, acyloxy, and amido terminal and/or substituent groups.

As used herein, the term “amine” by itself or as part of another substituent as used herein refers to an alkyl groups as defined within, having one or more amino groups. The amino groups can be primary, secondary or tertiary. The alkyl amine can be further substituted with a hydroxy group. Amines useful in the present disclosure include, but are not limited to, ethyl amine, propyl amine, isopropyl amine, ethylene diamine and ethanolamine. The amino group can link the alkyl amine to the point of attachment with the rest of the compound, be at the omega position of the alkyl group, or link together at least two carbon atoms of the alkyl group. One of skill in the art will appreciate that other alkyl amines are useful in the present disclosure.

The term “amino group” as used herein refers to a substituent of the form —NH₂, —NHR, —NR₂, —NR₃⁺, wherein each R is independently selected, and protonated forms of each, except for —NR₃⁺, which cannot be protonated. Accordingly, any compound substituted with an amino group can be viewed as an amine. An “amino group” within the meaning herein can be a primary, secondary, tertiary, or quaternary amino group. An “alkylamino” group includes a monoalkylamino, dialkylamino, and trialkylamino group.

The term “amide” refers to a functional group having a carbonyl group attached to an amine group, having the general formula RC(═O)NR′R″, where R, R′, and R″ represent organic groups or hydrogen atoms. The term “amido” refers to a substituent containing an amide group.

As used herein, the term “(hetero)arylamino” by itself or as part of another substituent refers an amine radical substituted with an aryl group (e.g., —NH-aryl). An arylamino may also be an aryl radical substituted with an amine group (e.g., -aryl-NH₂). Arylaminos may be substituted or unsubstituted.

As used herein, the term “carbamate” by itself or as part of another substituent refers to the functional group having the structure —NR″CO₂R′, where R′ and R″ are independently selected from hydrogen, (C₁-C₈)alkyl and heteroalkyl, unsubstituted aryl and heteroaryl, (unsubstituted aryl)-(C₁-C₄)alkyl, and (unsubstituted aryl)oxy-(C₁-C₄)alkyl. Examples of carbamates include t-Boc, Fmoc, benzyloxy-carbonyl, alloc, methyl carbamate, ethyl carbamate, 9-(2-sulfo)fluorenylmethyl carbamate, 9-(2,7-dibromo)fluorenylmethyl carbamate, Tbfmoc, Climoc, Bimoc, DBD-Tmoc, Bsmoc, Troc, Teoc, 2-phenylethyl carbamate, Adpoc, 2-chloroethyl carbamate, 1,1-dimethyl-2-haloethyl carbamate, DB-t-BOC, TCBOC, Bpoc, t-Bumeoc, Pyoc, Bnpeoc, V-(2-pivaloylamino)-1,1-dimethylethyl carbamate, NpSSPeoc.

As used herein, the term “carboxylic acid” by itself or as part of another substituent refers to a structure R—COOH where R is a carbon-containing group of atoms.

As used herein, the term “carboxylate” by itself or as part of another substituent refers to the conjugate base of a carboxylic acid, which generally can be represented by the formula RCOO For example, the term “magnesium carboxylate” refers to the magnesium salt of the carboxylic acid The term “carboxylate ester” as used herein by itself or as part of another substituent refers to a compound derived from a carboxylic acid, which generally can be represented by the formula RCOOR′ where R′ can be an alkyl, alkene, alkyne, haloalkyl, heteroalkyl, cycloalkyl, aryl, heteroaryl, (unsubstituted aryl)alkyl, and (unsubstituted aryl)oxy-alkyl or other carbon-containing group of atoms. R′ can optionally contain functional groups.

As used herein, the term “sulfonate functional group” or “sulfonate” either by itself or as part of another substituent refers to both the free sulfonate anion (—S(═O)₂O—) and salts thereof. Therefore, the term sulfonate encompasses sulfonate salts such as sodium, lithium, potassium and ammonium sulfonate.

As used herein, the term “sulfonamide” by itself or as part of another substituent refers to a group of formula —SO₂NR— where R can be, for example, a water solubilizing moiety, hydrogen, alkyl, alkene, alkyne, cycloalkyl, haloalkyl, aryl, or functional group and can contain carboxylic groups. R can be a water-solubilizing polymer including, but not limited to, a polymer comprising 6 or more monomeric units, a non-ionic water-soluble polymer, PEG, modified PEG terminated with a carboxylic acid or a carboxylic ester.

As used herein, the term “sulfonamide” by itself or as part of another substituent refers to a group of formula —SO₂NR₂ where each R can independently be, for example, a water solubilizing moiety, hydrogen, alkyl, alkene, alkyne, cycloalkyl, haloalkyl, aryl, or functional group and can contain carboxylic groups. R can be a water-solubilizing polymer including, but not limited to, a polymer comprising 6 or more monomeric units, a non-ionic water-soluble polymer, PEG, modified PEG terminated with a carboxylic acid or a carboxylic ester.

As used herein, the term “sulfinamide” by itself or as part of another substituent refers to a group of formula —SONR₂ where each R can independently be, for example, a water solubilizing moiety, hydrogen, alkyl, alkene, alkyne, cycloalkyl, haloalkyl, aryl, or functional group and can contain carboxylic groups. R can be a water-solubilizing polymer including, but not limited to, a polymer comprising 6 or more monomeric units, a non-ionic water-soluble polymer, PEG, modified PEG terminated with a carboxylic acid or a carboxylic ester.

As used herein, the term “activated ester” or “active esters” by itself or as part of another substituent refers to carboxyl-activating groups employed in peptide chemistry to promote facile condensation of a carboxyl group with a free amino group of an amino acid derivative. Descriptions of these carboxyl-activating groups are found in general textbooks of peptide chemistry, for example K. D. Kopple, “Peptides and Amino Acids”, W. A. Benjamin, Inc., New York, 1966, pp. 50-51 and E. Schroder and K. Lubke, “The Peptides”; Vol. 1, Academic Press, New York, 1965, pp. 77-128.

As used herein, the terms “hydrazine” and “hydrazide” by themselves or as part of another substituent refer to compounds that contain singly bonded nitrogens, one of which is a primary amine functional group.

As used herein, the term “aldehyde” by itself or as part of another substituent refers to a chemical compound that has a —CHO group.

As used herein, the term “thiol” by itself or as part of another substituent refers to a compound that contains the functional group composed of a sulfur-hydrogen bond. The general chemical structure of the thiol functional group is R—SH, where R represents an alkyl, alkene, aryl, or other carbon-containing group of atoms.

As used herein, the term “silyl” by itself or as part of another substituent refers to Si(R^{z})₃ wherein each R^{z} independently is alkyl, aryl or other carbon-containing group of atoms.

As used herein, the term “diazonium salt” by itself or as part of another substituent refers to a group of organic compounds with a structure of R—N₂⁺X⁻, wherein R can be any organic group (e.g., alkyl or aryl) and X is an inorganic or organic anion (e.g., halogen).

As used herein, the term “triflate” by itself or as part of another substituent also referred to as trifluoromethanesulfonate, is a group with the formula CF₃SO₃.

As used herein, the term “boronic acid” by itself or as part of another substituent refers to a structure —B(OH)₂. It is recognized by those skilled in the art that a boronic acid may be present as a boronate ester at various stages in the synthesis of the quenchers. Boronic acid is meant to include such esters. The term “boronic ester” or “boronate ester” as used herein refers to a chemical compound containing a —B(Z¹)(Z²) moiety, wherein Z¹ and Z² together form a moiety where the atom attached to boron in each case is an oxygen atom. In some embodiments, the boronic ester moiety is a 5-membered ring. In some other embodiments, the boronic ester moiety is a 6-membered ring. In some other embodiments, the boronic ester moiety is a mixture of a 5-membered ring and a 6-membered ring.

As used herein, the term “maleimide” by itself or as part of another substituent refers a structure

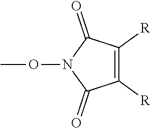

where R can be, for example, a water solubilizing moiety, hydrogen, alkyl, alkene, alkyne, cycloalkyl, haloalkyl, aryl, or other group and can contain carboxylic groups. R can be a water-solubilizing polymer including, but not limited to, a polymer comprising 6 or more monomeric units, a non-ionic water-soluble polymer, PEG, modified PEG terminated with a carboxylic acid or a carboxylic ester.

As used herein, the term “hydrazone” by itself or as part of another substituent refers to a structure

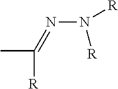

where R can be, for example, a water solubilizing moiety, hydrogen, alkyl, alkene, alkyne, cycloalkyl, haloalkyl, aryl, or other group and can contain carboxylic groups. R can be a water-solubilizing polymer including, but not limited to, a polymer comprising 6 or more monomeric units, a non-ionic water-soluble polymer, PEG, modified PEG terminated with a carboxylic acid or a carboxylic ester.

As used herein, the term “azide” by itself or as part of another substituent refers to a structure-N₃.

As used herein, the term “N-hydroxysuccinimidyl” by itself or as part of another substituent refers to a structure

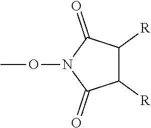

where R can be, for example, a water solubilizing moiety, hydrogen, alkyl, alkene, alkyne, cycloalkyl, haloalkyl, aryl, or other group and can contain carboxylic groups. R can be a water-solubilizing polymer including, but not limited to, a polymer comprising 6 or more monomeric units, a non-ionic water-soluble polymer, PEG, modified PEG terminated with a carboxylic acid or a carboxylic ester.

As used herein, the term “phosphoramide” by itself or as part of another substituent refers to a structure

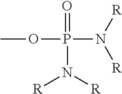

where R can be, for example, a water solubilizing moiety, hydrogen, alkyl, alkene, alkyne, cycloalkyl, haloalkyl, aryl, or other group and can contain carboxylic groups. R can be a water-solubilizing polymer including, but not limited to, a polymer comprising 6 or more monomeric units, a non-ionic water-soluble polymer, PEG, modified PEG terminated with a carboxylic acid or a carboxylic ester.

As used herein, the term “phosphonamidate” by itself or as part of another substituent refers to a structure

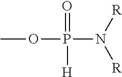

where R can be, for example, a water solubilizing moiety, hydrogen, alkyl, alkene, alkyne, cycloalkyl, haloalkyl, aryl, or other group and can contain carboxylic groups. R can be a water-solubilizing polymer including, but not limited to, a polymer comprising 6 or more monomeric units, a non-ionic water-soluble polymer, PEG, modified PEG terminated with a carboxylic acid or a carboxylic ester.

As used herein, the term “phosphinamide” by itself or as part of another substituent refers to a structure

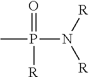

where R can be, for example, a water solubilizing moiety, hydrogen, alkyl, alkene, alkyne, cycloalkyl, haloalkyl, aryl, or other group and can contain carboxylic groups. R can be a water-solubilizing polymer including, but not limited to, a polymer comprising 6 or more monomeric units, a non-ionic water-soluble polymer, PEG, modified PEG terminated with a carboxylic acid or a carboxylic ester.

The term “chromophore’ refers to a compound having a reactive group (e.g., a carboxylate moiety, an amino moiety, a haloalkyl moiety, or the like) that can be covalently bonded. Examples of suitable chromophores include, but are not limited to, those described in U.S. Pat. Nos. 7,687,282; 7,671,214; 7,446,202; 6,972,326; 6,716,979; 6,579,718; 6,562,632; 6,399,392; 6,316,267; 6,162,931; 6,130,101; 6,005,113; 6,004,536; 5,863,753; 5,846,737; 5,798,276; 5,723,218; 5,696,157; 5,658,751; 5,656,449; 5,582,977; 5,576,424; 5,573,909; and 5,187,288, which patents are incorporated herein by reference in their entirety.

The term “moiety” refers to a group as a portion of a molecule, which may be a functional group, or a portion of a molecule with multiple groups which share common structural and/or functional aspects. Examples of group or moiety include but are not limited to a linker moiety, a functional group, a water-solubilizing moiety, a PEG moiety, according to the present disclosure.

The term “linker” or “linkage” refers to a linking moiety that connects two groups and has a backbone of 100 atoms or less in length. A linker or linkage may be a covalent bond that connects two groups or a chain of between 1 and 100 atoms in length, for example a chain of 1, 2, 3, 4, 5, 6, 8, 10, 12, 14, 16, 18, 20 or more carbon atoms in length, where the linker may be linear, branched, cyclic or a single atom. In some embodiments, the linker is a branching linker that refers to a linking moiety that connects three or more groups. In certain cases, one, two, three, four or five or more carbon atoms of a linker backbone may be optionally substituted with a sulfur, nitrogen or oxygen heteroatom. In some embodiments, the linker backbone includes a linking functional group, such as an ether, thioether, amino, amide, sulfonamide, carbamate, thiocarbamate, urea, thiourea, ester, thioester or imine. The bonds between backbone atoms may be saturated or unsaturated, and in some cases not more than one, two, or three unsaturated bonds are present in a linker backbone. The linker may include one or more substituent groups, for example with an alkyl, aryl or alkenyl group. A linker may include, without limitations, polyethylene glycol, ethers, thioethers, tertiary amines, alkyls, which may be straight or branched, e.g., methyl, ethyl, n-propyl, 1-methylethyl (iso-propyl), n-butyl, n-pentyl, 1,1-dimethylethyl (t-butyl), and the like. The linker backbone may include a cyclic group, for example, an aryl, a heterocycle or a cycloalkyl group, where 2 or more atoms, e.g., 2, 3 or 4 atoms, of the cyclic group are included in the backbone. A linker may be cleavable or non-cleavable.

A linker moiety can be attached to “L” or to “A”, as taught in US Published Application No. 2020/0190253A1, which is incorporated herein by reference in its entirety. A linker moiety can comprise covalent bond, an alkoxy, sulfonamide, disulfonamide, a selenomide, a sulfinamide, a sultam, a disulfinamide, an amide, a seleninamide, a phosphonamide, a phosphinamide, a phosphonamidate, or a secondary amine.

As described therein, and as each pertains to a linker moiety, the term “sulfonamide,” refers to a moiety —S(O)₂NR—; the term “disulfonamide,” refers to a moiety —S(O)₂NRS(O)₂—; the term “selenonamide,” refers to a moiety —Se(O)₂NR—; the term “sulfinamide,” refers to a moiety —S(O)NR²; the term “disulfinamide,” refers to a moiety —S(O)NRS(O)—; the term “seleninamide,” refers to a moiety —Se(O)NR—; the term “phosphonamide,” refers to a moiety —NR—PR(O)NR—; the term “phosphinamide,” refers to a moiety —PR(O)NR—; and the term “phosphonamidate,” refers to a moiety —O—PR(O)NR—; and the term “sultam” refers to a cyclic sulfonamide (e.g., wherein the R group is bonded to the sulfur atom via an alkylene moiety); wherein for each term the R group is independently H, alkyl, haloalkyl, or aryl.

The subject water-soluble fluorescent polymers feature termini on the conjugated polymer chains that can include a functional group that provides for bioconjugation. In some cases, such functionality is referred to as an end linker or end group. With these end linkers, a covalent bond can be formed to attach a biomolecule such as a protein, peptide, affinity ligand, antibody, antibody fragment, polynucleotide, or aptamer. For example, polymeric dye-labeled antibodies find use in flow cytometry as reagents exhibiting high brightness. Additionally, orthogonal functional groups can be installed along the conjugated polymer chain that can be used for either bioconjugation or the attachment of acceptor signaling chromophores in donor acceptor polymeric tandem dyes.

The phrase “conjugated water-soluble fluorescent polymer” refers to a water-soluble fluorescent polymer having a binding partner conjugated thereto.

“ [symbol] ” represents either a single or double bond.

The phrase “binding partner” refers to any molecule or complex of molecules capable of specifically binding to a target analyte. A binding partner of the present disclosure includes for example, a protein (e.g., an antibody or an antibody fragment), a small organic molecule, a carbohydrate (e.g., a polysaccharide), an oligonucleotide, a polynucleotide, a lipid, an affinity ligand, an aptamer, or the like. In some embodiments, the binding partner is an antibody or fragment thereof. Specific binding in the context of the present disclosure refers to a binding reaction which is determinative of the presence of a target analyte in the presence of a heterogeneous population. Thus, under certain assay conditions, the specified binding partners bind preferentially to a particular protein or isoform of the particular protein and do not bind in a significant amount to other proteins or other isoforms present in the sample.

In some cases, the antibody includes intravenous immunoglobulin (IVIG) and/or antibodies from (e.g., enriched from, purified from, e.g., affinity purified from) IVIG. IVIG is a blood product that contains IgG (immunoglobulin G) pooled from the plasma (e.g., in some cases without any other proteins) from many (e.g., sometimes over 1,000 to 60,000) normal and healthy blood donors. IVIG is commercially available. Aspects of IVIG are described, for example, in US. Pat. Appl. Pub. Nos. 2010/0150942; 2004/0101909; 2013/0177574; 2013/0108619; and 2013/0011388.

In some cases, the antibody is a monoclonal antibody of a defined sub-class (e.g., IgG1, IgG2, IgG3, or IgG4). If combinations of antibodies are used, the antibodies can be from the same subclass or from different subclasses. For example, the antibodies can be IgG1 antibodies. In some embodiments, the monoclonal antibody is humanized.

The phrase “water-soluble fluorescent polymer complex” refers to a water-soluble fluorescent polymer of the present disclosure conjugated with a binding partner.

The phrase “protected group” (also referred to as “protecting group”) refers to a reversibly formed derivative of an existing functional group in a molecule attached to decrease reactivity so that the protected functional group does not react under synthetic conditions to which the molecule is subjected.

The term “substrate” refers to a solid material having a variety of configurations. The substrate can be, for example, a sheet, bead, or other structure, such as a plate with wells, a polymer, particle, a semiconductor surface, nanotubes, a fibrous mesh, hydrogels, porous matrix, a pin, a microarray surface, a chromatography support, and the like. In some instances, the substrate is selected from the group consisting of a particle, a planar solid substrate, a fibrous mesh, a hydrogel, a porous matrix, a pin, a microarray surface and a chromatography support.

The term “water” as used herein refers to any aqueous solution that is primarily water and is compatible with physiological conditions. In some instances, the aqueous solution contains more than 50% water, such as more than 60% water, more than 70% water, more than 80% water, more than 90% water, or more than 95% water. The term “water” includes, for example, biological buffers and other aqueous solutions that may contain additives such as salts, detergents, stabilizers, and other water-soluble components, for example, sugars, proteins, amino acids, and nucleotides. In some instances, “water” may be an aqueous solution containing up to 10% miscible organic solvent (e.g., up to 10% DMSO in water). The term “water” does not include pure solvents or solvent combinations different from water, such as pure alcohols, for example pure methanol or ethanol, pure ethers, for example pure diethyl ether or tetrahydrofuran, or any other pure solvent either miscible or not miscible with water.

The term “water solubilizing moiety” or “water solubilizing group” (WSG or W¹) as used herein by itself or part of another group refers to any hydrophilic group that is well solvated in aqueous environments, for example such as under physiological conditions, and is capable of increasing the water solubility of the molecule to which it is attached. The increase in water solubility of the molecule can vary depending upon the moiety attached. In some instances, the increase in water solubility (as compared to the solubility of the molecule without the moiety attached) is 2 fold or more, 5 fold or more, 10 fold or more, 25 fold or more, 50 fold or more, or 100 fold or more.

Any convenient WSG may be included in the dyes described herein to provide for increased water-solubility. A water-solubilizing moiety can increase the solubility of a compound in a predominantly aqueous solution, as compared to a control compound which lacks the water-solubilizing moiety. The water-solubilizing moiety may be any convenient hydrophilic moiety that is well solvated in aqueous environments. In some instances, the WSG can be capable of imparting solubility in “water” (e.g., aqueous buffer) as used herein of >1 mg/mL, >2 mg/mL, >3 mg/mL, >4 mg/mL, >5 mg/mL, >6 mg/mL, >7 mg/mL, >8 mg/mL, >9 mg/mL, or >10 mg/mL. In some instances, the water-solubilizing moiety can be capable of imparting solubility in water>10 mg/mL, >20 mg/mL, >30 mg/mL, >40 mg/mL, >50 mg/mL, >60 mg/mL, >70 mg/mL, >80 mg/mL, >90 mg/mL or >100 mg/mL.

It is understood that water soluble polymers may, under certain conditions, form discrete water-solvated nanoparticles in aqueous systems and can be resistant to aggregation.

In some instances, the increase in water solubility (as compared to the solubility of the molecule without the moiety attached) is 2 fold or more, 5 fold or more, 10 fold or more, 25 fold or more, 50 fold or more, or 100 fold or more. In some cases, the water-solubilizing moiety is charged, e.g., a positively or negatively charged hydrophilic moiety. In some instances, the water-solubilizing moiety is a neutral hydrophilic moiety. In some instances, the water-solubilizing moiety is branched (e.g., as described herein). In some instances, the water-solubilizing moiety is linear. Water-solubilizing moieties include, but are not limited to, those taught in US Patent Publication No. 2022/0348770 which is incorporated herein by referenced in its entirety.

Any convenient WSG may be included in the dyes described herein to provide for increased water-solubility. WSGs may be, but are not limited to, carboxylate, phosphonate, phosphate, sulfonate, sulfate, sulfinate, sulfonium, ester, polyethylene glycols (PEG) and modified PEGs, linear PEG groups, branched PEG groups, hydroxyl, amine, amino acid, ammonium, guanidinium, pyridinium, polyamine and sulfonium, polyalcohols, straight chain or cyclic saccharides, primary, secondary, tertiary, or quaternary amines and polyamines, phosphonate groups, phosphinate groups, ascorbate groups, glycols, including, polyethers, a zwitterionic derivative, a peptide sequence, nucleotides (DNA and RNA), a peptoid, a carbohydrate, an oxazoline, a polyol, a dendron, a dendritic polyglycerol, a cellulose, a chitosan, —COOM′, —SO₃M′, —PO₃M′, —NR³₊, Y′, (CH₂CH₂O)ₚR and mixtures thereof, where Y′ can be any halogen, sulfate, sulfonate, or oxygen containing anion, p can be 1 to 500, each R can be independently H or an alkyl (such as methyl) and M′ can be a cationic counterion or hydrogen, —(CH₂CH₂O)_{yy}CH₂CH₂XR^{yy}, —(CH₂CH₂O)_{yy}CH₂CH₂X—, —X(CH₂CH₂O)_{yy}CH₂CH₂—, glycol, and polyethylene glycol, wherein yy is selected from 1 to 1000, X is selected from O, S, and NR^{ZZ}, and R^{ZZ} and R^{YY} are independently selected from H and C₁₋₃ alkyl, and combinations or derivatives thereof. In some instances, WSGs include, but are not limited to, PEG, a modified PEG, a peptide sequence, a peptoid, a carbohydrate, an oxazoline, a polyol, a dendron, a dendritic polyglycerol, a cellulose, a chitosan, or a derivative thereof. WSGs may be unsubstituted or substituted.

In some instances, the WSGs may be a hydrophilic polymer. For example, hydrophilic polymers that can be utilized in the WSG include, but are not limited to, polyalkylene oxide based polymers comprising an ethylene oxide repeat unit of the formula (CH₂—CH₂—O)ₙ— or —(O—CH₂—CH₂)ₙ—, such as, for example, PEG, polyamide alkylene oxide, or derivatives thereof. Further examples of polymers of interest include a polyamide having a molecular weight greater than 1,000 Daltons of the formula —[C(O)—X—C(O)—NH—Y—NH]ₙ— or —[NH—Y—NH—C(O)—X—C(O)]ₙ—, where X and Y are divalent radicals that may be the same or different and may be branched or linear, and n is a discrete integer from 2-100, such as from 2 to 50, and where either or both of X and Y comprises a biocompatible, substantially non-antigenic water-soluble repeat unit that may be linear or branched. The number of such water-soluble repeat units can vary significantly, with the number of such units being from 2 to 500, 2 to 400, 2 to 300, 2 to 200, 2 to 100, 6-100, for example from 2 to 50 or 6 to 50. An example of an embodiment is one in which one or both of X and Y is selected from: —((CH₂)ₙ₁—(CH₂—CH₂—O)ₙ₂—(CH₂)— or —((CH₂)ₙ₁—(O—CH₂—CH₂)ₙ₂—(CH₂)ₙ₁—), where n1 is 1 to 6, 1 to 5, 1 to 4, or 1 to 3, and where n2 is 2 to 50, 2 to 25, 2 to 15, 2 to 10, 2 to 8, or 2 to 5. In some instances, the water-soluble polymer is a group of 1-50 monomeric units, such as 1-40, 1-30, 1-20, 2-24, 2-20, 2-10 or 2-6 monomeric units. A further example of an embodiment is one in which X is —(CH₂—CH₂)—, and where Y is —(CH₂—(CH₂—CH₂—O)₃—CH₂—CH₂—CH₂)— or —(CH₂—CH₂—CH₂—(O—CH₂—CH₂)₃—CH₂)—. In certain instances, any one of the formulae described herein may be substituted with a water-soluble moiety that is a dendron, as known in art.

In some instances, hydrophilic polymers can be, for example, PEG, a peptide sequence, a peptoid, a carbohydrate, an oxazoline, a polyol, a dendron, a dendritic polyglycerol, a cellulose, a chitosan, or a derivative thereof.

In some cases, a WSG is (CH₂)ₓ(OCH₂CH₂)_{y}OCH₃ where each x is independently an integer from 0-20, each y is independently an integer from 0 to 50. In some instances, the water-soluble polymer is a PEG group or modified PEG polymer of 6-24 monomeric units, such as 10-30, 10-24, 10-20, 12-24, 12-20, 12-16 or 16-20 monomeric units.

In some cases, the WSG includes a non-ionic polymer (e.g., a PEG polymer) substituted at the terminal with an ionic group (e.g., a sulfonate). In some embodiments of the formulae, the WSG includes a substituent selected from (CH₂)ₓ(OCH₂CH₂)_{y}OCH₃ where each x is independently an integer from 0-20, each y is independently an integer from 0 to 50; and a benzyl optionally substituted with one or more halogen, hydroxyl, C₁-C₁₂ alkoxy, or (OCH₂CH₂)_{z}OCH₃ where each z is independently an integer from 0 to 50. In some instances, the WSG is (CH₂)₃(OCH₂CH₂)₁₁OCH₃. In some embodiments, one or more of the substituents is a benzyl substituted with at least one WSG groups (e.g., one or two WSG groups) selected from (CH₂)ₓ(OCH₂CH₂)_{y}OCH₃ where each x is independently an integer from 0-20 and each y is independently an integer from 0 to 50. It is understood that hydroxy-terminated polymer chains (e.g., PEG chains) instead of methoxy-terminated polymer chains (e.g., PEG chains) may be utilized in any of the water-solubilizing moieties.

The term modified polymer, such as a modified PEG, refers to water soluble polymers that have been modified or derivatized at either or both terminals, e.g., to include a terminal substituent (e.g., a terminal alkyl, substituted alkyl, alkoxy or substituted alkoxy, etc.) and/or a terminal linking functional group (e.g., an amino or carboxylic acid group suitable for attachment via amide bond formation) suitable for attached of the polymer to a molecule of interest (e.g., to a light harvesting chromophore via a branching group). The subject water-soluble polymers can be adapted to include any convenient linking groups. It is understood that in some cases, the water-soluble polymer can include some dispersity with respect to polymer length, depending on the method of preparation and/or purification of the polymeric starting materials. In some instances, the water-soluble polymers are monodisperse.

The water-soluble polymer can include one or more spacers or linkers. Examples of spacers or linkers include linear or branched moieties comprising one or more repeat units employed in a water-soluble polymer, diamino and or diacid units, natural or unnatural amino acids or derivatives thereof, as well as aliphatic moieties, including alkyl, aryl, heteroalkyl, heteroaryl, alkoxy, and the like, which can contain, for example, up to 18 carbon atoms or even an additional polymer chain.

The water-soluble polymer moiety, or one or more of the spacers or linkers of the polymer moiety when present, may include polymer chains or units that are biostable or biodegradable. For example, polymers with repeat linkages have varying degrees of stability under physiological conditions depending on bond lability. Polymers with such bonds can be categorized by their relative rates of hydrolysis under physiological conditions based on known hydrolysis rates of low molecular weight analogs, e.g., from less stable to more stable, e.g., polyurethanes (—NH—C(O)—O—)>polyorthoesters (—O—C((OR)(R′))—O—)>polyamides (—C(O)—NH—). Similarly, the linkage systems attaching a water-soluble polymer to a target molecule may be biostable or biodegradable, e.g., from less stable to more stable: carbonate (—O—C(O)—O—)>ester (—C(O)—O—)>urethane (—NH—C(O)—O—)>orthoester (—O—C((OR)(R′))—O—)>amide (—C(O)—NH—). In general, it may be desirable to avoid use of a sulfated polysaccharide, depending on the lability of the sulfate group. In addition, it may be less desirable to use polycarbonates and polyesters. These bonds are provided by way of example, and are not intended to limit the types of bonds employable in the polymer chains or linkage systems of the water-soluble polymers useful in the WSGs disclosed herein.

In some instances, the water-solubilizing moieties include, but are not limited to, hydroxy, alkoxy, (hetero)aryloxy, (hetero)arylamino, PEG, linked PEG, amide-PEG, sulfonamide-PEG, phosphoramide-PEG, ammonium alkyl salt, ammonium alkyloxy salt, ammonium oligoether salt, carbonyl, acyl, sulfonate, alkyl sulfonate, alkyl carboxylate, sulfonate alkyl salt, sulfonate alkoxy salt, sulfonate oligoether salt, sulfonamido oligoether, sulfonamide, sulfinamide, phosphonamidate, phosphinamide, alkoxy sulfonamide PEG, alkylcarboxylate, alkylamide, alkoxy sulfonate, alkyl sulfonate, alkyl sulfonate salt,

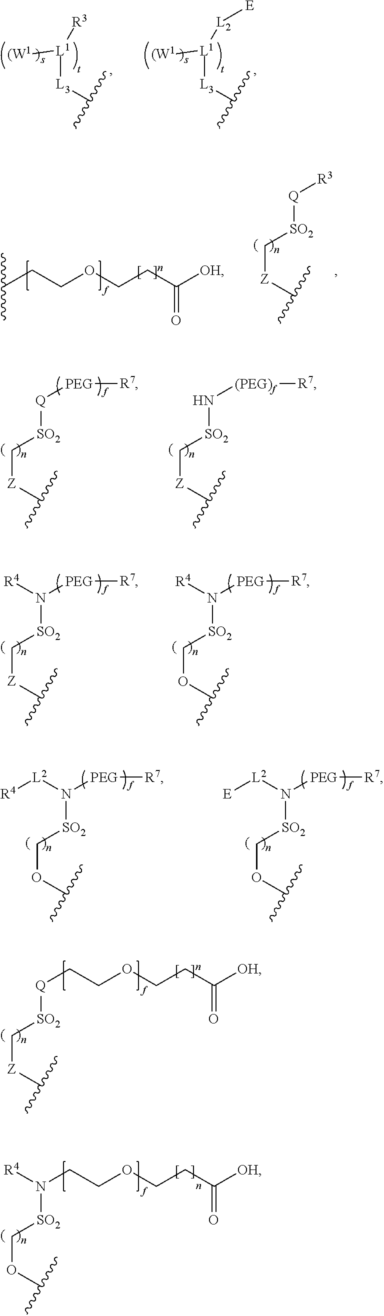

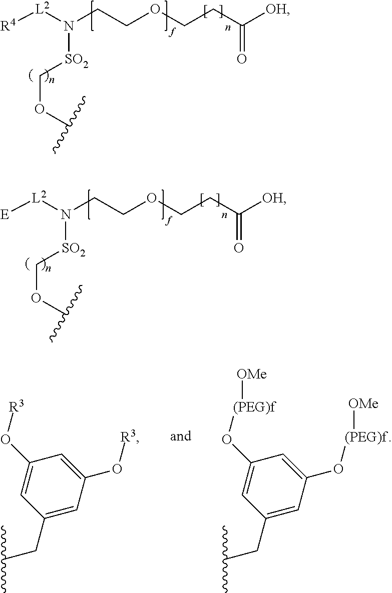

In some instances, the subject compounds may comprise multiple water-solubilizing moieties attached at a single location in the subject compounds, for example, via a branching linker, such as, for example, an aralkyl substituent further di-substituted with water solubilizing groups. As such, in some cases, the branching linker group is a substituent of the dye that connects the dye to two or more water solubilizing groups. In some instances, multiple water-solubilizing moieties may be attached to the subject compounds via groups having, for example, the following formulas:

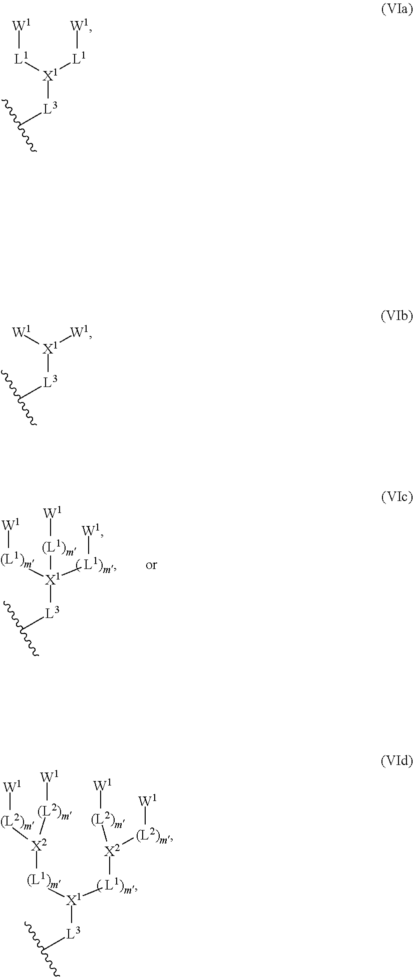

wherein X¹, X² are branching points, L¹, L², L³ are linkers, m′ is an integer from 1, 2, or 3; W¹ is a water-solubilizing moiety.

In some instances, one or more water-solubilizing moieties may be attached to the subject compounds via a group comprising linkers according to the disclosure, for example, as taught in US Published Application No. 2020/0190253A1, which is incorporated herein by reference in its entirety. A linker moiety can be attached to the cyanine bridge or the heterocycloaryl groups of the fluorescent compounds of the instant disclosure. A linker may be cleavable or non-cleavable.

One or more water-solubilizing moieties can also be attached to the subject compounds via a group comprising linkers, such as, for example, but not limited to, the following linker formula (VIe):

(L³)ₘ-(X¹)_{m′}-((L¹)_{m″}-(W¹)ₛ)ₜ—R³ (VIe)
wherein:
each optional L¹ and L³ is an independently selected linker moiety;
X¹, optionally present, is a branching point;
W¹ is a water-soluble moiety, including, but not limited to, a water-soluble polymer comprising 2-50, 4-30, or 6-24 monomeric units;
each m is independently 0 or 1; each m′ is independently 0 or 1; each m″ is independently 0 or 1;
each s is independently 1 or 2;
each t is independently 0, 1, 2, or 3; and
R³ is as defined herein.

In some instances, L¹, L³, and X are absent and W¹ is a water-solubilizing moiety, for example, a water-soluble polymer comprising 2-50, 4-30, or 6-24 monomeric units, such as 10-30, 10-24, 10-20, 12-24, 12-20, 12-16 or 16-20 monomeric units. In some cases, the water-solubilizing moiety may be a linear water-solubilizing moiety. For example, L¹ and X may be absent, L³ is a linker (e.g., as disclosed herein), and W¹ is a water-solubilizing moiety.

In some cases, at least one of, at least two of, or all three of L¹, L² and/or L³ may be selected from an alkyl or substituted alkyl linker, an alkenyl or substituted alkenyl linker, an alkynyl or substituted alkynyl linker, an alkoxy or substituted alkoxy linker, a PEG linker, a sulfonamido-alkyl or substituted sulfonamido-alkyl linker, an amido-alkyl or substituted amido-alkyl linker and an alkyl-amido-alkyl or substituted alkyl-amido-alkyl linker. In certain cases, the linker comprises a carbonyl group. A linker moiety can be a covalent bond, an alkoxy, sulfonamide, disulfonamide, a selenomide, a sulfinamide, a sultam, a disulfinamide, an amide, carbonyl, a seleninamide, a phosphonamide, a phosphinamide, a phosphonamidate, or a secondary amine.

In some instances, L² and L³ may be linker moieties each independently selected from the group consisting of a covalent bond, C₁₋₈ alkylene, 2- to 8-membered heteroalkylene, and a chain of between 2 and 200 backbone atoms in length, wherein the chain comprises a linear chain, a branched chain, and/or a cyclic moiety

In some instances, L¹ can be a sulfonamide, a sulfinamide, a disulfonamide, a disulfinamide, a sultam, an amide, a secondary amine, a phosphonamide, a phosphinamide, a phosphonamidate, a selenonamide, or a seleninamide.

In some instances, L³ can be a linker having a backbone of 20 atoms or less in length and W¹ is a water-solubilizing moiety (e.g., as described herein). In some instances, L³ can be selected from an alkyl or substituted alkyl linker, an alkenyl or substituted alkenyl linker, an alkynyl or substituted alkynyl linker, an acyl or substituted acyl, an alkoxy or substituted alkoxy linker, a PEG linker, a sulfonamido-alkyl or substituted sulfonamido-alkyl linker, an amido-alkyl or substituted amido-alkyl linker and an alkyl-amido-alkyl or substituted alkyl-amido-alkyl linker. In some instances, L³ can be a bond. In some instances, L³ can be an alkyl or substituted alkyl linker, an alkenyl or substituted alkenyl linker, an alkynyl or substituted alkynyl linker, an alkoxy or substituted alkoxy linker and X can be an aryl group.

In some instances, L¹ and L³ are each independently selected from a C₁-C₁₂ alkyl or substituted alkyl linker, a C₁-C₁₂ alkenyl or substituted alkenyl linker, a C₁-C₁₂ alkynyl or substituted alkynyl linker, a C₁-C₁₂ acyl or substituted acyl linker, a C₁-C₁₂ alkoxy or substituted alkoxy linker, a C₁-C₁₂ amido-alkyl or substituted amido-alkyl linker, a C₁-C₁₂ alkyl-amido-alkyl or substituted alkyl-amido-alkyl linker, a sulfonamide, a sulfinamide, a disulfonamide, a disulfinamide, a sultam, an amide, a secondary amine, a phosphonamide, a phosphinamide, a phosphonamidate, a selenonamide, and a seleninamide. In certain cases, L³ comprises a carbonyl group or alkoxy group, and L¹ is a C₁-C₁₂ alkyl or substituted alkyl, a sulfonamide, a sulfinamide, a disulfonamide, a disulfinamide, a sultam, an amide, a secondary amine, a phosphonamide, a phosphinamide, a phosphonamidate, a selenonamide, and a seleninamide. In some instances, L³ can be an alkoxy or substituted alkoxy linker, X can be absent, and L¹ can be a sulfonamide, a sulfinamide, a disulfonamide, a disulfinamide, a sultam, an amide, a secondary amine, a phosphonamide, a phosphinamide, a phosphonamidate, a selenonamide, or a seleninamide.

In some instances, the branching point X¹ is selected from N, CR′, C(═O)N, SO₂N, a tri-substituted aryl moiety (e.g., a 1,3,5-phenyl), a tetra-substituted aryl moiety (e.g., a 1, 3, 4, 5-phenyl), and a tri-substituted heteroaryl group. In certain instances, the branching point X¹ is a nitrogen atom. In other instances, the branching point X¹ is CR′, where R′ is selected from hydrogen, alkyl, substituted alkyl, or -L³-W¹ (e.g., as described herein).

### III. Compositions

### Polymers

In some embodiments, the fluorescent polymer of the present disclosure comprises at least one monomer or co-monomer having a structure of any one of Formula (A1)-(A6):

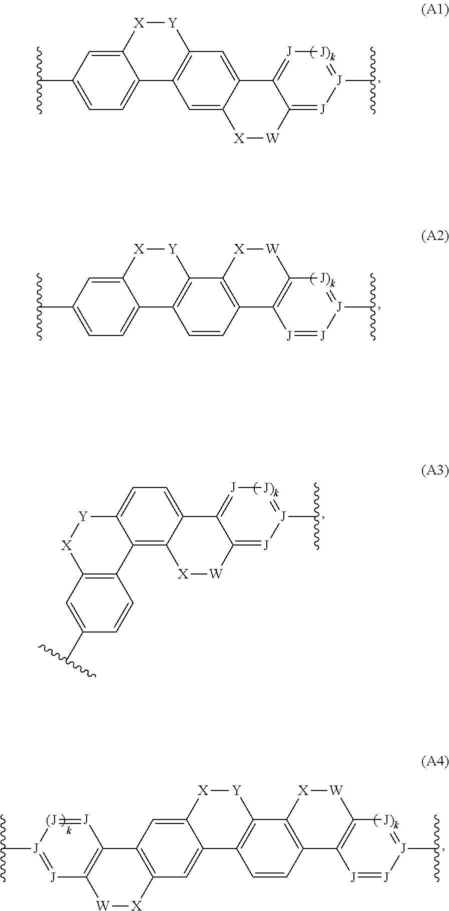

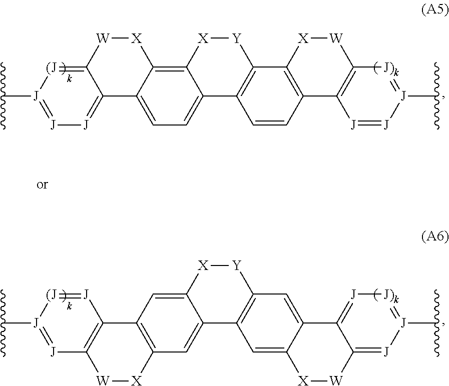

wherein
each [symbol] in A1-A6 is a site for covalent attachment to the unsaturated backbone of the fluorescent polymer, such as any other component of the polymer described in Formula (I).

X can be CH₂. X can be CR¹R². X can be CHR¹. X can be CHR². X can be X′R¹R². X can be NH. X can be NR¹. X can be O. X can be S. X can be SO. X can be SO₂. X can be SONHR². X can be PR⁷. X can be PO(R⁷)₂. X can be POR². X can be P(O)OH. X can be PONHR². X can be SiR¹R². Each X can be different. Each X can be the same.

Y can be CH₂. Y can be CR¹R². Y can be CHR². Y can be CHR². Y can be X′R¹R². Y can be NH. Y can be NR¹. Y can be O. Y can be S. Y can be SO. Y can be SO₂. Y can be SONHR². Y can be PR′. Y can be PO(R⁷)₂. Y can be POR². Y can be P(O)OH. Y can be PONHR². Y can be SiR¹R². Y can be X. Each Y can be different. Each Y can be the same.

X′ can be C. X′ can be Si.

W can be a covalent bond. When W is a covalent bond X is directly bonded to both rings. W can be Y. Each W can be different. Each W can be the same.

At least one of W, X, or Y comprises a water-solubilizing group.

J can be CH. J can be NR⁴. J can be S. J can be O. J can be Se. J can be Si. Each J can be different. Each J can be the same.

R¹ can be a water-solubilizing moiety. R¹ can be alkene. R¹ can be C₁₋₁₀-alkene. R¹ can be methene, ethene, n-propene, i-propene, n-butene, i-butene, or t-butene. R¹ can be alkyne. R¹ can be C₁₋₁₀-alkyne. R¹ can be methyne, ethyne, n-propyne, i-propyne, n-butyne, i-butyne, or t-butyne. R¹ can be cycloalkyl. R¹ can be haloalkyl. R¹ can be (hetero)aryloxy. R¹ can be (hetero)arylamino. R¹ can be PEG. R¹ can be carboxylic acid. R¹ can be ammonium alkyl salt. R¹ can be ammonium alkyloxy salt. R¹ can be ammonium oligoether salt. R¹ can be sulfonate alkyl salt. R¹ can be sulfonate alkoxy salt. R¹ can be sulfonate oligoether salt. R¹ can be sulfonamido oligoether. R¹ can be sulfonamide. R¹ can be sulfinamide. R¹ can be phosphonamidite. R¹ can be phosphinamide.

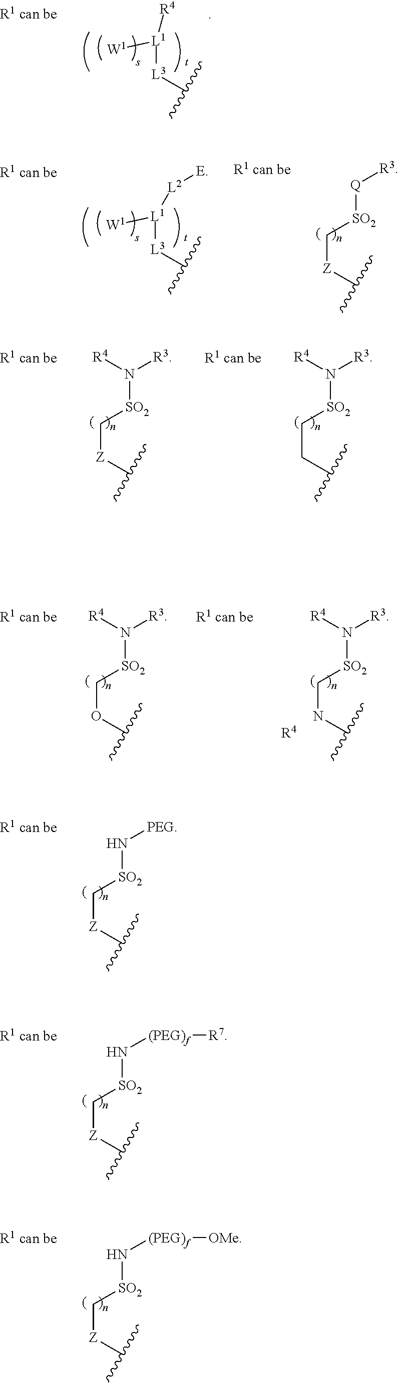

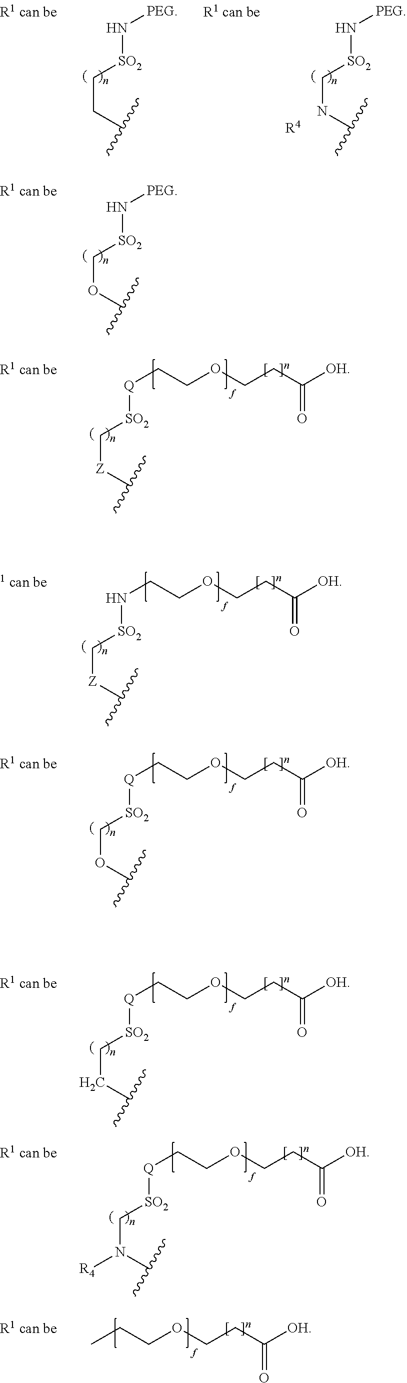

Each instance of R¹ can be different. All instances of R¹ can be the same.

R² can be a water-solubilizing moiety. R² can be a linker moiety. R² can be C₁₋₁₀-alkyl. R² can be methyl, ethyl, n-propyl, i-propyl, n-butyl, i-butyl, or t-butyl. R² can be alkene. R² can be C₁₋₁₀-alkene. R² can be methene, ethene, n-propene, i-propene, n-butene, i-butene, or t-butene. R² can be alkyne. R² can be C₁₋₁₀-alkyne. R² can be methyne, ethyne, n-propyne, i-propyne, n-butyne, i-butyne, or t-butyne. R² can be cycloalkyl. R² can be haloalkyl. R² can be alkoxy. R² can be (hetero)aryloxy. R² can be aryl. R² can be (hetero)arylamino. R² can be PEG. R² can be sulfonamide-PEG. R² can be phosphoramide-PEG. R² can be ammonium alkyl salt. R² can be ammonium alkyloxy salt. R² can be ammonium oligoether salt. R² can be sulfonate alkyl salt. R² can be sulfonate alkoxy salt. R² can be sulfonate oligoether salt. R² can be sulfonamido oligoether. R² can be sulfonamide. R² can be sulfinamide. R² can be phosphonamidite. R² can be phosphinamide.

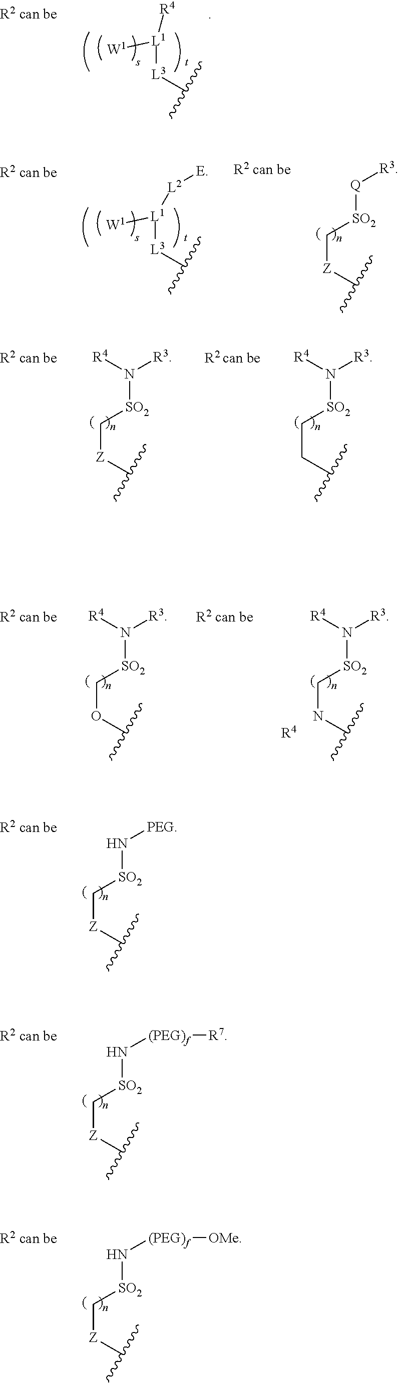

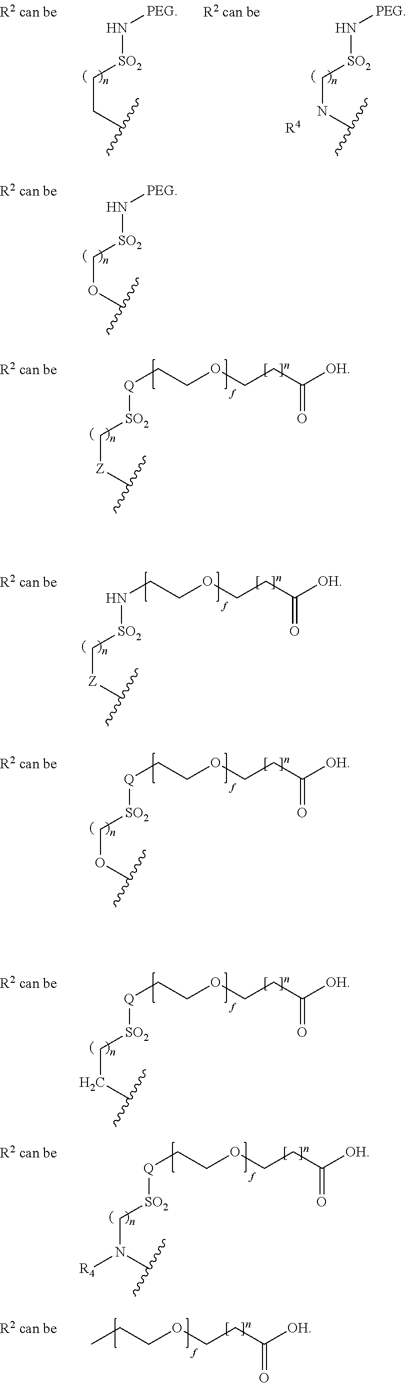

Each instance of R² can be different. All instances of R² can be the same.

R³ can be a WSG. R³ can be PEG or modified PEG polymer. The modified PEG polymer can be of 6-30 monomeric units, such as 6-24 or 10-30, 10-24 or 10-20, 12-24, 12-20, 12-16 or 16-20 monomeric unit. The modified PEG polymer can be terminated with a carboxylic acid or carboxylate ester. R³ can be

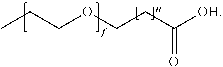

R³ can be alkyl. R³ can be a polymer comprising 6-24 monomeric units.

W¹ can be a water-solubilizing moiety. In some embodiments, W¹ is a water solubilizing moiety selected from ethylene glycol, PEG groups, carboxy groups including but not limited to carboxylic acids and carboxylates, polyvinyl alcohols, glycols, peptides, polyphosphates, polyalcohols, sulfonates, phosphonates, boronates, amines, ammoniums, sulfoniums, phosphonium, alcohols, polyols, oxazolines, zwitterionic derivatives, carbohydrates, nucleotides, polynucleotides, substituted PEG groups, substituted carboxy groups including but not limited to substituted carboxylic acids and substituted carboxylates, substituted glycols, substituted peptides, substituted polyphosphates, substituted polyalcohols, substituted sulfonates, substituted phosphonates, substituted boronates, substituted amines, substituted ammoniums, substituted sulfoniums, substituted phosphonium, alcohols, substituted zwitterionic derivatives, substituted carbohydrates, substituted nucleotides, substituted polynucleotides, or combinations thereof.

In some cases, each f is an integer from 0 to 50, 1 to 50, 2 to 40, 3 to 30, or 5 to 25.

In some cases, each m is an integer from 1 to about 10,000, 2 to 8,000, 3 to 5,000, 4 to 1,000, 5 to 500, 6 to 100, or 10 to 50.

In some cases, W¹ comprises one or more ethylene glycol monomers. In some cases, W¹ comprises a PEG containing moiety.

L¹ can be a linker moiety. L² can be a linker moiety. L³ can be a linker moiety.

Linking moieties L¹, L², and L³ may independently be, but are not limited to, a covalent bond, C₁₋₈ alkylene, 2- to 8-membered heteroalkylene. In some embodiments, the linker is a single atom, a linear chain, a branched chain, a cyclic moiety. In some embodiments, the linker is chain of between 2 and 100 backbone atoms (e.g., carbon atoms) in length, such as between 2 and 50 backbone atoms in length or between 2 and 20 atoms backbone atoms in length. In certain cases, one, two, three, four or five or more carbon atoms of a linker backbone can be optionally replaced with sulfur, nitrogen, or oxygen. The bonds between backbone atoms can be saturated or unsaturated; typically, not more than one, two, or three unsaturated bonds will be present in a linker backbone. The linker can include one or more substituent groups (e.g., an alkyl group or an aryl group). A linker can include, without limitation, oligo(ethylene glycol); ethers; thioethers; tertiary amines; and alkylene groups (i.e., divalent alkyl radicals), which can be straight or branched. The linker backbone can include a cyclic group, for example, a divalent aryl radical, a divalent heterocyclic radical, or a divalent cycloalkyl radical, where 2 or more atoms, e.g., 2, 3 or 4 atoms, of the cyclic group are included in the backbone.

In some embodiments, L¹ comprises a sulfonamide, a sulfonimide, a sultam, a disulfinamide, an amide, a phosphonamide, a phosphonamidate, a phosphinamide, a selenoonamide, a seleninamde, or a secondary amine. In some embodiments, L¹ comprises a sulfonamide, an amide, a phosphonamide, or a secondary amine. In some cases, L¹ is a linker moiety optionally terminated with L²-E. In some cases, L² comprises a linear or branched, saturated or unsaturated C₁₋₃₀ alkylene group; wherein one or more carbon atoms in the C₁₋₃₀ alkylene group is optionally and independently replaced by O, S, NR^{a}; wherein two or more groupings of adjacent carbon atoms in the C₁₋₃₀ alkylene are optionally and independently replaced by —NR^{a}(CO)— or —(CO)NR^{a}—; and wherein each IV is independently selected from H and C₁₋₆ alkyl; and wherein each R^{a} is independently selected from H and C₁₋₆ alkyl.

In some embodiments, L² is a linker moiety optionally terminated with a functional moiety selected from amine, carbamate, carboxylic acid, carboxylate, maleimide, activated ester, N-hydroxysuccinimidyl, hydrazine, hydrazide, hydrazone, azide, alkyne, aldehyde, thiol, and protected groups thereof for conjugation to a chromophore, substrate, or a binding partner;

In some embodiments, L³ is selected from the group consisting of a covalent bond, C₁₋₈ alkylene, 2- to 8-membered heteroalkylene (e.g., a divalent alkoxy linker such as —O-alkyl), C₃-8 cycloalkylene, C₆₋₁₀ arylene, 5- to 12-membered heteroarylene, 5- to 12-membered heterocyclylene, an amine, —NHC(O)L^{a}-, —C(O)NHL^{a}-, —C(O)L^{a}-, and combinations thereof, wherein L^{a} is selected from the group consisting of C₁₋₈ alkylene and 2- to 8-membered heteroalkylene.

In some cases, L¹, L² and L³ together form the following:

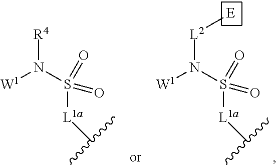

wherein L^{1a} is a linker moiety.

In some cases, L^{1a} is selected from the group consisting of a covalent bond, C₁₋₈ alkylene, 2- to 8-membered heteroalkylene (e.g., a divalent alkoxy linker), C₃-8 cycloalkylene, C₆₋₁₀ arylene, 5- to 12-membered heteroarylene, 5- to 12-membered heterocyclylene, —NHC(O)L^{a}-, —C(O)NHL^{a}-, —C(O)L^{a}-, and combinations thereof. In some embodiments, L^{1a} is selected from the group consisting of a covalent bond, C₁₋₈ alkylene, 2- to 8-membered heteroalkylene, —NHC(O)L^{a}-, —C(O)NHL^{a}-, and —C(O)L^{a}-.

In some embodiments, L³ is a trivalent arylalkyl moiety having: a first point of attachment to a first L¹ moiety (or a first L^{1a} moiety); a second point of attachment to a second L¹ moiety (or a second L^{1a} moiety); and a third point of attachment to an A monomer. For example, some embodiments of the disclosure provide conjugated polymers having two or more E groups, such as chromophores, attached as shown in Formula (L³-1):

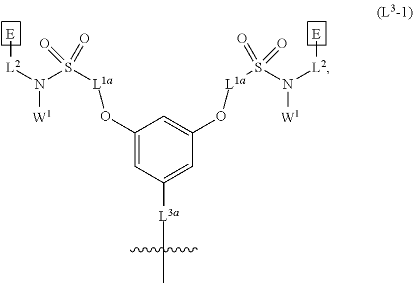

wherein L³a is selected from the group consisting of a covalent bond, C₁₋₈ alkylene, 2- to 8-membered heteroalkylene, —NHC(O)L^{a}-, —C(O)NHL^{a}-, and —C(O)L^{a}-; L^{1a} is C₁₋₈ alkylene or 2- to 8-membered heteroalkylene; and the wavy line is the point of the attachment to the A monomer.

Each E can be an independently selected chromophore, functional moiety, substrate or binding partner.

R⁴ can be H. R⁴ can be alkyl. R⁴ can be a PEG. R⁴ can be a linked PEG. R⁴ can be a water-solubilizing moiety. R⁴ can be a linked water-solubilizing moiety. R⁴ can be a linker moiety. R⁴ can be a chromophore. R⁴ can be a linked chromophore. R⁴ can be a functional group. R⁴ can be a linked functional group. R⁴ can be carboxylic amine. R⁴ can be amine. R⁴ can be carbamate. R⁴ can be carboxylic acid. R⁴ can be carboxylate. R⁴ can be maleimide. R⁴ can be activated ester. R⁴ can be N-hydroxysuccinimidyl, hydrazine. R⁴ can be L²-E. R⁴ can be hydrazide. R⁴ can be hydrazone. R⁴ can be azide. R⁴ can be alkyne. R⁴ can be alkene. R⁴ can be tetrazine. R⁴ can be aldehyde. R⁴ can be thiol. Each R⁴ can optionally have protected groups.

Q can be a bond. Q can be NR⁴. Q can be CHR⁴. Q can be —CH₂.

Z can be CH₂. Z can be CHR⁴. Z can be O. Z can be NR⁴.

R⁷ can be H. R⁷ can be C₁-C₁₂ alkyl. R⁷ can be C₂-C₁₂ alkene. R⁷ can be C₂-C₁₂ alkyne. R⁷ can be C₃-C₁₂ cycloalkyl. R⁷ can be C₁-C₁₂ haloalkyl. R⁷ can be C₁-C₁₂ alkoxy. R⁷ can be C₂-C₁₈ (hetero)aryloxy. R⁷ can be C₂-C₁₈ (hetero)arylamino. R⁷ can be C₂-C₁₂ carboxylic acid. R⁷ can be C₂-C₁₂ carboxylate ester. R⁷ can be C₁-C₁₂ alkoxy.

In some embodiments, at least one of R¹, R², R³, or R⁴ comprises a water-solubilizing moiety.

k can be 0. k can be 1. k can be 2.

f can independently be an integer from 0 to 50.

n can independently be an integer from 1 to 20.

s can be 1. s can be 2.

t can be 0. t can be 1. t can be 2. t can be 3.

In some embodiments, a fluorescent tandem polymer according to the present disclosure comprises a fluorescent polymer comprising:
at least one monomer or co-monomer having a structure of Formula (A1)-(A6):

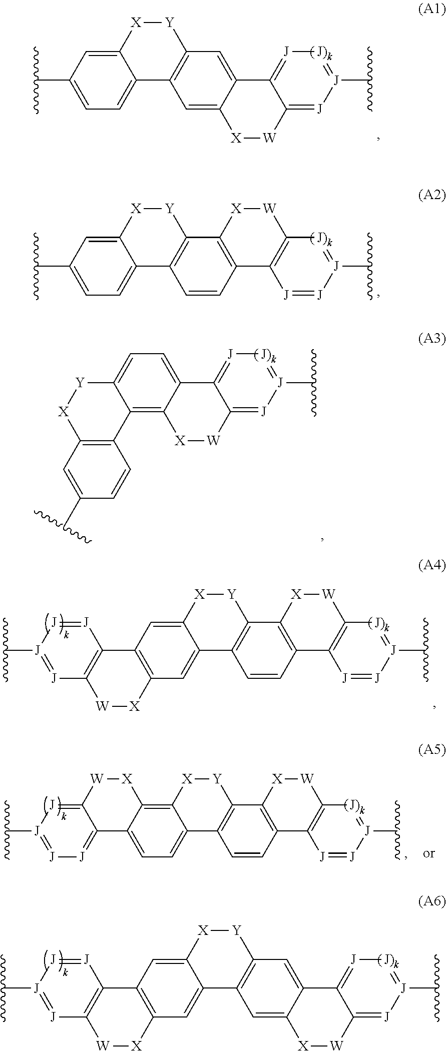

and
a signaling chromophore covalently linked to the polymeric dye in energy-receiving proximity therewith,
wherein each [symbol] in A1-A6 is a site for covalent attachment to the unsaturated backbone of the fluorescent polymer; and
wherein X, Y, W, J, R¹, and R² are as previously defined.

In some embodiments, the fluorescent tandem polymer can be water-soluble. In some embodiments, the fluorescent tandem polymer may comprise a specific binding partner covalently linked to the polymer.

In some embodiments, a labeled specific binding partner according to the present disclosure comprises a fluorescent polymer comprising at least one monomer or co-monomer having a structure of Formula (A1)-(A6):

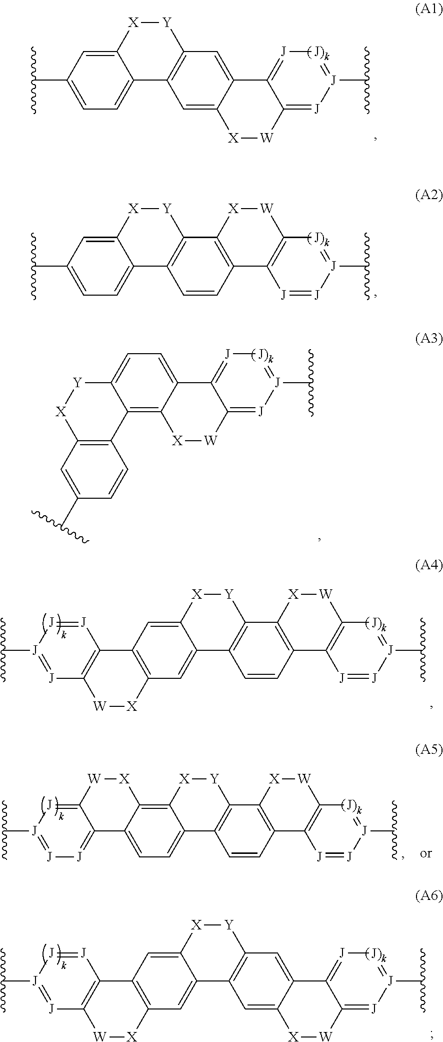

and
a specific binding partner covalently linked to the polymer,
wherein
each [symbol] in A1-A6 is a site for covalent attachment to the unsaturated backbone of the fluorescent polymer, such as any other component of the polymer described in Formula (I); and
wherein X, Y, W, J, R¹, R², and k are as previously defined.

In some embodiments, the specific binding partner may comprise a polymer that is water soluble. In some embodiments, the specific binding partner may comprise a polymer that is a fluorescent tandem polymer.

The “fused DHP fluorescent polymer” may comprise a DHP fused ring system having at least 5 fused rings, or 5 to 7 fused rings. The fused DHP fluorescent polymer may have an Extinction Coefficient at 375 nm of at least 100,000 M⁻¹ cm⁻¹ or higher.

In some embodiments, a fluorescent polymer according to the present disclosure has the structure of Formula (I):

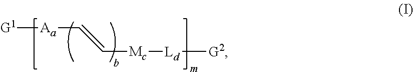

wherein
A is selected from the group consisting of

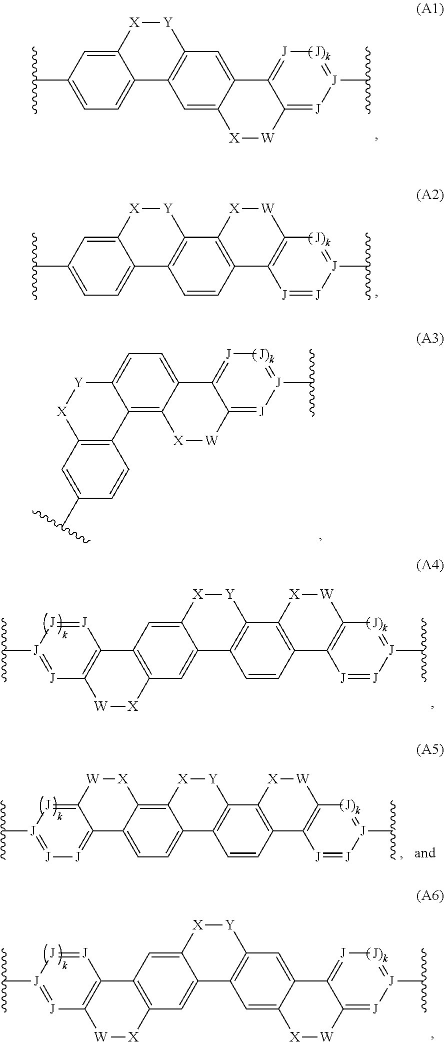

wherein each [symbol] in A1-A6 is a site for covalent attachment to the unsaturated backbone of the fluorescent polymer, including any other component of the polymer described in Formula (I); and
wherein
X, Y, W, J, R¹, and R² are as previously defined;
each optional L is a linker;
each optional M is a polymer modifying unit evenly or randomly distributed along the polymer main chain and is optionally substituted with one or more optionally substituted R¹, R², R³, or R⁴ groups;
G¹ and G² are each independently selected from an unmodified polymer terminus and a modified polymer terminus, optionally conjugated to E;
a, c, and d define the mol % of each unit within the structure which each can be evenly or randomly repeated and where each a is a mol % from 10 to 100%, each c is a mol % from 0 to 90%, and each d is a mol % from 0 to 25%;
each b is independently 0 or 1;
m is an integer from 1 to about 10,000.

The fluorescent polymer according to the present disclosure may be a water-soluble fluorescent polymer.

The fluorescent polymers of the present disclosure can contain polymer modifying units, represented in Formula I as M, that are capable of altering the polymer band gap. M can be evenly or randomly distributed along the polymer main chain. Each M is optional. M can be optionally substituted with one or more optionally substituted R¹, R², R³, or R⁴ groups.

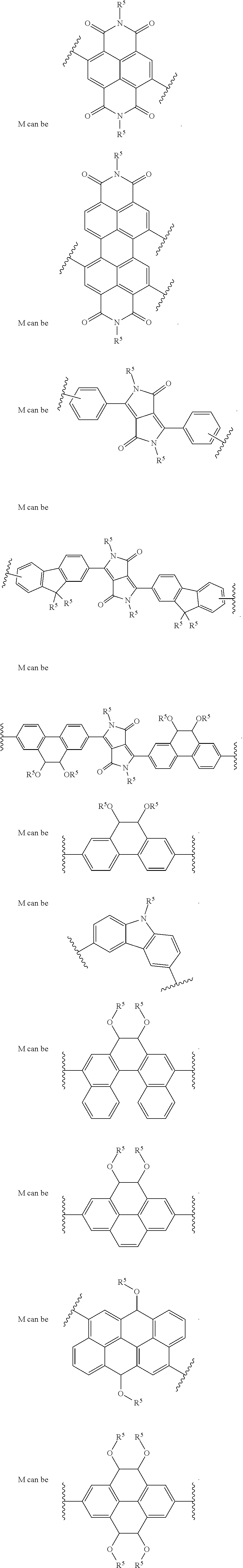

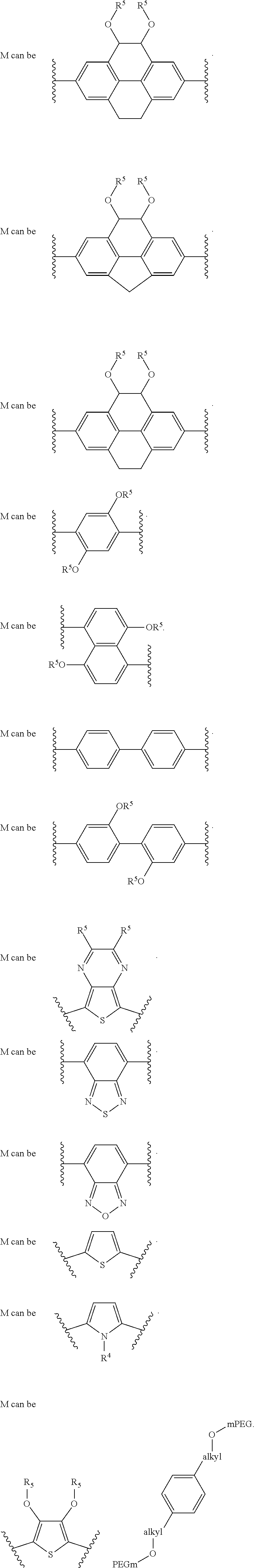

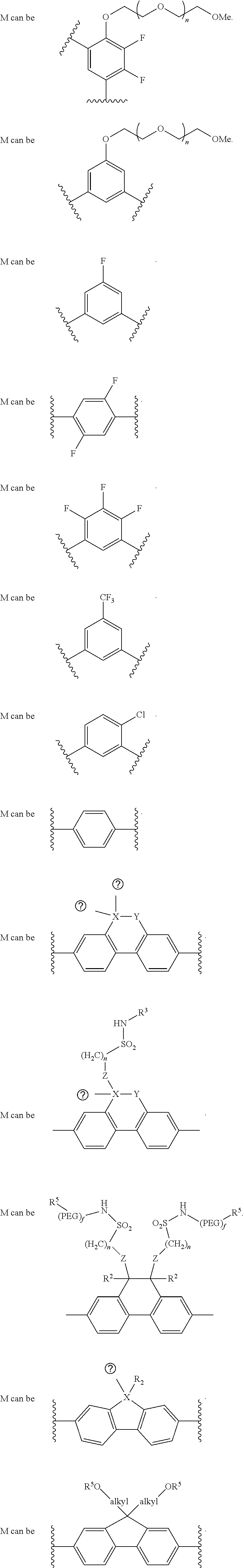

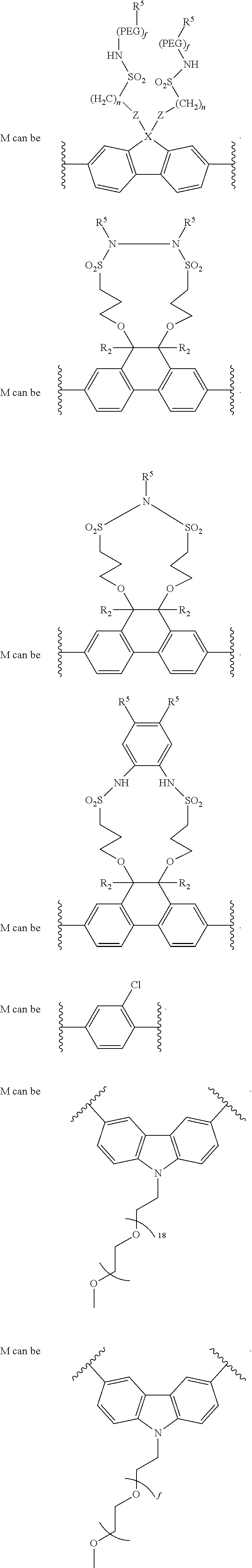

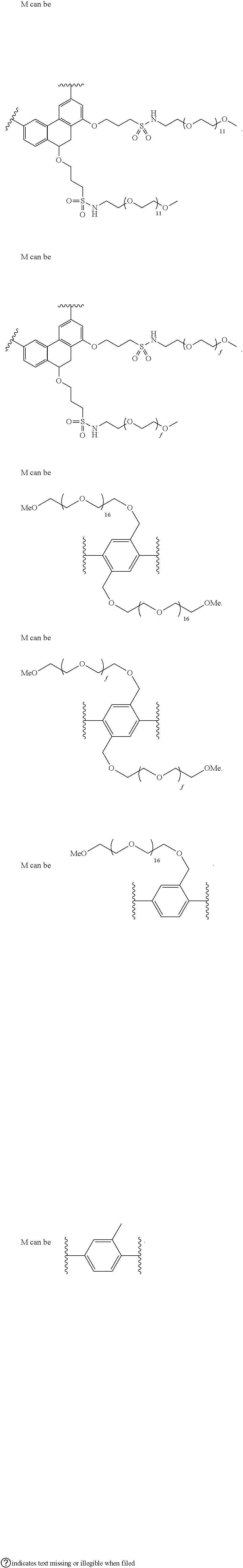

M can be substituted. M can be terminated with a functional group selected from amine, carbamate, carboxylic acid, carboxylate ester, maleimide, activated ester, N-hydroxysuccinimidyl, hydrazine, hydrazide, hydrazone, azide, alkyne, alkene, tetrazine, aldehyde, thiol, amide, sulfonamide, ether, thioether, thiocarbamate, hydroxyl, iodoacetyl, hydrazido, hydrazino, ketone, phosphine, epoxide, urea, thiourea, thioester, imine, disulfides, and protected groups thereof for conjugation to another substrate, acceptor dye, molecule or binding partner. Each of R¹, R², R³, f, and n can be as described above.

R⁵ can be halogen. R⁵ can be hydroxyl. R⁵ can be C₁-C₁₂ alkyl. R⁵ can be C₂-C₁₂ alkene. R⁵ can be C₂-C₁₂ alkyne. R⁵ can be C₃-C₁₂ cycloalkyl. R⁵ can be C₁-C₁₂ haloalkyl. R⁵ can be C₁-C₁₂ alkoxy. R⁵ can be C₂-C₁₈ (hetero)aryloxy. R⁵ can be C₂-C₁₈ (hetero)arylamino. R⁵ can be carboxylic acid. R⁵ can be carboxylate ester. R⁵ can be (CH₂)_{x′}(OCH₂—CH₂)_{y′}OCH₃. R⁵ can be C₂₋₁₈ (hetero)aryl group. x′ can be an integer from 0-20. x′ can be an integer from 0-10. x′ can be an integer from 1-4. y′ can be an integer from 0-50. y′ can be an integer from 0-40. y′ can be an integer from 0-30. y′ can be an integer from 0-20. y′ can be an integer from 0-10. y′ can be an integer from 1-4.

The fluorescent polymers of the present disclosure can also contain linkers represented in Formula I as L. Each optional L can be evenly or randomly distributed along the polymer main chain. L can be —(CH₂)ₚ—O— wherein p is from 1 to 12, e.g., 1 to 6. L can be —O—(CH₂)ₚ— wherein p is from 1 to 12, e.g., 1 to 6. L can be —(CH₂)ₚ— wherein p is from 1 to 12, e.g., 1 to 6. L can be —O—. L can be C₁-C₁₂-alkyl linker, e.g., a C₁-C₆-alkyl linker, wherein one or more backbone atoms are optionally substituted with a heteroatom. L can be an aryl group. L can be a heteroaryl group. When L is an aryl or heteroaryl group, it can be substituted with one or more pendant chains terminated with a functional group selected from the group consisting of amine, carbamate, carboxylic acid, carboxylate, maleimide, activated ester, N-hydroxysuccinimidyl, hydrazine, hydrazide, hydrazone, azide, alkyne, aldehyde, thiol, and protected groups thereof for conjugation to another substrate, acceptor dye or chromophore, molecule or binding partner.

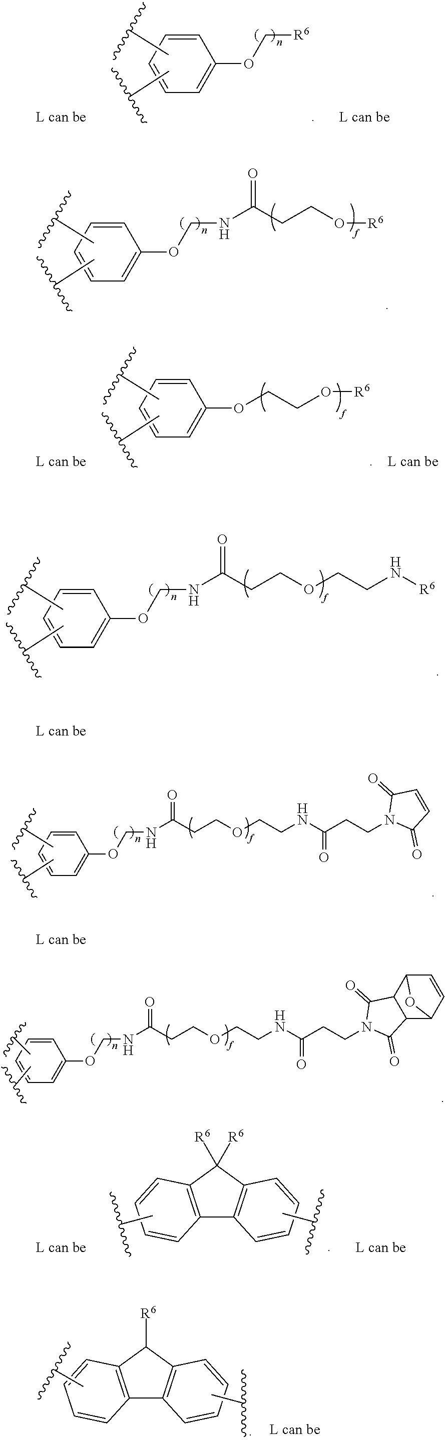

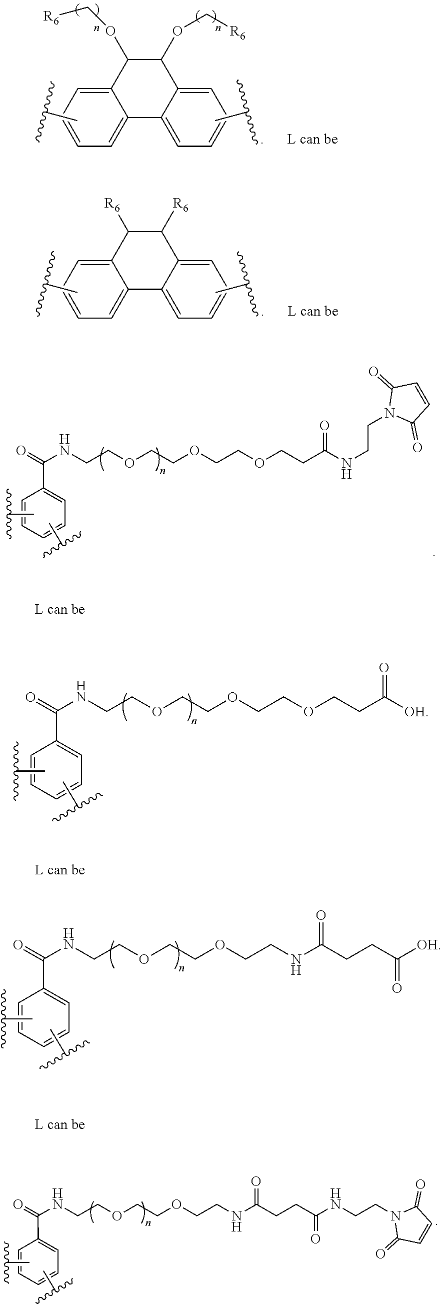

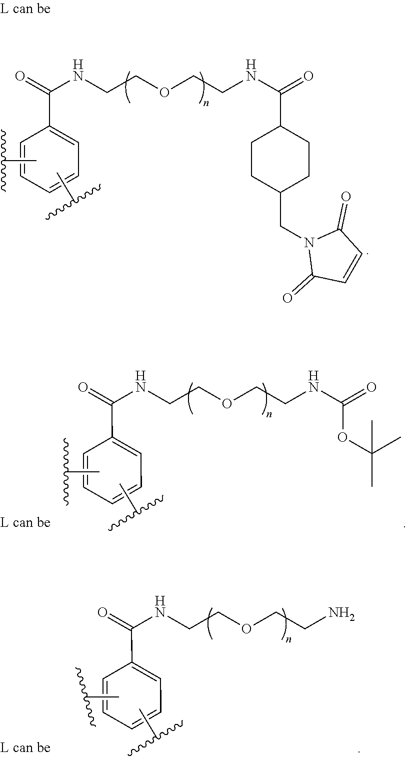

Each R⁶ is independently selected. R⁶ can be H. R⁶ can be OH. R⁶ can be SH. R⁶ can be NHCOO-t-butyl. R⁶ can be (CH₂)ₙCOOH. R⁶ can be (CH₂)ₙ(CH₂CH₂O)_{f}COOH. R⁶ can be —(CH₂)ₙCOOCH₃. R⁶ can be —(CH₂)ₙNH₂. R6 can be —(CH₂)ₙNH(CH₂)ₙCH₃. R⁶ can be —(CH₂)ₙNHCOOH. R⁶ can be —(CH₂)ₙNHCO(CH₂)ₙCO(CH₂)ₙCH₃. R⁶ can be —(CH₂)ₙNHCOO(CH₂)ₙCH₃. R⁶ can be —(CH₂)ₙNHCOOC(CH₃)₃. R⁶ can be —(CH₂)ₙNHCO(C₃-C₁₂)cycloalkyl. R⁶ can be —(CH₂)ₙNHCO(CH₂CH₂O)_{f} (C₁-C₆) alkyl. R⁶ can be —(CH₂)ₙNHCO(CH₂)ₙCOOH. R⁶ can be —(CH₂)ₙNHCO(CH₂)ₙCOO(CH₂)ₙCH₃. R⁶ can be —(CH₂)ₙ(OCH₂CH₂)_{f}OCH₃. R⁶ can be N-maleimide. R⁶ can be halogen, C₂-C₁₂ alkene. R⁶ can be C₂-C₁₂ alkyne. R⁶ can be C₃-C₁₂ cycloalkyl. R⁶ can be C₁-C₁₂ halo alkyl. R⁶ can be C₁-C₁₂ (hetero)aryl. R⁶ can be C₁-C₁₂ (hetero)arylamino. R⁶ can be benzyl optionally substituted with one or more halogen, hydroxyl, C₁-C₁₂ alkoxy, or (OCH₂CH₂)_{f}OCH₃. R⁶ can be carboxylic acid. R⁶ can be carboxylate ester

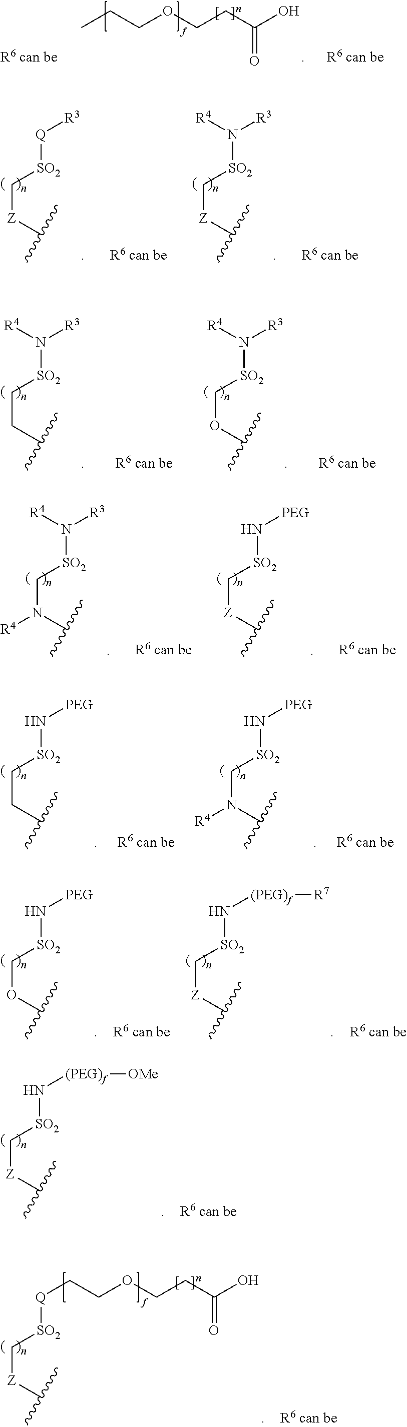

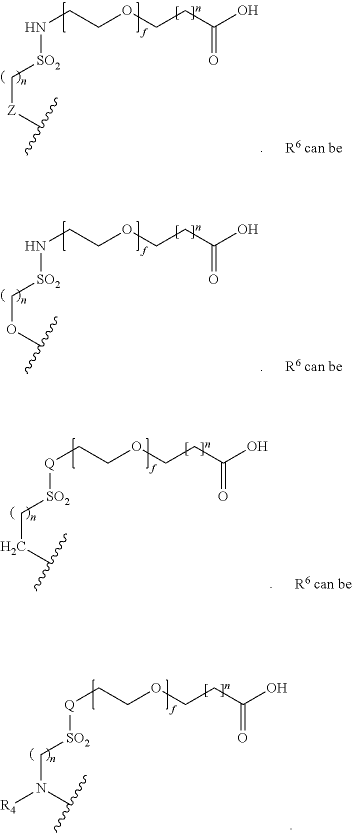

R³, R⁴, f, and n can be as described above.

The fluorescent polymers of the present disclosure also contain capping units represented in Formula I as each G¹ and G². G¹ can be hydrogen. G¹ can be halogen. G¹ can be alkyne. G¹ can be optionally substituted aryl. G¹ can be optionally substituted heteroaryl. G¹ can be halogen. G¹ can be substituted aryl. G¹ can be silyl. G¹ can be diazonium salt. G¹ can be triflate. G¹ can be acetyloxy. G¹ can be azide. G¹ can be sulfonate. In some aspect, G¹ can be phosphate. G¹ can be boronic acid substituted aryl. G¹ can be boronic ester substituted aryl. G¹ can be boronic ester. G¹ can be boronic acid. G¹ can be optionally substituted tetrahydropyrene (THP). G¹ can be optionally substituted dihydrophenanthrene (DHP). G¹ can be optionally substituted fluorene. In some aspect, G¹ can be aryl or heteroaryl substituted with one or more pendant chains terminated with a functional group selected from amine, carbamate, carboxylic acid, carboxylate, maleimide, activated ester, N-hydroxysuccinimidyl, hydrazine, hydrazide, hydrazone, azide, alkyne, aldehyde, thiol, and protected groups thereof for conjugation to a substrate, or a binding partner.

In some embodiments, G² can be hydrogen. G² can be halogen. G² can be alkyne. G² can be optionally substituted aryl. G² can be optionally substituted heteroaryl. G² can be halogen. G² can be substituted aryl. G² can be silyl. G² can be diazonium salt. G² can be triflate. G² can be acetyloxy. G² can be azide. G² can be sulfonate. G² can be phosphate. G² can be boronic acid substituted aryl. G² can be boronic ester substituted aryl. G² can be boronic ester. G² can be boronic acid. G² can be optionally substituted tetrahydropyrene (THP). G² can be optionally substituted fluorene. G² can be optionally substituted dihydrophenanthrene (DHP). G² can be aryl or heteroaryl substituted with one or more pendant chains terminated with a functional group selected from amine, carbamate, carboxylic acid, carboxylate, maleimide, activated ester, N-hydroxysuccinimidyl, hydrazine, hydrazide, hydrazone, azide, alkyne, aldehyde, thiol, and protected groups thereof for conjugation to a substrate, or a binding partner.

G¹ and G² can each independently be optionally substituted dihydrophenanthrene (DHP). G¹ and G² can each independently be optionally substituted fluorene. G¹ and G² can each independently be aryl substituted with one or more pendant chains terminated with a functional group. G¹ and G² can each independently be a heteroaryl substituted with one or more pendant chains terminated with a functional group.

G¹ and G² can each independently be

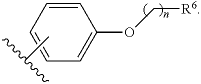

G¹ and G² can each independently be

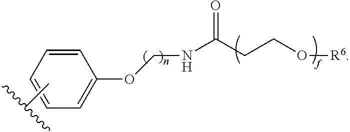

G¹ and G² can each independently be

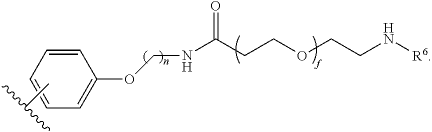

G¹ and G² can each independently be

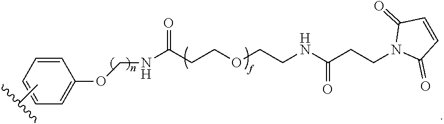

G¹ and G² can each independently be

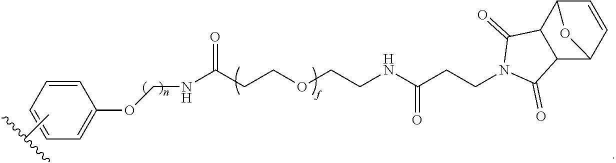

G¹ and G² can each independently be

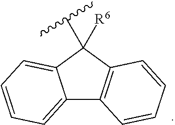

G¹ and G² can each independently be

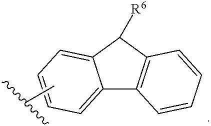

G¹ and G² can each independently be

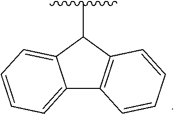 [SMILES: *C1c2ccccc2-c2ccccc21]

G¹ and G² can each independently be

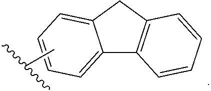

G¹ and G² can each independently be

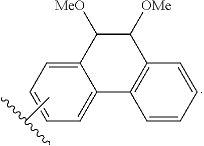

G¹ and G² can each independently be

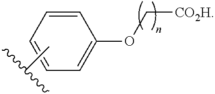

G¹ and G² can each independently be

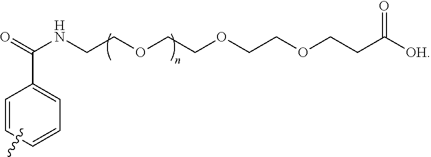

G¹ and G² can each independently be

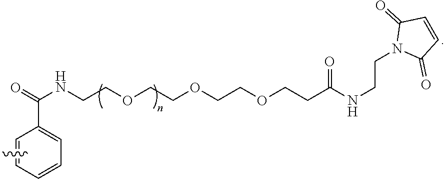

G¹ and G² can each independently be

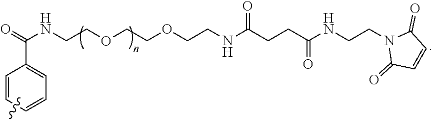

G¹ and G² can each independently be

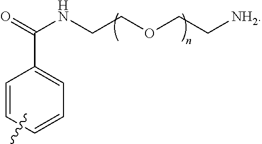

G¹ and G² can each independently be

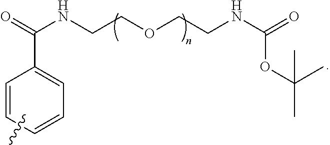

G² can each independently be

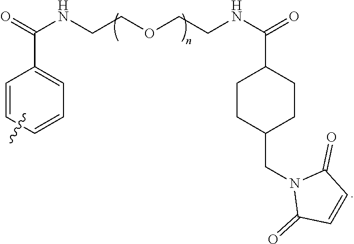

R⁶, f and n can be as described above.

a defines the mol % of the corresponding unit within the structure, wherein the corresponding unit can be evenly or randomly repeated. a can be from 10 to 100%.

c defines the mol % of the corresponding unit within the structure, wherein the corresponding unit can be evenly or randomly repeated. c can be from 0 to 90%.

d defines the mol % of the corresponding unit within the structure, wherein the corresponding unit can be evenly or randomly repeated. c can be from 0 to 25%.

b can be 0. b can be 1.

Each k can be independently 0, 1, or 2.

m can be an integer from 1 to about 10,000.

In some embodiments, the fluorescent polymer can be

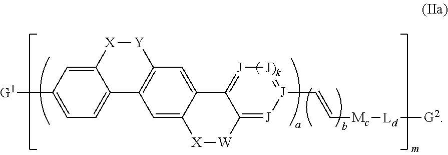

The fluorescent polymer can be

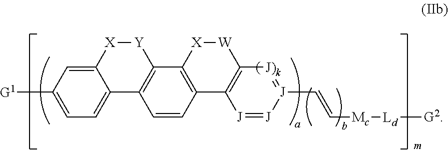

The fluorescent polymer can be

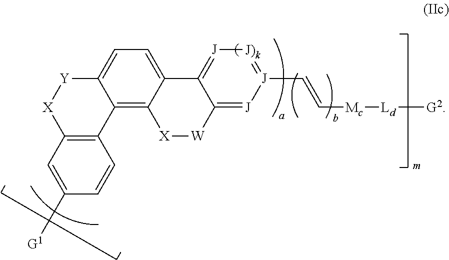

The fluorescent polymer can be

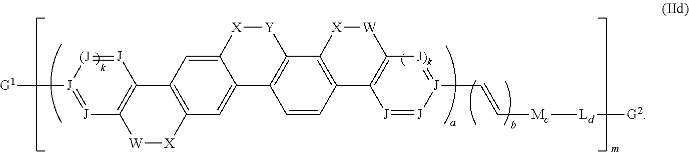

The fluorescent polymer can be

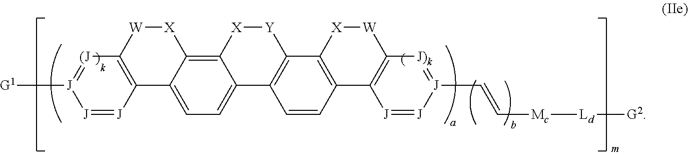

The fluorescent polymer can be

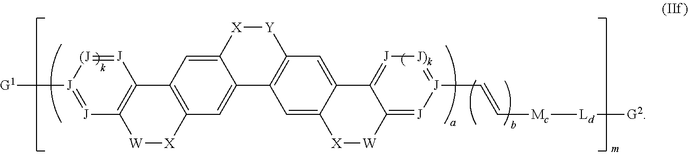

The fluorescent polymer can be

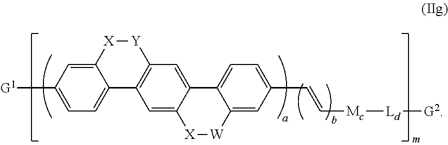

Each of X, Y, Z, W, R¹, R², M, L, J, G¹, G², a, b, c, d, and m are as described above.

In some embodiments, the fluorescent polymer can be

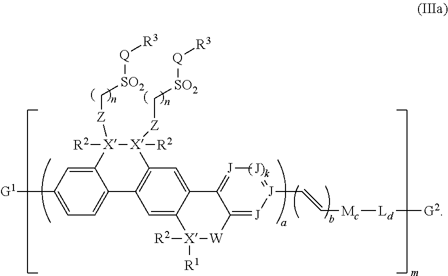

The fluorescent polymer can be

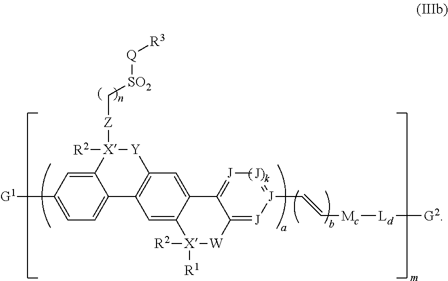

The fluorescent polymer can be

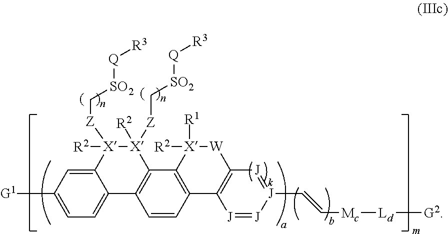

The fluorescent polymer can be

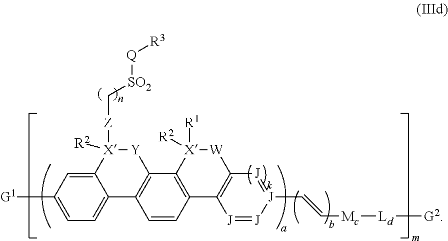

The fluorescent polymer can be

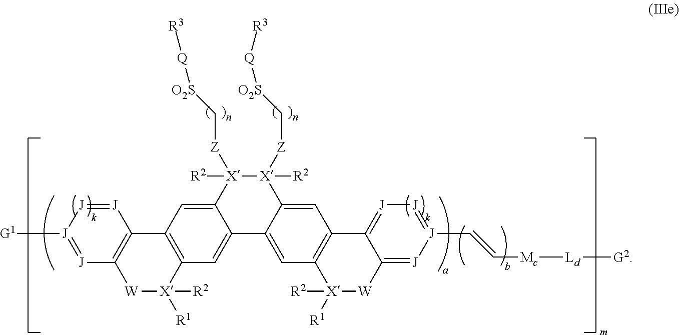

The fluorescent polymer can be

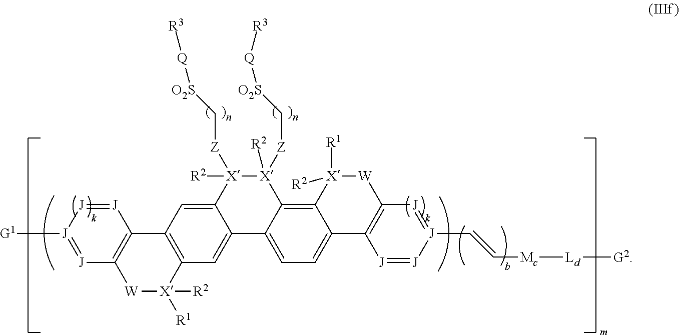

The fluorescent polymer can be

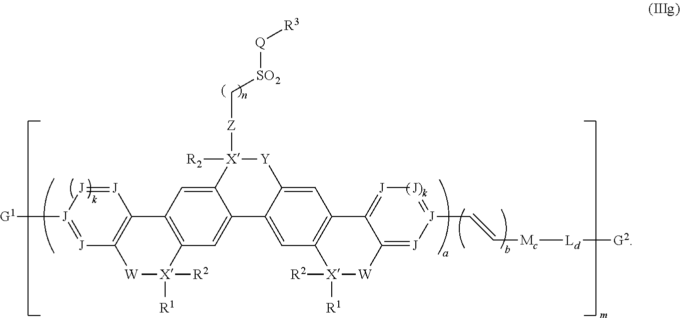

The fluorescent polymer can be

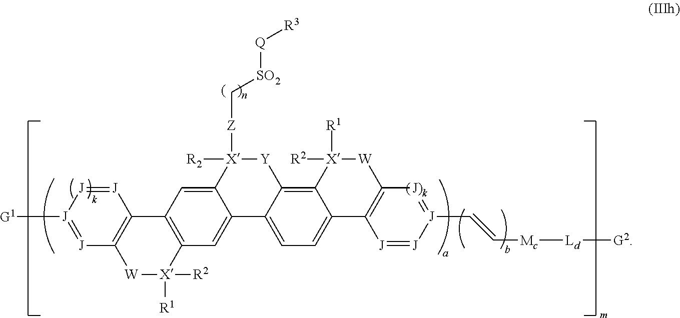

The fluorescent polymer can be

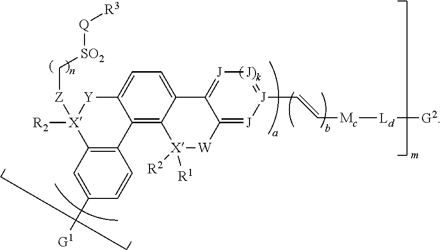

Each X′ is independently C or Si, and each of Y, Z, W, R¹, R², R³, M, L, J, G¹, G², Q, a, b, c, d, k, m, and n are as described above.

In some embodiments, the fluorescent polymer can be

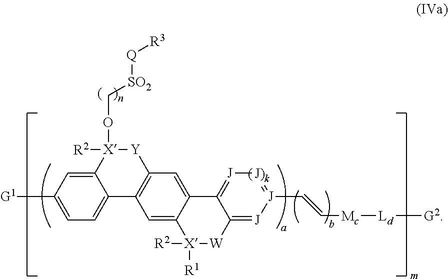

The fluorescent polymer can be

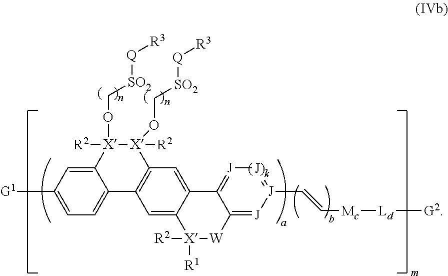

The fluorescent polymer can be

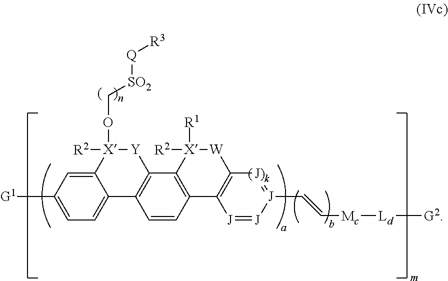

The fluorescent polymer can be

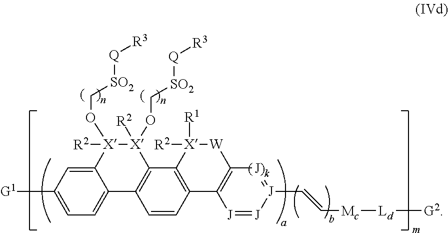

The fluorescent polymer can be

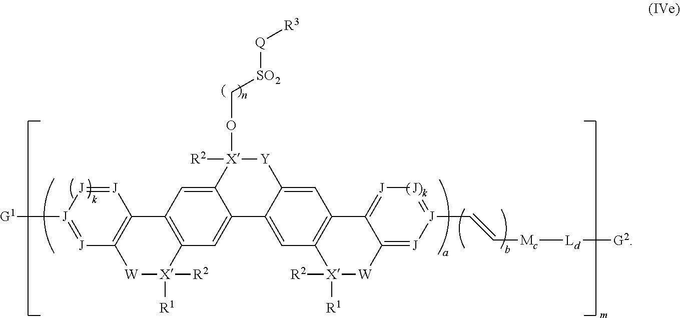

The fluorescent polymer can be

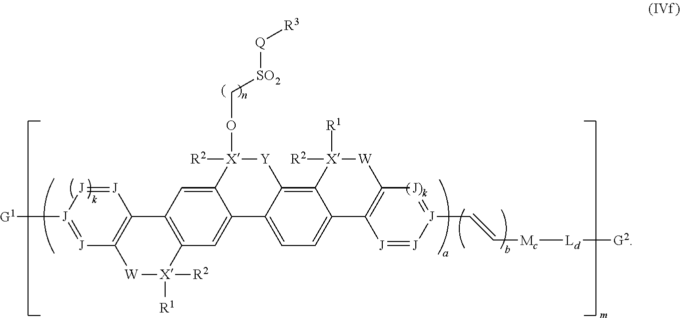

The fluorescent polymer can be

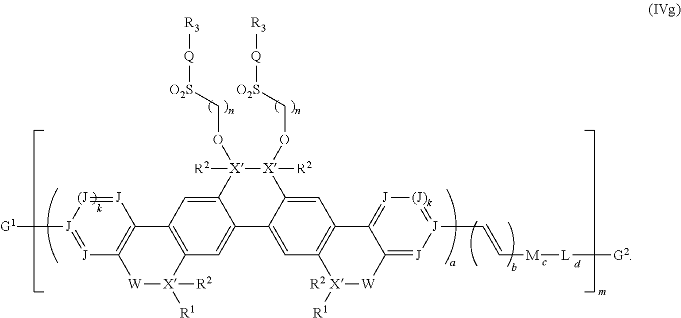

The fluorescent polymer can be

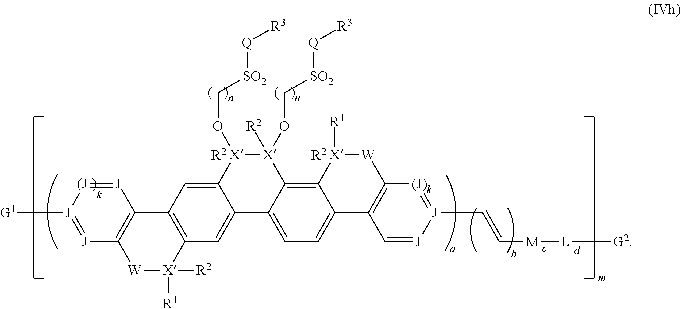

The fluorescent polymer can be

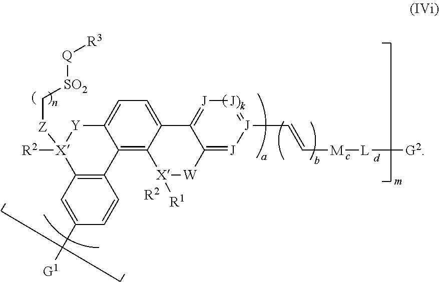

In some cases, each X′ is independently C or Si, and each of Y, Z, W, R¹, R², R³, M, L, J, G¹, G², Q, a, b, c, d, k, m, and n are as described above.

In some embodiments, the fluorescent polymer can be

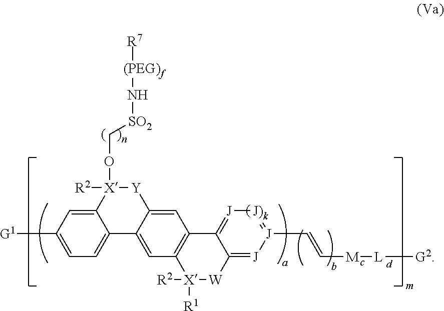

The fluorescent polymer can be

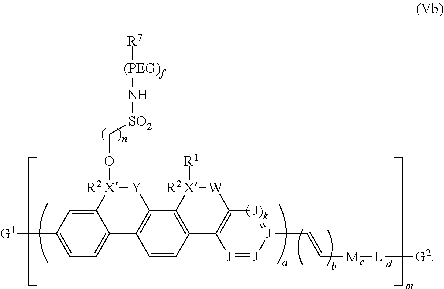

The fluorescent polymer can be

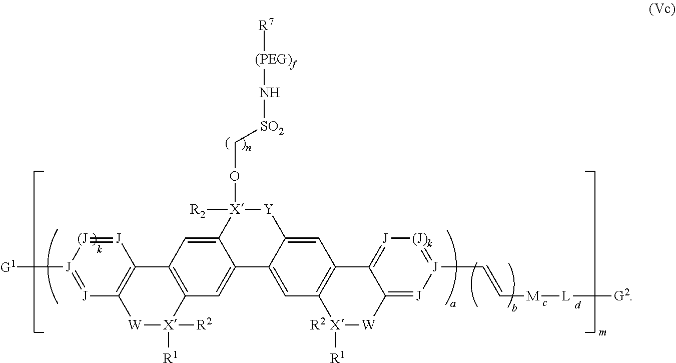

Each of X, Y, Z, W, R¹, R², M, L, J, G¹, G², a, b, c, d, f, k, m, and n are as described above.

In some embodiments, the fluorescent polymer can be

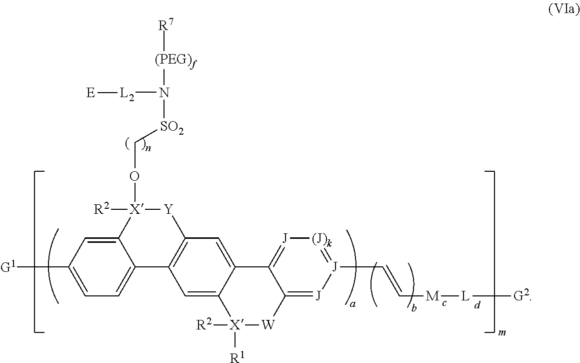

The fluorescent polymer can be

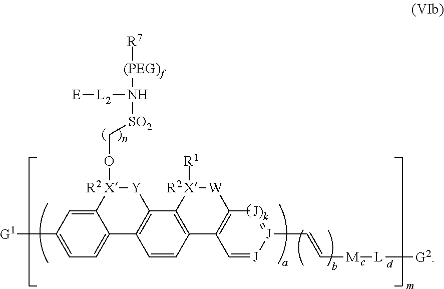

The fluorescent polymer can be

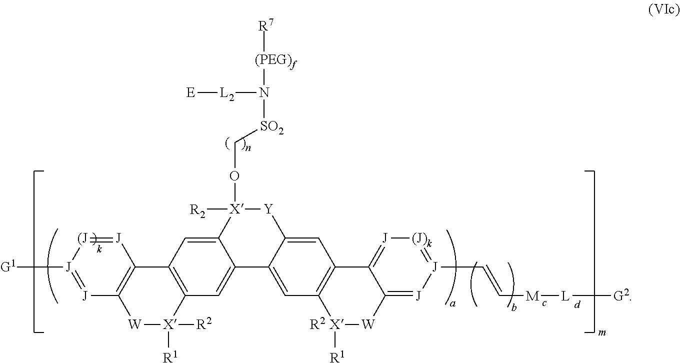

The fluorescent polymer can be

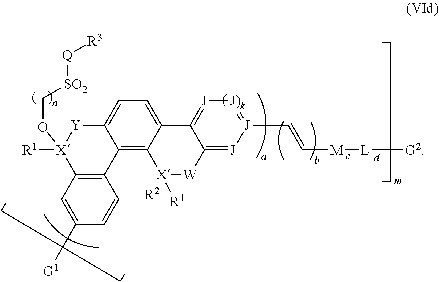

In some cases, each X′ is independently C or Si, and each of Y, Z, W, R¹, R², R³, M, L, J, G¹, G², Q, a, b, c, d, k, m, and n are as described above.

In some embodiments, the fluorescent polymer can be

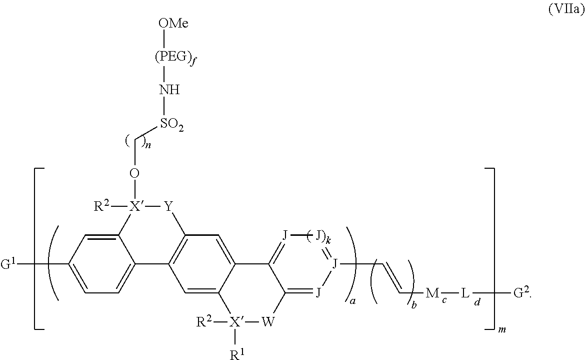

The fluorescent polymer can be

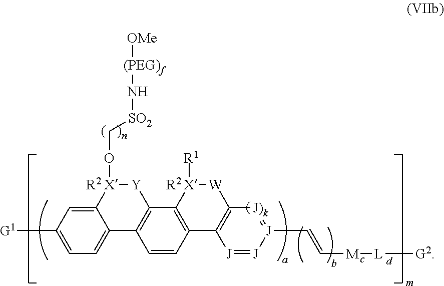

The fluorescent polymer can be

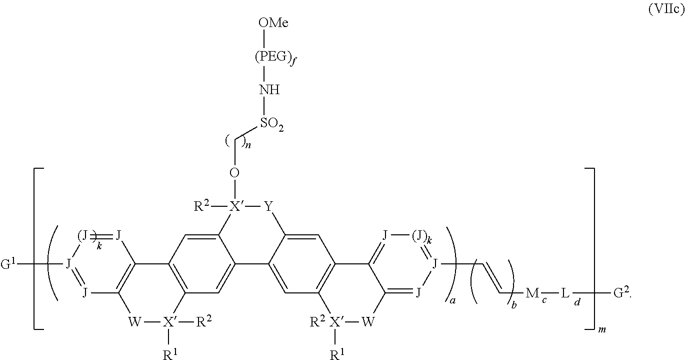

In some cases, each X′ is independently C or Si, and each of Y, Z, W, R¹, R², R³, M, L, J, G¹, G², Q, a, b, c, d, k, m, and n are as described above.

In some aspects, the present disclosure provides a fluorescent copolymer having the structure of Formula (I), wherein A comprises at least two different monomeric units selected from the group consisting of:

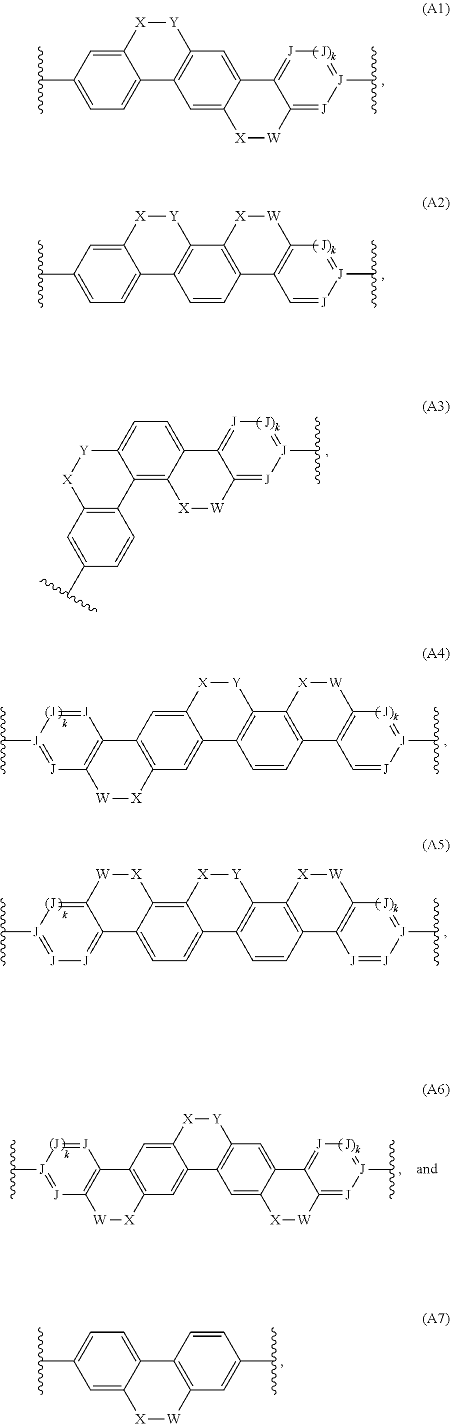

Each [symbol] in A1-A7 is a site for covalent attachment to the unsaturated backbone of the fluorescent polymer, including any other component of the polymer described in Formula (I). Each of X, W, R¹, R², M, L, G¹, G², a, b, c, d, g, and m are as described above.

In some embodiments, the fluorescent copolymer can be

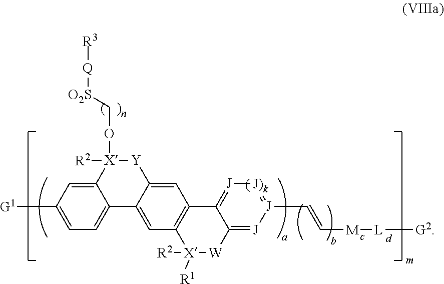

The fluorescent copolymer can be

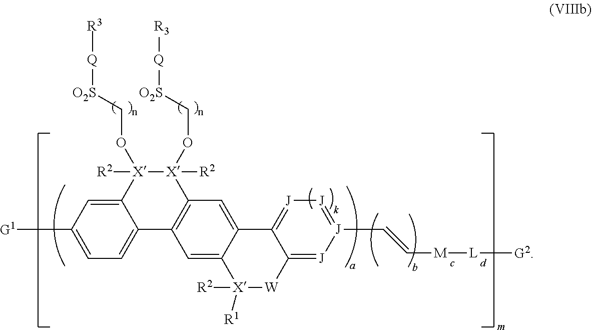

The fluorescent copolymer can be

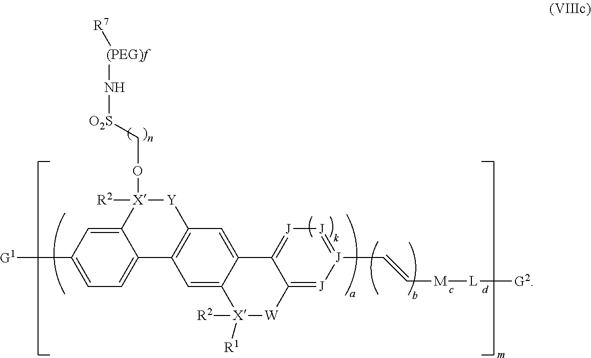

The fluorescent copolymer can be

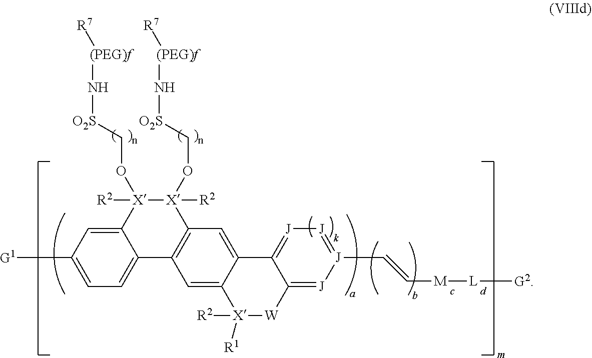

The fluorescent copolymer can be

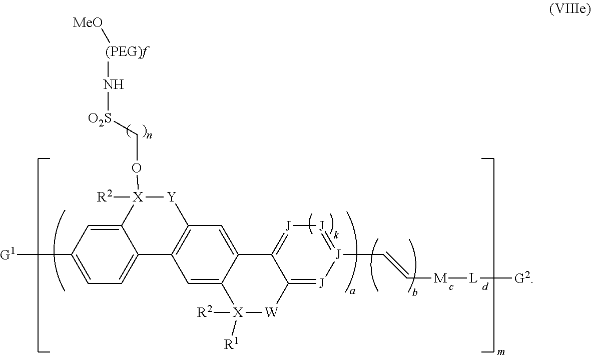

The fluorescent copolymer can be

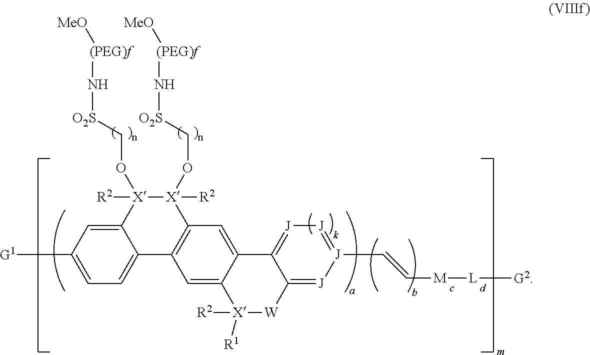

The fluorescent copolymer can be

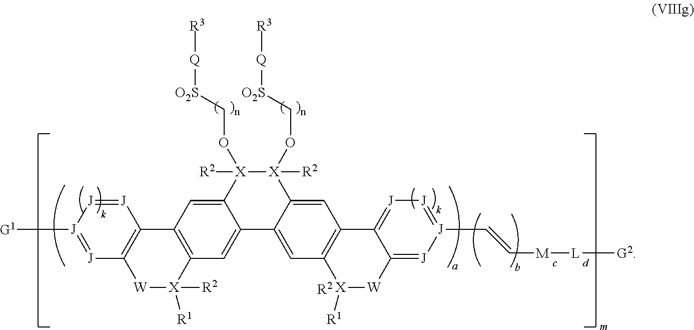

The fluorescent copolymer can be

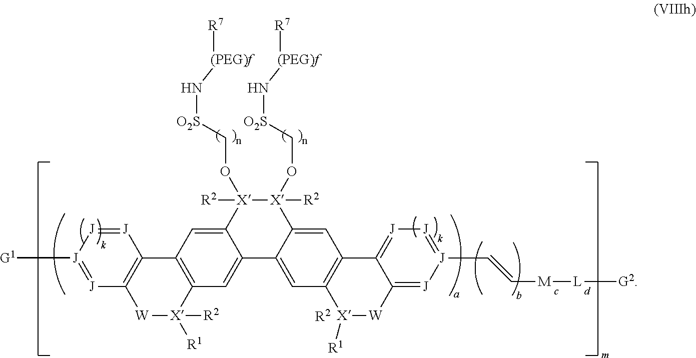

The fluorescent copolymer can be

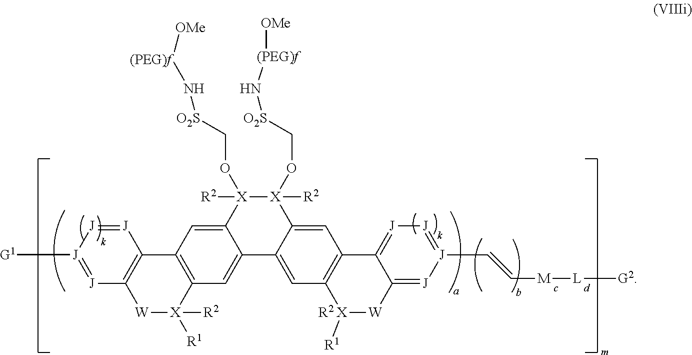

In some cases, each X′ is independently C or Si, and each of Y, Z, W, R¹, R², R³, M, L, J, G¹, G², Q, a, b, c, d, k, m, and n are as described above, and g defines the mol % of the corresponding unit within the structure which can be evenly or randomly repeated, wherein g is from 10 to 100%.

In some embodiments, the fluorescent copolymer can be

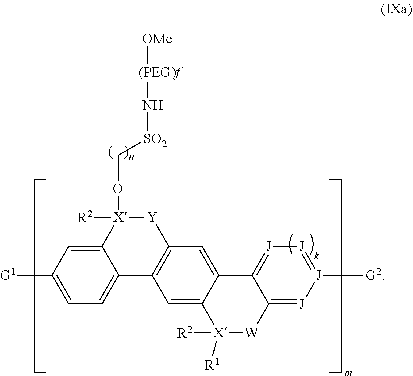

The fluorescent copolymer can be

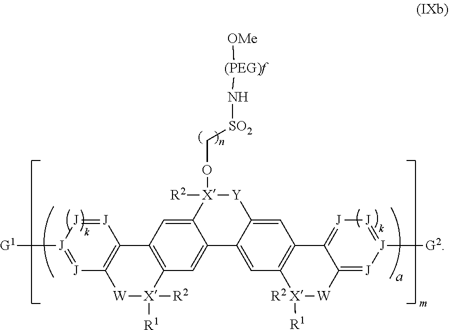

The fluorescent polymer can be

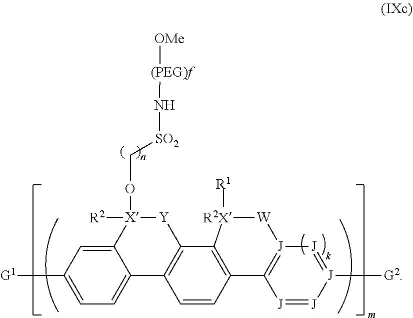

In some cases, each X′ is independently C or Si, and each of Y, Z, W, R¹, R², R³, M, L, J, G¹, G², Q, a, b, c, d, k, m, and n are as described above.

In some instances, X′ is C, W is a bond, and Y is CR¹R². In some cases, X′ is C, W is CR¹R², and Y is CR¹R².

In some embodiments, the fluorescent polymer of the present disclosure can be a fluorescent copolymer comprising a combination of polymers, wherein at least one or more of the fluorescent polymers has a structure selected from the group consisting of Formula (I), Formula (IIa), Formula (IIb), Formula (IIc), Formula (IId), Formula (IIe), Formula (IIf), Formula (IIg), Formula (IIIa), Formula (IIIb), Formula (IIIc), Formula (IIId), Formula (IIIe), Formula (IIIf), Formula (IIIg), Formula (IIIh), Formula (IIIi), Formula (IVa), Formula (IVb), Formula (IVc), Formula (IVd), Formula (IVe), Formula (IVf), Formula (IVg), Formula (IVh), Formula (IVi), Formula (Va), Formula (Vb), Formula (Vc), Formula (VIa), Formula (VIb), Formula (VIc), Formula (VId), Formula (VIe), Formula (VIf), Formula (VIg), Formula (VIj), Formula (VIIa), Formula (VIIb), Formula (VIIc), Formula (VIIIa), Formula (VIIIb), Formula (Ville), Formula (VIIId), Formula (VIIIe), Formula (VIIIf), Formula (VIIIg), Formula (VIIIh), Formula (VIIIi), Formula (IXa), Formula (IXb), Formula (IXc), Formula (Xa), Formula (Xb), Formula (Xc), Formula (Xd), Formula (Xe), and Formula (Xf).

The fluorescent polymers according to the present disclosure can additionally comprise a co-monomer known in the art. The co-monomer can be a π-conjugated co-monomer. The π-conjugated co-monomer can be selected from the group consisting of optionally substituted fluorene monomers, optionally substituted DHP monomers, optionally substituted tetrahydropyrene (THP) monomers, optionally substituted fluorenooxepine monomers, or optionally substituted benzene monomers. The co-monomer can be any monomer disclosed in WO 2017/180998A2 and U.S. Pat. Nos. 7,629,448, 8,158,444, 8,362,193, 8,575,303, 8,802,450, 8,969,509, 9,371,559, or 9,383,353, the disclosures of which are incorporated herein in their entireties.

In some embodiments, the fluorescent polymers as described herein are characterized by a minimum number average molecular weight of greater than 5,000 g/mol, greater than 10,000 g/mol, greater than 15,000 g/mol, greater than 20,000 g/mol, greater than 25,000 g/mol, greater than 30,000 g/mol, greater than 40,000 g/mol, greater than 50,000 g/mol, greater than 60,000 g/mol, greater than 70,000 g/mol, greater than 80,000 g/mol, greater than 90,000 g/mol, or greater than 100,000 g/mol.

In some embodiments, polymers as described herein are characterized by a minimum weight average molecular weight of greater than 5,000 g/mol, greater than 10,000 g/mol, greater than 15,000 g/mol, greater than 20,000 g/mol, greater than 25,000 g/mol, greater than 30,000 g/mol, greater than 40,000 g/mol, greater than 50,000 g/mol, greater than 60,000 g/mol, greater than 70,000 g/mol, greater than 80,000 g/mol, greater than 90,000 g/mol, or greater than 100,000 g/mol. Number average and weight average molecular weight values can be determined by gel permeation chromatography (GPC) using polymeric standards (e.g., polystyrene or like material).

### Monomers

The present disclosure provides monomers for making the fluorescent polymers described herein. Non-limiting examples of the monomers (or monomeric units) include:

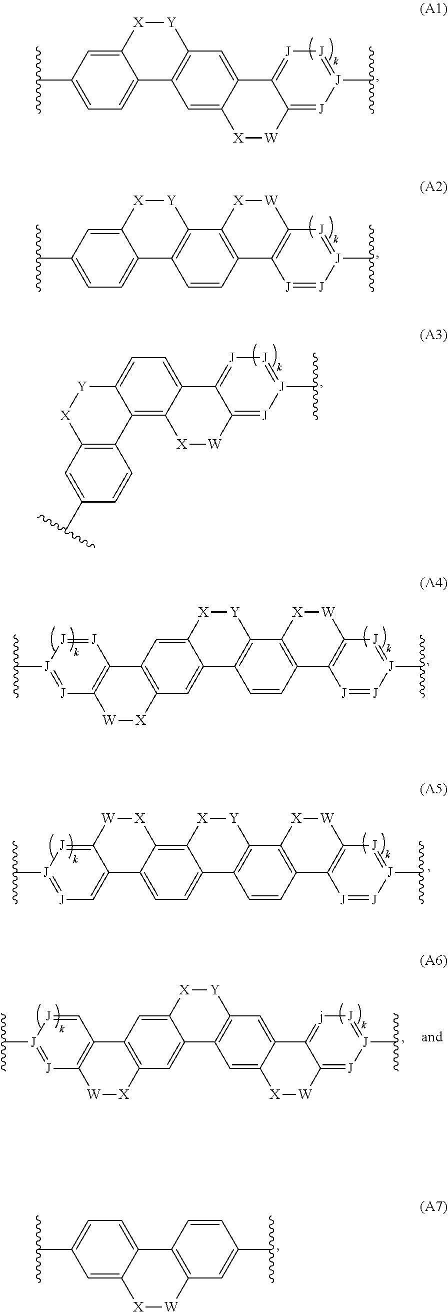

wherein [symbol] in A1-A7 is a site for covalent attachment to the unsaturated backbone of the fluorescent polymer, including any other component of the polymer described in Formula (I); and wherein each of X, Y, W, J and k, are as described above.

In some cases, R¹ is

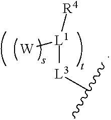

In some cases, R¹ is L^{1a}-SO₂—N(W¹)—R⁸. In some cases, R¹ is

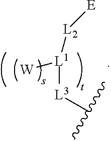

In some cases, R¹ is

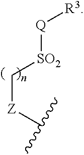

In some cases, R¹ is

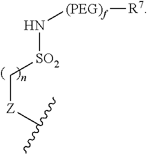

In some cases, R¹ is

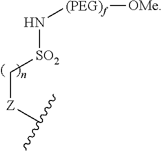

In some cases, Q is NH, R¹ is

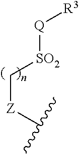

and R³ is PEG. In some cases, Q is NH, R¹ is

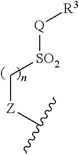

### and R¹ is

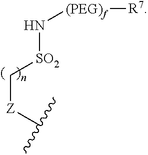

In some cases, Q is NH and R¹ is

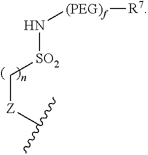

In some cases, Q is NH and R¹ is

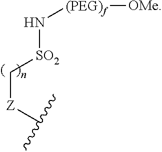

In some cases, X is CR¹R² and R¹ is

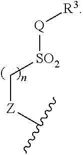

In some cases, X is CR¹R² and R¹ is

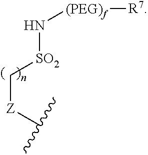

In some cases, X is CR¹R² and R¹ is

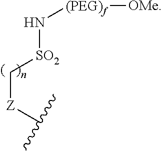

In some cases, X is CR¹R², Q is NH, R¹ is

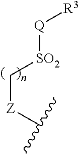

and R³ is PEG. In some cases, X is CR¹R², Q is NH, R¹ is

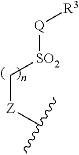

### and R³ is

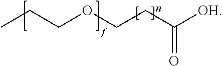

In some cases, X is CR¹R², Y is CR¹R², Q is NH, R¹ is

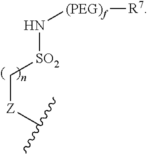

In some cases, X is CR¹R², Q is NH and R¹ is

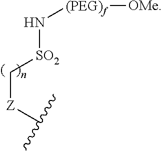

In some X is CR¹R² and Y is CR¹R². In some cases, X is CR¹R², Y is CR¹R², and R¹ is

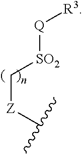

In some cases, X is CR¹R², Y is CR¹R², and R¹ is

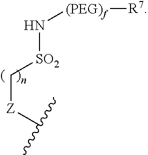

In some cases, X is CR¹R², Y is CR¹R², and R¹ is

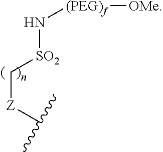

In some cases, X is CR¹R², Q is NH and R¹ is

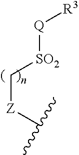

and R³ is PEG. In some cases, X is CR¹R², Y is CR¹R², Q is NH, R¹ is

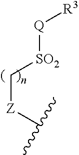

### and R³ is

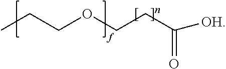

In some cases, X is CR¹R², Y is CR¹R², Q is NH and R¹ is

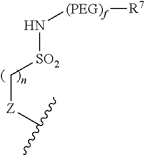

In some cases, is X is CR¹R², Y is CR¹R², Q is NH and R¹ is

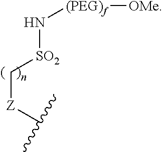

In some cases, X is CH₂, CR¹R², CHR¹, or CHR² and W is a bond, Y or CR¹R². In some cases, X is CH₂, CR¹R², CHR¹, or CHR² and W is Y. In some cases, X is CH₂, CR¹R², CHR¹, or CHR² and W is CR¹R². In some cases, X is CH₂, CR¹R², CHR¹, or CHR² and W is a bond.

In some embodiments, the fluorescent monomer of the present disclosure is water soluble.

In some embodiments, the fluorescent monomer (or monomeric units) of the present disclosure may be selected from the group consisting of:

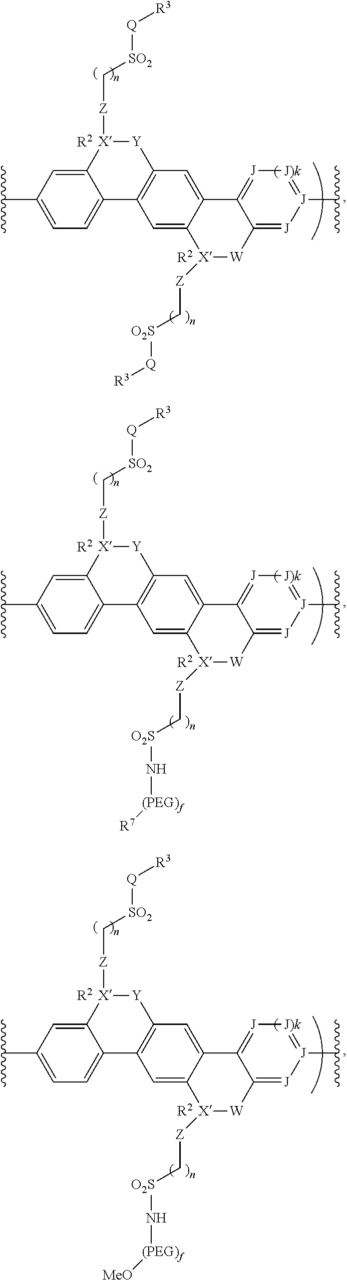

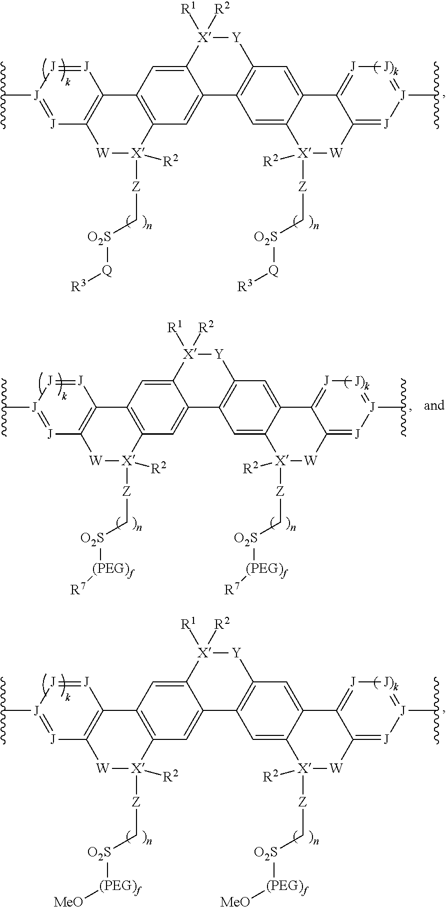

wherein X′ is C or Si, and X′, Y, W, Z, Q, J, k, R¹, R², R³, R⁷, f, k, and n are as described herein.

In some embodiments, the fluorescent monomer (or monomeric units) of the present disclosure comprises:

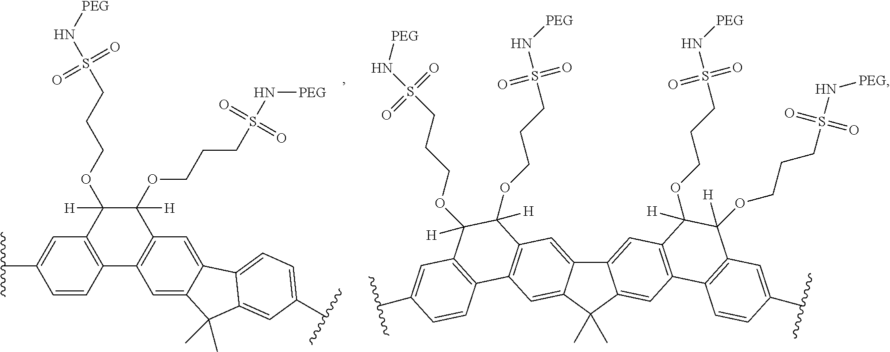

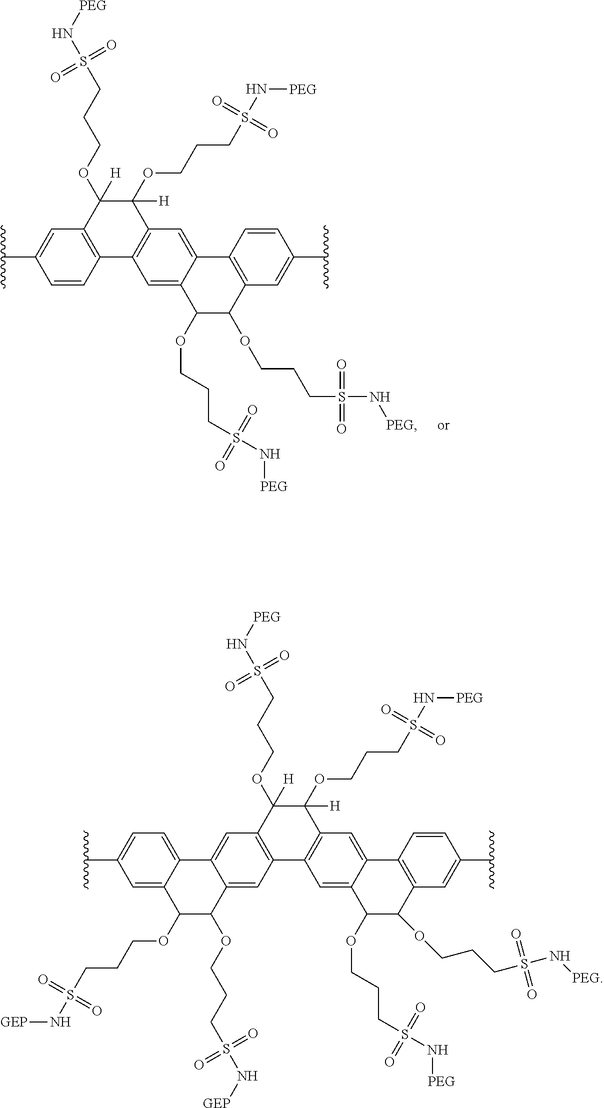

In some cases, at least one or both terminal ends of the fluorescent monomers of the present disclosure independently or both a halogen atom, boronic ester or boronic acid, silyl, diazonium salt, triflate, acetyloxy, sulfonate, or phosphate which can undergo Pd or Nickel salt catalyzed polymerization reactions.

### Synthesis

In some aspects, the present disclosure provides methods, processes, and synthetic routes for the fluorescent monomers, fluorescent polymers, and fluorescent copolymers described herein.

In one example, a fluorescent monomer (compound 8) can be prepared according to the synthetic scheme (I) shown below.

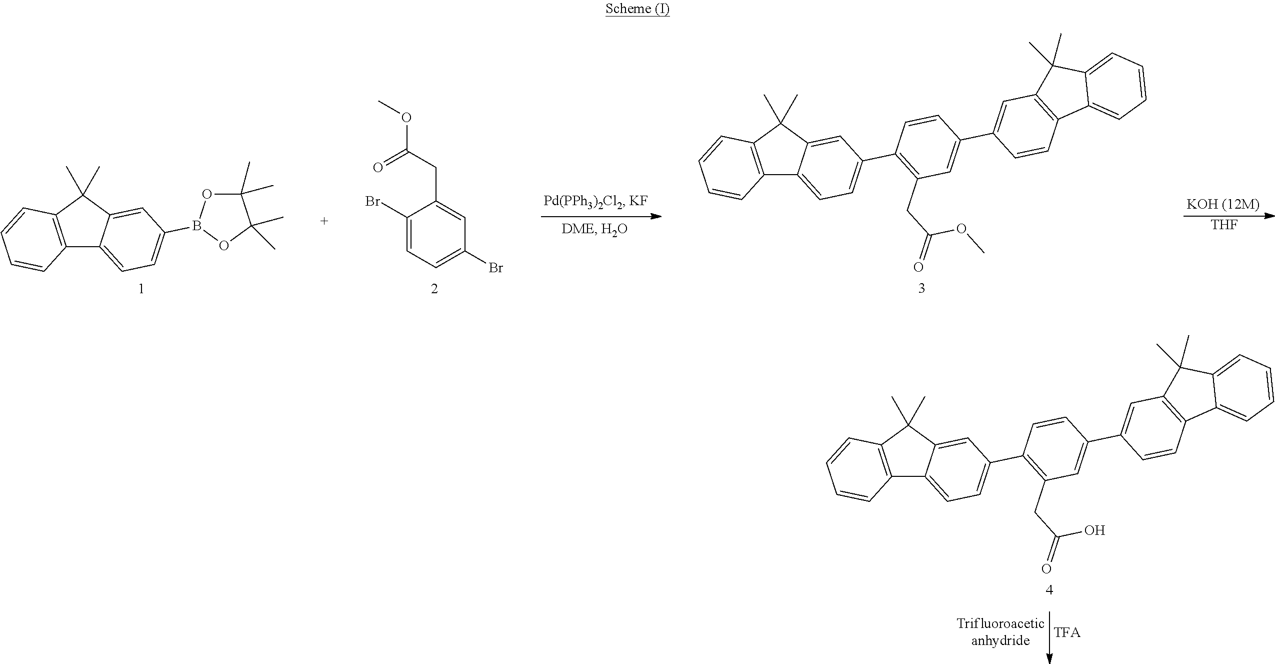

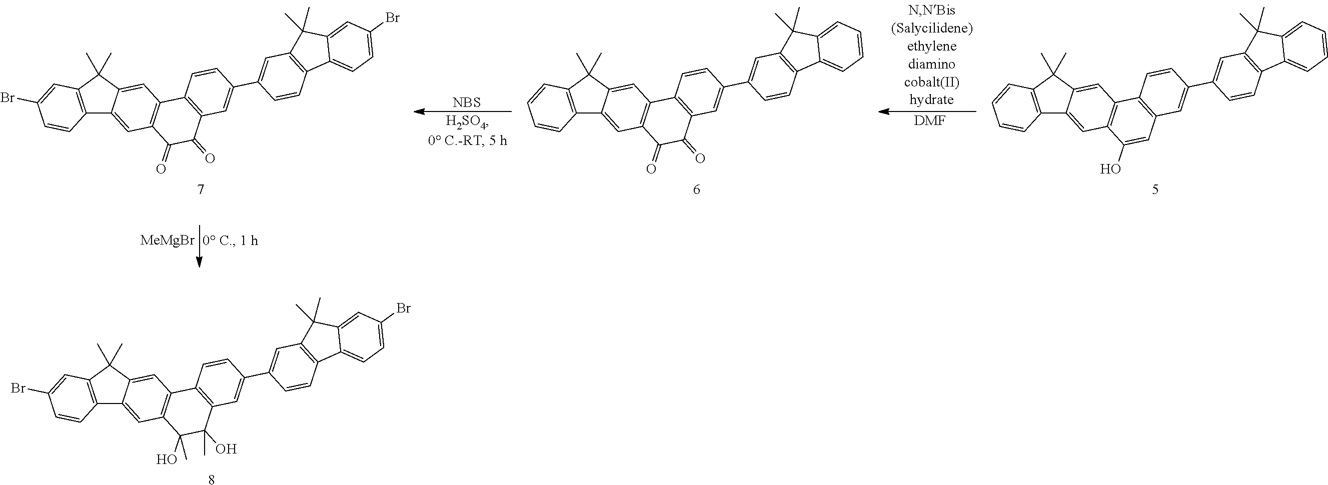

In yet another example, fluorescent monomers (compounds 24 and 25) can be prepared according to the synthetic scheme (II) shown below:

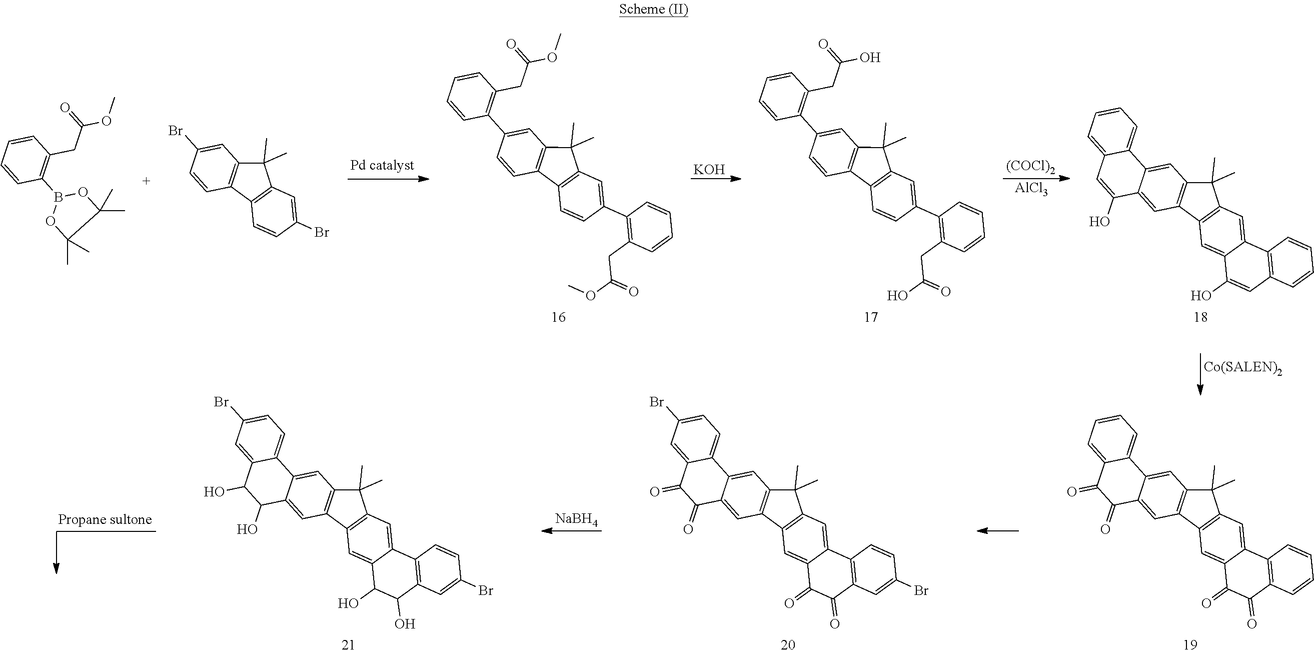

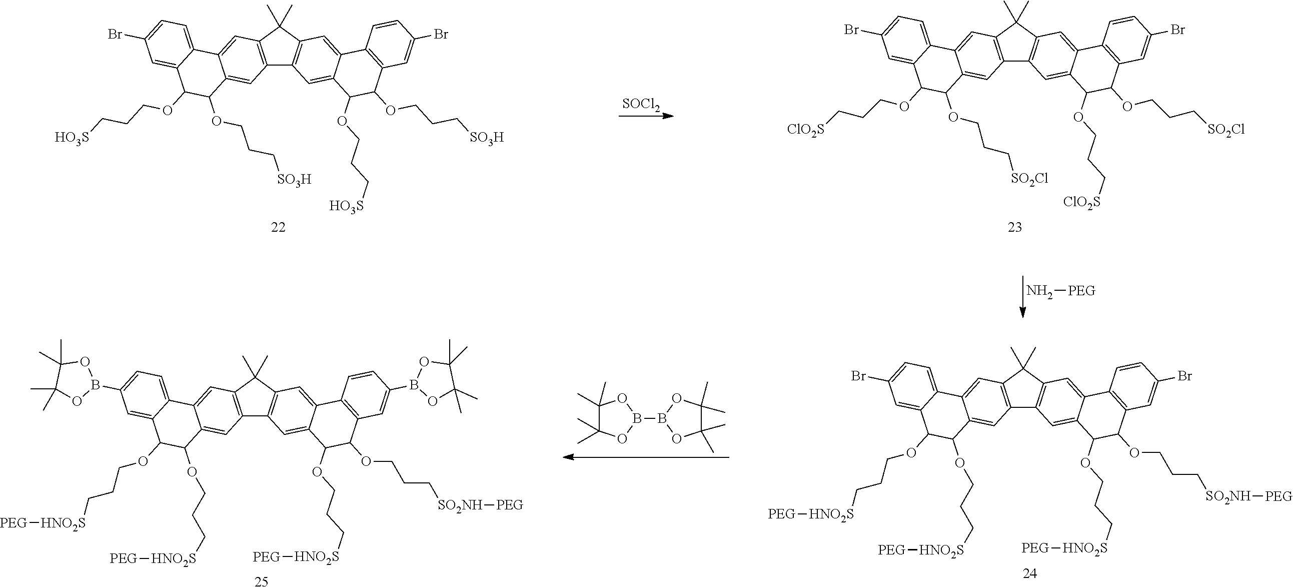

In another example, fluorescent monomers (compounds 32 and 33) can be prepared according to the synthetic scheme (III) shown below:

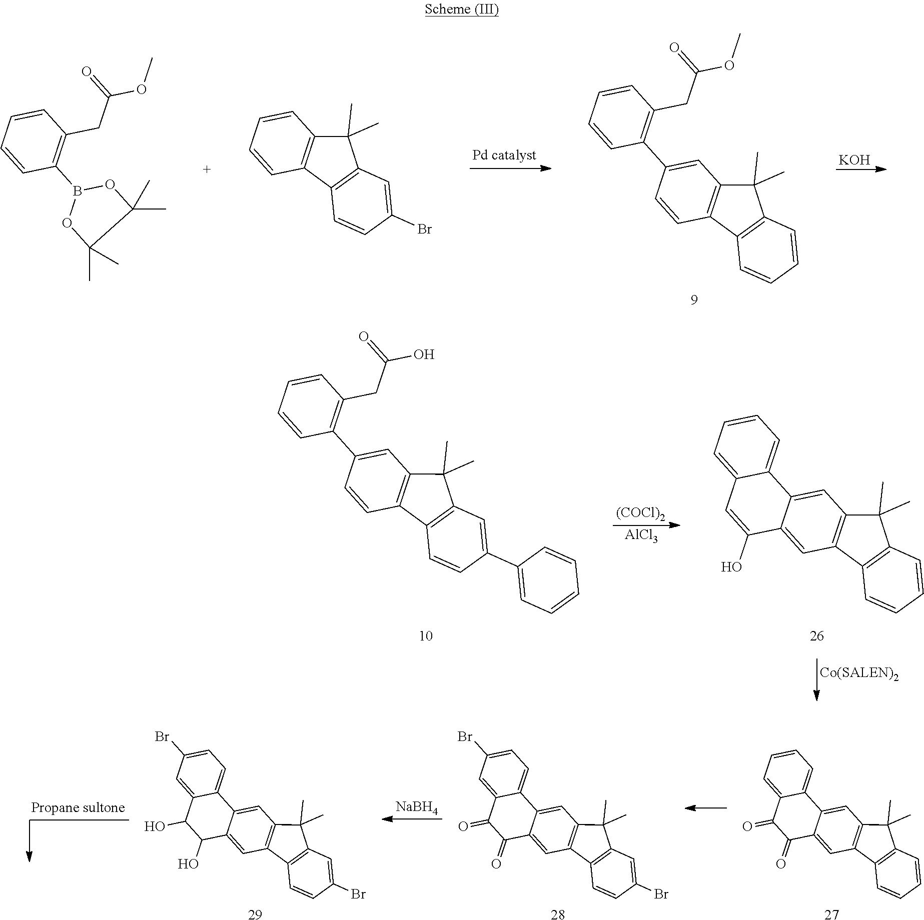

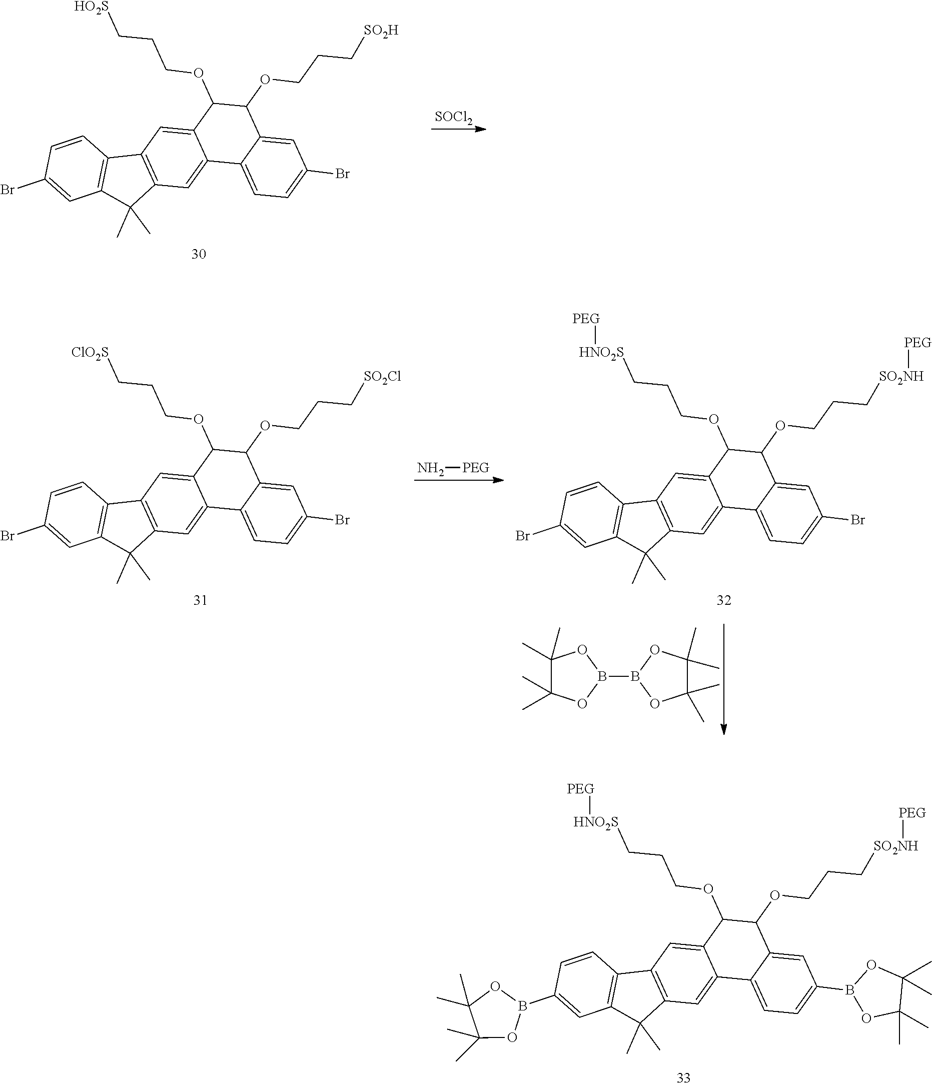

### Polymerization

The compounds described in the above embodiments may be made using procedures known in the art. In some embodiments, the fluorescent polymers can be made from fluorescent fused dihydrophenanthrene (DHP) monomers combined with modifying units or linker units. In some instances, the linker or modifying units may be electron rich. In some instances, the linker or modifying units may be electron poor. In some embodiments, bright fluorescent polymeric dyes can be made from a combination of fused DHP with any one or more of optionally substituted tetrahydropyrene (THP) monomers, optionally substituted fluorene monomers, and/or optionally substituted benzene monomers. Fluorene monomers and methods for making them are disclosed in WO 2017/180998. Optionally substituted benzene monomers are known and commercially available, for example, from Sigma Aldrich.

Synthesis of diboronic ester derivatives from a dihalide monomer can be accomplished via Suzuki coupling with bis(pinacolato) diboron according to scheme (IV) as shown below:

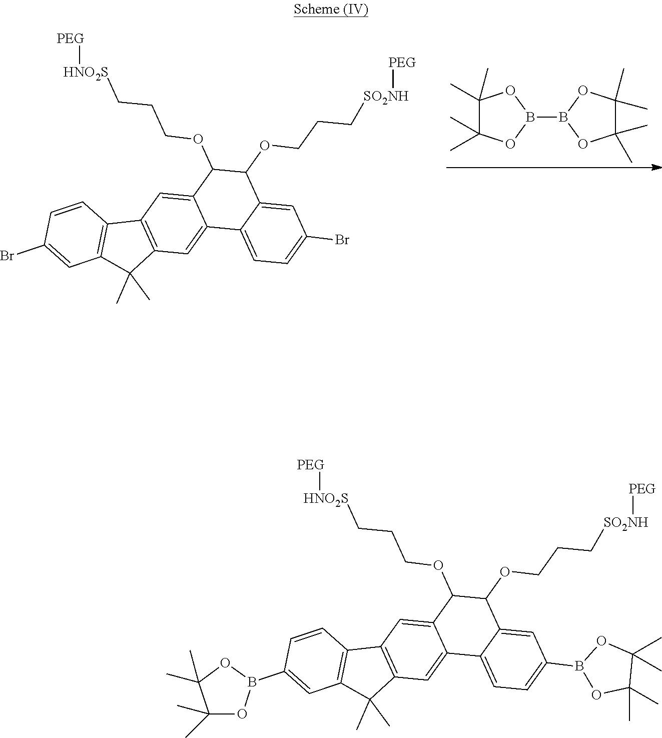

Generally, polymerization of monomer units described above can be accomplished using polymerization techniques known to those of skill in the art or using methods known in the art in combination with methods described herein. For example, polymerization can be achieved via Suzuki coupling according to scheme (V) as shown below:

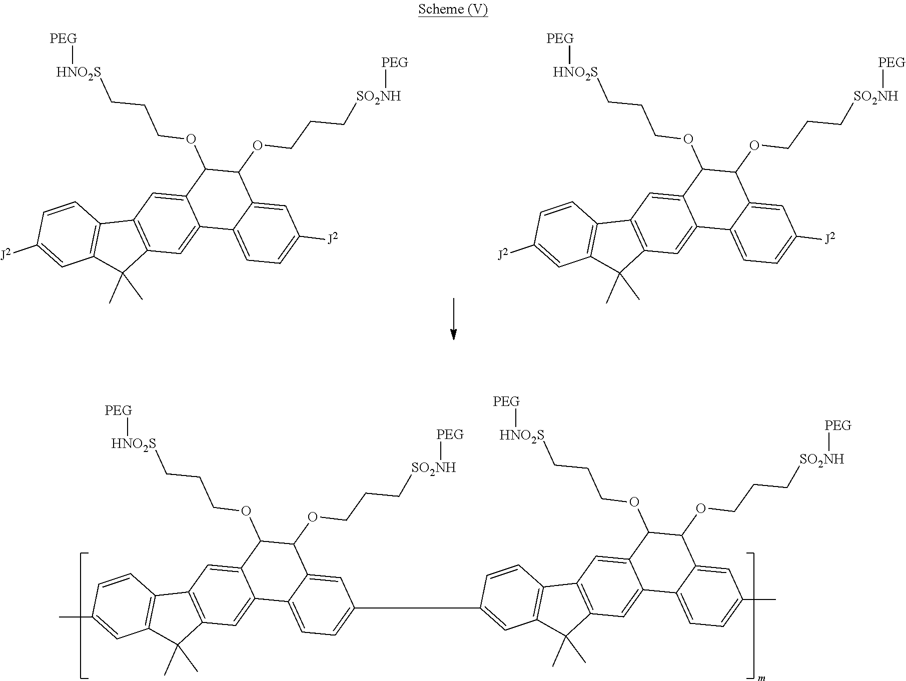

where J¹ and J² are independently H, Br, B(OH)₂, or a boronic ester.

Another non-limiting example of polymerization according to scheme (VI) is shown as below:

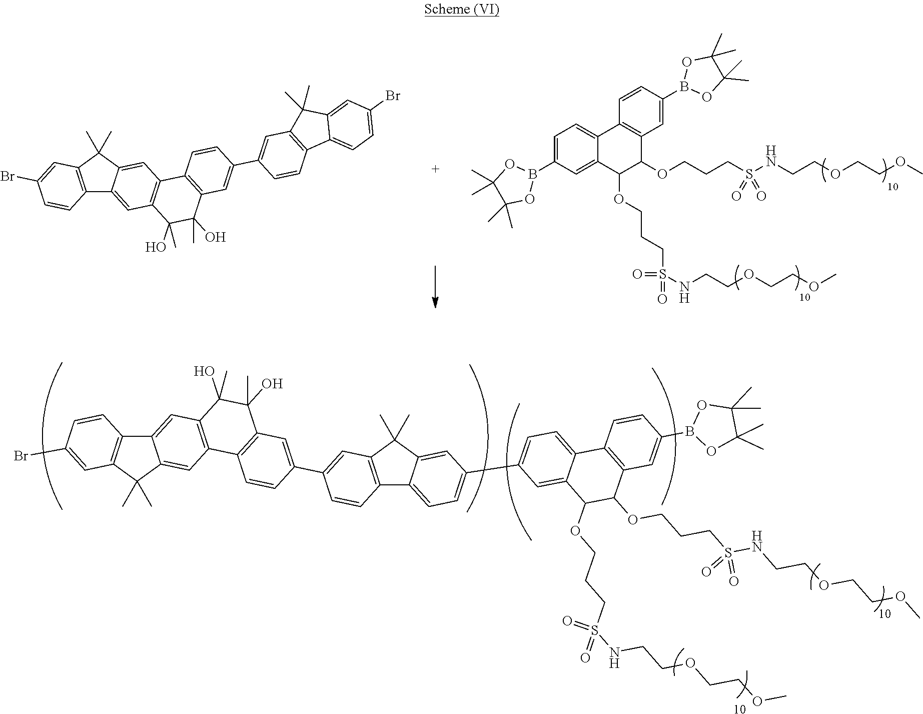

In one example, polymerization can proceed as follows. In a round bottom flask, add both the bromo and boronic monomers in (DMF-water) mixture and purge with nitrogen for 10 minutes. Under nitrogen, mix about 20 equivalent of CsF and 10% of Pd(OAc)₂ and heat at 80° C. Monitor polymerization using UV-Vis spectroscopy and SEC chromatography. Later, add a capping agent (selected from G¹) containing an appropriate functional group to the reaction mixture and 3 hours later add a second capping agent (selected from G²) to the reaction mixture. After the reaction is complete, evaporate off the crude reaction mixture and pass it through a gel filtration column to remove small organic molecules and low MW oligomers.

### Capping Units

Linkers and capping units can be conjugated to a fluorescent polymer backbone of this disclosure via similar mechanisms as described previously. For example, bromo- and boronic esters of capping units can be used to append one or both ends of a polymer. Utilizing both bromo- and boronic esters of capping units will append both ends of polymer. Utilizing only one form, either a bromo- or boronic ester of a capping unit, will append only those ends terminated with its respective complement and for symmetric polymerizations can be used to statistically modify only one end of a polymer. For asymmetric polymers this approach is used to chemically ensure the polymers are only modified at a single chain terminus. Capping units can also be appended asymmetrically by first reacting a bromo-capping unit with a polymer with Y ends and subsequently reacting the polymer with a boronic ester capping unit.

For example, capping agents of the present disclosure can be made as shown in scheme (VII):

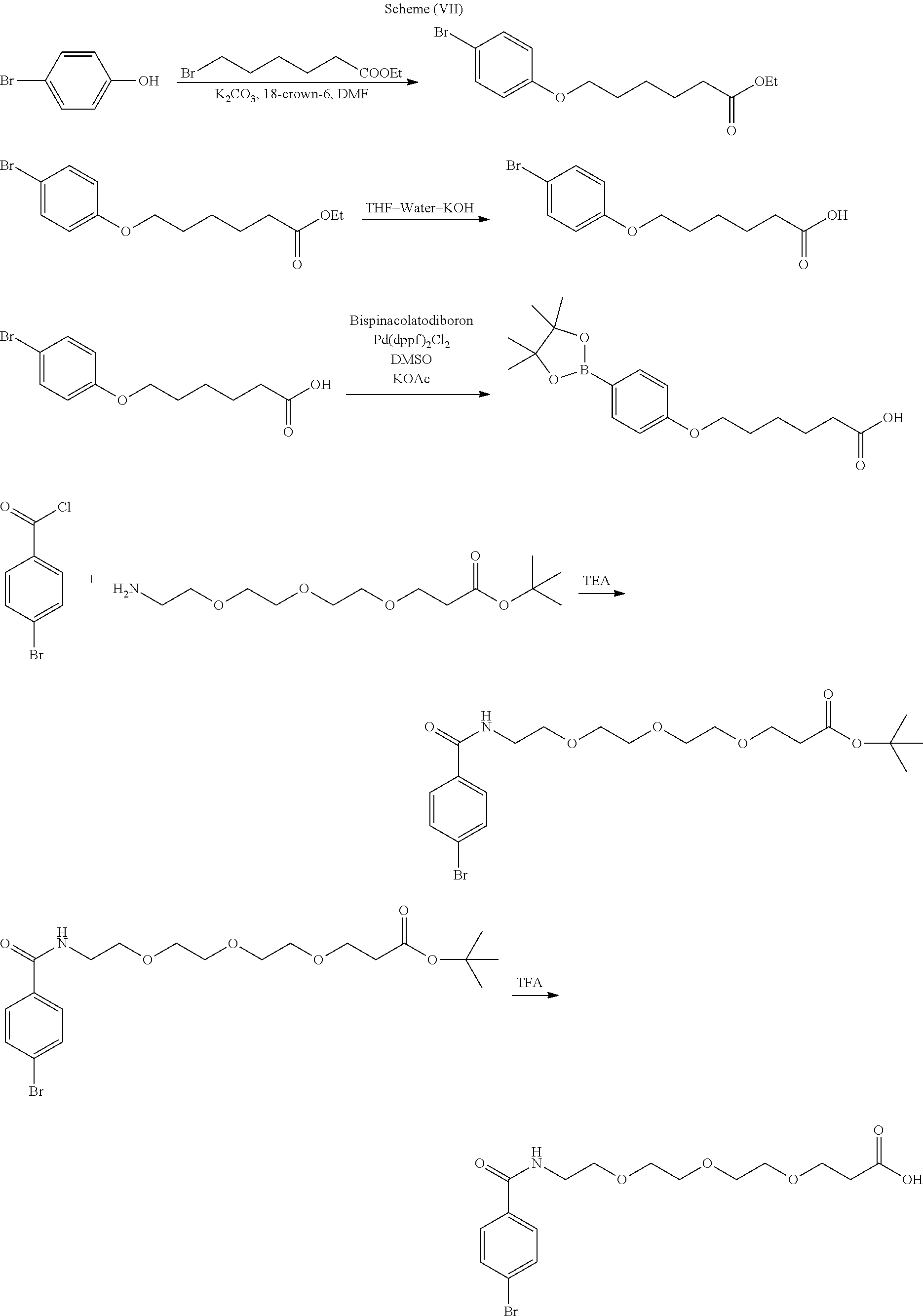

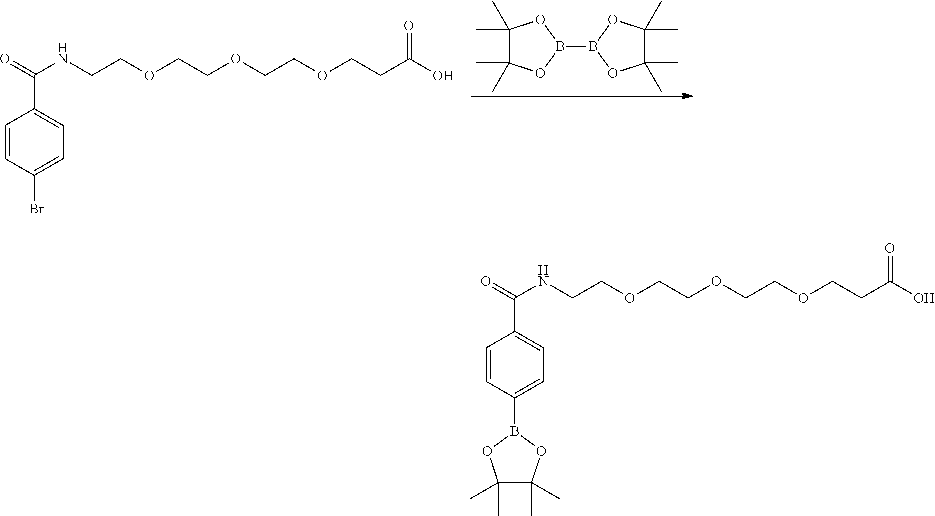

### Binding Partners

A “binding partner” or “specific binding partner” of the present disclosure can be any molecule or complex of molecules capable of specifically binding to target analyte. A binding partner of this disclosure includes, for example, proteins, small organic molecules, carbohydrates (including polysaccharides), oligonucleotides, polynucleotides, lipids, affinity ligand, antibody, antibody fragment, an aptamer and the like. In some embodiments, the binding partner is an antibody or fragment thereof. Specific binding in the context of the present disclosure refers to a binding reaction which is determinative of the presence of a target analyte in the presence of a heterogeneous population. Thus, under designated assay conditions, the specified binding partners bind preferentially to a particular protein or isoform of the particular protein and do not bind in a significant amount to other proteins or other isoforms present in the sample.

When the binding partners are antibodies, they may be monoclonal or polyclonal antibodies. The term antibody as used herein refers to immunoglobulin molecules and immunologically active portions of immunoglobulin (Ig) molecules. Such antibodies include, but are not limited to, polyclonal, monoclonal, mono-specific polyclonal antibodies, antibody mimics, chimeric, single chain, Fab, Fab′ and F(ab′)₂ fragments, Fv, and a Fab expression library.

### Complexes

In general, water-soluble fluorescent polymers of the present disclosure can be conjugated to binding partners to form a conjugated water-soluble fluorescent polymer complex using techniques known to those of skill in the art or using methods known in the art in combination with methods described herein.

In some embodiments, water-soluble fluorescent polymers of the present disclosure can be conjugated to binding partners using the method of direct modification of core polymers described in US2020/0190253, which is incorporated herein by reference in its entirety. For example, a polymer-antibody complex can be prepared according to the general scheme as shown in scheme (VIII):

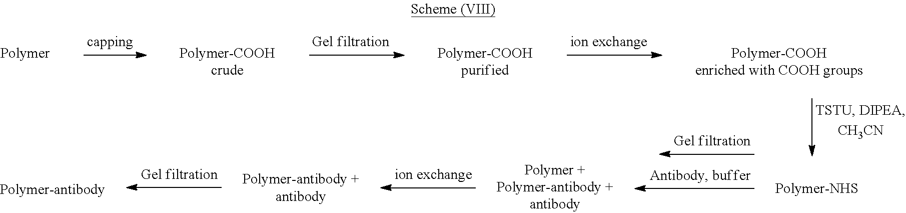

For example, preparation of polymer NHS ester can proceed as follows. Using a clean vial, dissolve 5 mg of polymer in 1 mL dry CH₃CN. To this, add 15 mg N,N,N′,N′-tetramethyl-O—(N-succinimidyl)uranium tetrafluoroborate (TSTU) and stir for 2 more minutes. To this, add 100 uL N,N-diisopropylethylamine (DIPEA) and continue stirring overnight with the cap sealed with parafilm. Later evaporate off the organic solvents in the reaction mixture. Dissolve the crude NHS in about 750 uL of 1×BBS buffer (pH 8.8) by a quick vortex and transfer it to a Zeba column 40K MWCO. Spin down the sample at 2200 RPM for 2 min and use this polymer NHS immediately.

Conjugation of polymer NHS with CD4 can proceed as follows. Take the polymer NHS in 1×BBS (^{˜}800 uL), spin down, add to 0.6 mg of CD4 and mix with 100 uL of 0.5M Borate buffer (pH 9.0). Vortex quickly for 30 seconds and allow to mix for 3-4 hours in the coulter mix.

Purification of polymer-antibody conjugate through Histrap HP column can proceed as follows. Approach 1: After the crude reaction purify the conjugate using a Histrap HP column. Load the sample using 1×PBS buffer and collect the unbound fraction. This can be done using 20 CV of buffer. Later change the buffer to wash the bound fraction which has both conjugate and free antibody. This can be done using 1×PBS with 0.25M imidazole running for 10 CV.

Approach 2: SP Sepharose FF column. Equilibrate the column and load the sample using 20 mM Citrate buffer pH 3.5 and collect the unbound fraction. This can be done using 20 CV of buffer. Later change the buffer to elute the bound fraction which has both conjugate and free antibody. This can be done using 20 mM Tris buffer pH 8.5 running for 20 CV.

Approach 3: Load the crude conjugate in a Tangential flow filtration system equipped with a 300K MWCO membrane. The conjugate is washed using 1×PBS until the filtrate show no absorption at 405 nm or 355 nm. Later the compound is concentrated.

Purification of polymer-antibody conjugate through SEC column can proceed as follows. Load the crude conjugate containing free antibody to the Size Exclusion Column, using 1×PBS. Pool the tubes after checking the absorption spectra and concentrate in an Amicon Ultra-15 having a 30 KDa MWCO centrifugal concentrator.

Purification of polymer-antibody conjugate through a Nuvia HR-S column (Bio-Rad Laboratories, Inc.) can proceed as follows. Load crude polymer-antibody conjugate mixture to the Nuvia HR-S column using a biological buffer having a pH between about 2 to about 14 and a conductivity less than 3 mS/cm. Due to charge-charge interactions between the matrix and biomolecules, the polymer antibody conjugate will bind to the resin while free polymer dye will not interact with the resin and will flow through. Disrupt the charge-charge interactions between the matrix and polymer antibody conjugate by using a salt (e.g., NaCl, KCl, phosphate etc.) at a concentration ranging from about 0.1 to 2 M. The salt concentration can be reduced by adjusting the pH of the elution buffer. For example, the conjugate can be eluted using a biological buffer and gradient of salt concentration (e.g., NaCl, KCl) between about 100 to 1000 mM at a pH of between about 6 to about 10.

Purification of conjugate through a Nuvia cPrime column (Bio-Rad Laboratories, Inc.) can proceed as follows. Load crude polymer-antibody conjugate mixture to the Nuvia cPrime column using a biological buffer having a pH between about 2 to about 14 and a salt concentration (e.g., NaCl, KCl) ranging from 0 to about 1 M. Unreacted polymers will flow through the column while the polymer-antibody conjugate will bind to the column. Elute the polymer-antibody conjugate by increasing the pH of the elution buffer. For example, the crude polymer antibody conjugate can be loaded into the Nuvia cPrime column using a biological buffer pH 5.0, 5 mM NaCl and eluted with a biological buffer pH 7.0 and gradient of salt concentration 5 to 500 mM.

Purification of conjugate through an Anti-mouse anti-H+L antibody-agarose bead can proceed as follows. Mix crude polymer-antibody conjugate mixture with anti-mouse anti-H+L antibody-agarose bead in a biological buffer having a pH between about 6 to about 8 for about 30 minutes at room temperature. The anti-mouse anti H+L antibody-agarose bead will bind to the polymer antibody conjugate. Remove unreacted polymers by washing with the above-mentioned biological buffer using a benchtop centrifuge with a speed of 300 g for 3 minutes. Repeat the washing process at least three times. To elute the polymer-antibody conjugate, apply an IgG elution buffer with a pH ranging from about 2 to about 4 to the washed antibody-agarose bead and incubate for about 10 to 15 min. Centrifuge to collect the flow through that contains the polymer antibody conjugate.

### Tandem Polymers

In some embodiments, the fluorescent polymers or water-soluble fluorescent polymers of the disclosure, and conjugates thereof, include acceptor dyes, fluorophore (FP), or chromophores (collectively referred to herein as an “signaling chromophore”) attached to the backbone. When a light source excites the polymer backbone, the acceptor dyes can absorb energy of an appropriate wavelength and emit or transfer energy.

The acceptor dye linked to the fluorescent dyes of the invention may have an absorption or emission profile with a degree of overlap with the absorption or emission profile of the fluorescent polymers of the disclosure. The fluorophore may be selected from coumarins, fluoresceins, rhodamines, cyanines, bodipys, or other polycyclic aromatics. Many fluorophores are commercially available and may be selected from but are not limited to, for example, any dye available from Beckman Coulter, Inc., including, but not limited to, SuperNova polymer dyes; any dye available from Becton Dickinson Biosciences, including, but not limited to, BD Horizon Brilliant™ polymer dyes; any dye available from ThermoFisher Scientific, including, but not limited to, Super Bright polymer dyes, and Alexa Fluor dyes, including, but not limited to, Alexa Fluor 488, Alexa Fluor 532, Alexa Fluor 546, Alexa Fluor 568, Alexa Fluor 594, Alexa Fluor 633, Alexa Fluor 647, Alexa Fluor 660, Alexa Fluor 680; ATTO 390, ATTO 465, ATTO 488, ATTO 495, ATTO 514, ATTO 532, ATTO 550, ATTO 565, ATTO 590, ATTO 594, ATTO 610, ATTO 620, ATTO 633, ATTO 647, ATTO 647N, ATTO 655, ATTO 665, ATTO 680, ATTO 700, ATTO 725, ATTO 740, 5-carboxy-2,7-dichlorofluorescein, 5-Carboxyfluorescein (5-FAM), 5-Carboxynapthofluorescein, 5-Carboxytetramethylrhodamine (5-TAMRA), 5-FAM (5-Carboxyfluorescein), 5-ROX, 6-TAMRA, 6-Carboxyrhodamine 6G, 6-CR6G, 6-JOE, 6-FAM, 6-ROX, Bodipy 492/515, Bodipy 493/503, Bodipy 500/510, Bodipy 505/515, Bodipy 530/550, Bodipy 542/563, Bodipy 558/568, Bodipy 564/570, Bodipy 576/589, Bodipy 581/591, Bodipy 630/650-X, Bodipy 650/665-X, Bodipy 665/676, Bodipy Fl, Bodipy R6G, Bodipy TMR, Bodipy TR, CF 488A, CF 555, CF 568, CF 594ST, CF 633, CF 640R, CF 647, CF 660C, CF 680, CF680R, CF 750, CF 770, CF 790, CL-NERF, CMFDA, Cy2, Cy3, Cy3.5, Cy5, Cy5.5, Cy7, DDAO, DiA, DiD, Dil, DyLight 488, DyLight 550, DyLight 594, DyLight 633, DyLight 650, DyLight 680, DyLight 755, DyLight 800, DiO, DiR, DM-NERF, DsRed, DTAF, DY-490, DY-495, DY-505, DY-530, DY-547, DY-548, DY-549, DY-549P1, DY-550, DY-554, DY-555, DY-556, DY-560, DY-590, DY-591, DY-594, DY-605, DY-610, DY-615, DY-630, DY-631, DY-632, DY-633, DY-634, DY-635, DY-636, DY-647, DY-648, DY-649, DY-649P1, DY-650, DY-651, DY-652, DY-654, DY-675, DY-676, DY-677, DY-678, DY-679, DY-679P1, DY-680, DY-681, DY-682, DY-700, DY-701, DY-703, DY-704, DY-730, DY-731, DY-732, DY-734, DY-749, DY-750, DY-751, DY-752, DY-754, DY-776, DY-777, DY-778, DY-780, DY-781, DY-782, DY-800, DY-831, Eosin, Erythrosin, FITC, Fluo-3, Fluo-4, Fluor-Ruby, FluorX, FM 1-43, FM 1-46, iFluor 488, iFluor 555, iFluor 594, iFluor 647, iFluor 680, iFluor 700, iFluor 750, iFluor 780, Lyso Tracker Green, Lyso Tracker Yellow, Mitotracker Green, Mitotracker Orange, Mitotracker Red, NBD, Oregon Green 488, Oregon Green 514, PKH26, PKH67, Resorufin, RH 414, Rhod-2, Rhodamine, Rhodamine 110, Rhodamine 123, Rhodamine 6G, Rhodamine B, Rhodamine Green, Rhodamine Red, Rose Bengal, Spectrum Green, Spectrum Orange, Spectrum Red, SYTO 11, SYTO 12, SYTO 13, SYTO 14, SYTO 15, SYTO 16, SYTO 17, SYTO 18, SYTO 20, SYTO 21, SYTO 22, SYTO 23, SYTO 24, SYTO 25, SYTO 40, SYTO 41, SYTO 42, SYTO 43, SYTO 44, SYTO 45, SYTO 59, SYTO 60, SYTO 61, SYTO 62, SYTO 63, SYTO 64, SYTO 80, SYTO 81, SYTO 82, SYTO 83, SYTO 84, SYTO 85, SYTOX Blue, SYTOX Green, SYTOX Orange, Texas Red, Tide Fluor 2 (TF2), Tide Fluor 2WS (TF2WS), Tide Fluor 3 (TF3), Tide Fluor 3WS (TF3WS), Tide Fluor 4 (TF4), Tide Fluor 5WS (TF5WS), Tide Fluor 6WS (TF6WS), Tide Fluor 7WS (TF7WS), Tide Fluor 8WS (TF8WS), TRITC, and XTRITC.

In some cases, the acceptor dyes useful in the disclosure may include, for example, a cyanine dye, a xanthene dye, a coumarin dye, a thiazine dye, an acridine dye, FITC, CY3B, Cy55, Alexa 488, Texas red, Cy5, Cy7, Alexa 750, Cy55, Cy3B, Cy3.5, Alexa 750, 800 CW, Biotium CF 555, diethyl coumarin, DY705 (Dyomics), DY431, DY485XL, DY500XL, DY610, DY640, DY654, DY 682, DY 700, DY 701, DY 704, DY 730, DY 731, DY732, DY 734, DY 752, DY 778, DY 782, DY 800, DY 831 and 800CW.

The acceptor dye may be a pendant acceptor dye. The tandem dye may be a fused DHP polymer according to the present disclosure comprising one or more, two or more, three or more, 1-30, 2-20, or 3-10 acceptor dye moieties.

For example, an acceptor dye attached to the water-soluble fluorescent polymer or water-soluble fluorescent polymer conjugate backbone can be as shown in scheme (IX).

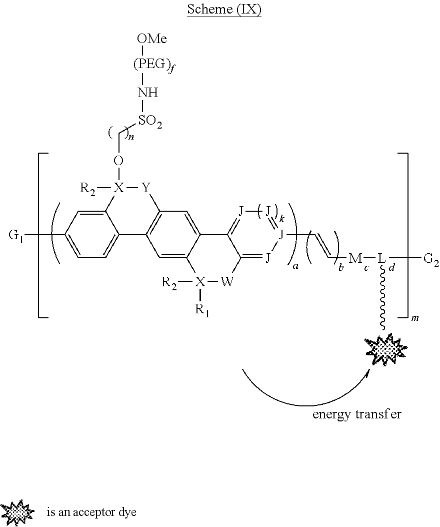

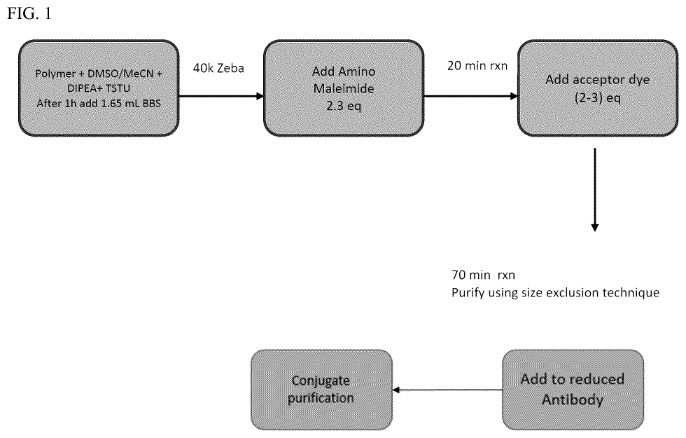

Water-soluble fluorescent tandem polymers or water-soluble fluorescent tandem polymer complexes can be prepared using techniques known to those of skill in the art or using methods known in the art in combination with methods described herein, including as shown in FIG. 1. In some embodiments, instead of being attached to a linker L in the polymer backbone, acceptor dyes, chromophores, fluorophores, functional moieties, and binding partners can be attached to polymers of the present disclosure through a linker moiety using the method of direct modification of core polymers described in US2020/0190253, which is incorporated herein by reference in its entirety.

### Kits

The disclosure provides a kit comprising at least one fluorescent polymer dye, labeled specific binding partner, or tandem dye according to the present disclosure. Aspects of the invention further include kits for use in practicing the subject methods and compositions. The compositions of the invention can be included as reagents in kits either as starting materials or provided for use in, for example, the methodologies described above.

A kit can include a fluorescent dye, fluorescent tandem dye or labeled specific binding partner as described herein and a container. Any convenient containers can be utilized, such as tubes, bottles, or wells in a multi-well strip or plate, a box, a bag, an insulated container, and the like. In some instances, the subject kits can include one or more components selected from a fluorescent polymer dye according to the disclosure, fluorescent tandem polymer dye accordingly to the disclosure, a fluorophore, a chromophore, a specific binding partner, a labeled specific binding partner according to the disclosure, a support bound specific binding member, a cell, a support, a biocompatible aqueous elution buffer, and instructions for use. In some embodiments of the kit, the fluorescent polymer dye or fluorescent polymer dye according to the disclosure is covalently linked to a specific binding partner.

In some instances, the subject kits can be a “labeling kit” that include a fluorescent polymer dye or fluorescent tandem polymer dye according to the disclosure comprising a sidechain chemoselective functional group such as a Dye-NHS ester and the like (also referred to as a conjugation tag) to which any convenient target moiety of interest (e.g., a donor or acceptor dye, fluorophore, chromophore, a specific binding partner, a support) can be conjugated. The chemoselective functional group may include a reactive group (e.g., biotin) that targets specific functional groups on biomolecules (e.g., proteins or antibodies), such as, for example, primary amines, sulfhydryls, carboxyls, or carbohydrates. The chemoselective functional group can be one used in “click chemistry” reactions.

In certain instances, the conjugation tag includes a maleimide functional group and the target moiety includes a thiol functional group, or vice versa. In some instances, the conjugation tag includes an alkyne (e.g., a cyclooctyne group) functional group and the target moiety includes an azide functional group, or vice versa, which can be conjugated via Click chemistry. In certain instances, the conjugation tag includes an alkene (e.g., a cyclooctene group) functional group and the target moiety includes a tetrazine functional group, or vice versa, which can be conjugated via inverse-demand Diels-Alder cycloaddition reaction. In some instances, the conjugation tag includes an amine-reactive chemical group, such as, for example, a NHS ester (N-hydroxysuccinimde esters) or imidoester functional group and the target moiety includes a NH₂ functional group, or vice versa. In some instances, the conjugation tag includes a biotin-binding protein (e.g., Avidin, Streptavidin, or NeutrAvidin) and the target moiety includes a biotin molecule, or vice versa, which can non-covalently interact.

### IV. Methods of Detecting an Analyte

### Overview

The polymer and tandem polymers of the disclosure can be conjugated to biomolecules (i.e., specific binding partners) due to having functional groups. The conjugates can be used in a large number of different applications or methods including, but not limited to, flow cytometry, fluorescence activated sorting, immunofluorescence, immunohistochemistry, fluorescence multiplexing, single molecule imaging, single particle tracking, protein folding, protein rotational dynamics, DNA and gene analysis, protein analysis, metabolite analysis, lipid analysis, FRET based sensors, high throughput screening, cellular imaging, in vivo imaging, fluorescence-based biological assays such as immunoassays and enzyme-based assays, and a variety of fluorescence techniques in biological assays and measurements.

In some aspects, the present disclosure provides a method for detecting an analyte in a sample, the method comprising:
providing a sample that is suspected of containing an analyte; and
contacting the sample with a binding partner conjugated to a fluorescent polymer or tandem polymer of the present disclosure, wherein the binding partner is capable of interacting with the analyte.

A light source is applied to the sample that can excite the water-soluble fluorescent polymer; and light emitted from the conjugated water-soluble fluorescent polymer complex is detected. In the typical assay, water-soluble fluorescent polymers of the present disclosure are excitable with a light having wavelength between about 395 nm and about 415 nm and the emitted light is typically between about 415 nm and about 475 nm. Alternatively, excitation light can have a wavelength between about 340 nm and about 380 nm and the emitted light can have a wavelength between about 390 nm and about 430 nm. While the fluorescent polymers of the present disclosure have a violet excitation spectrum, one of skill in the art will understand that the spectrum can be tuned to the blue, UV or another laser if the polymers are copolymerized with appropriate modifying units.

In the method of the present disclosure, the fluorescent polymer can be any water-soluble fluorescent polymer of the present disclosure as disclosed herein. The fluorescent polymer can have the structure of Formula (I). The fluorescent polymer can have the structure of any one or more of Formula (IIa), Formula (IIb), Formula (IIc), Formula (IId), Formula (IIe), Formula (IIf), Formula (IIg), Formula (IIIa), Formula (IIIb), Formula (IIIc), Formula (IIId), Formula (IIIe), Formula (IIIf), Formula (IIg), Formula (IIIh), Formula (IIIi), Formula (IVa), Formula (IVb), Formula (IVc), Formula (IVd), Formula (IVe), Formula (IVf), Formula (IVg), Formula (IVh), Formula (IVi), Formula (VIj), Formula (Va), Formula (Vb), Formula (Vc), Formula (VIa), Formula (VIb), Formula (VIc), Formula (VId), Formula (VIg), Formula (VIh), Formula (VIIa), Formula (VIIb), Formula (VIIc), Formula (VIIIa), Formula (VIIIb), Formula (VIIIc), Formula (VIIId), Formula (VIIIe), Formula (VIIIf), Formula (VIIIg), Formula (VIIIh), Formula (VIIIi), Formula (IXa), Formula (IXb), Formula (IXc), Formula (Xa), Formula (Xb), Formula (Xc), Formula (Xd), Formula (Xe), Formula (Xf), Formula (XIa), Formula (XIb), Formula (XIb), Formula (XId), Formula (XIe), Formula (XIf), Formula (XIg), and Formula (XIh).

In the method of the present disclosure, the fluorescent polymer can also be fluorescent copolymer comprising: (1) at least one fluorescent polymer having a structure selected from the group comprising of Formula (I), Formula (IIa), Formula (IIb), Formula (IIc), Formula (IId), Formula (IIe), Formula (IIf), Formula (IIg), Formula (IIIa), Formula (IIIb), Formula (IIIc), Formula (IIId), Formula (IIIe), Formula (IIIf), Formula (Mg), Formula (IIIh), Formula (IIIi), Formula (IVa), Formula (IVb), Formula (IVc), Formula (IVd), Formula (IVe), Formula (IVf), Formula (Va), Formula (Vb), Formula (Vc), Formula (VIa), Formula (VIb), Formula (VIc), Formula (VId), Formula (VIg), Formula (VIh), Formula (VIIa), Formula (VIIb), Formula (VIIc), Formula (VIIIa), Formula (VIIIb), Formula (VIIIe), Formula (VIIId), Formula (VIIIe), Formula (VIIIf), Formula (VIIIg), Formula (VIIIh), Formula (VIIIi), Formula (IXa), Formula (IXb), Formula (IXc), Formula (Xa), Formula (Xb), Formula (Xc), Formula (Xd), Formula (Xe), Formula (Xf), Formula (XIa), Formula (XIb), Formula (XIb), Formula (XId), Formula (XIe), Formula (XIf), Formula (XIg), and Formula (XIh), as disclosed herein; and (2) a π-conjugated co-monomer in the repeating unit. The π-substituted comonomer can be an optionally substituted fluorene monomer. The π-substituted comonomer can be an optionally substituted dihydrophenanthrene (DHP) monomer. The π-substituted comonomer can be an optionally substituted tetrahydropyrene (THP) monomer. The π-substituted comonomer can be an optionally substituted benzene monomer. The optionally substituted fluorene structures can be those disclosed in WO 2017/180998A2.

### Samples

The sample in the methods of the present disclosure can be, for example, blood, bone marrow, spleen cells, lymph cells, bone marrow aspirates (or any cells obtained from bone marrow), urine (lavage), serum, saliva, cerebral spinal fluid, urine, amniotic fluid, interstitial fluid, feces, mucus, or tissue (e.g., tumor samples, disaggregated tissue, disaggregated solid tumor). In certain embodiments, the sample is a blood sample. In some embodiments, the blood sample is whole blood. The whole blood can be obtained from the subject using standard clinical procedures. In some embodiments, the sample is a subset of one or more cells of whole blood (e.g., erythrocyte, leukocyte, lymphocyte (e.g., T cells, B cells or NK cells), phagocyte, monocyte, macrophage, granulocyte, basophil, neutrophil, eosinophil, platelet, or any cell with one or more detectable markers). In some embodiments, the sample can be from a cell culture.

The subject can be a human (e.g., a patient suffering from a disease), a commercially significant mammal, including, for example, a monkey, cow, or horse. Samples can also be obtained from household pets, including, for example, a dog or cat. In some embodiments, the subject is a laboratory animal used as an animal model of disease or for drug screening, for example, a mouse, a rat, a rabbit, or guinea pig.

### Analytes

An “analyte” as used herein, refers to a substance, e.g., molecule, whose abundance/concentration is determined by some analytical procedure. For example, in the present disclosure, an analyte can be a protein, peptide, nucleic acid, lipid, carbohydrate small molecule, or a target-associated biomolecule.

The target analyte may be, for example, nucleic acids (DNA, RNA, mRNA, tRNA, or rRNA), peptides, polypeptides, proteins, lipids, ions, monosaccharides, oligosaccharides, polysaccharides, lipoproteins, glycoproteins, glycolipids, or fragments thereof. In some embodiments, the target analyte is a protein and can be, for example, a structural microfilament, microtubule, and intermediate filament proteins, organelle-specific markers, proteasomes, transmembrane proteins, surface receptors, nuclear pore proteins, protein/peptide translocases, protein folding chaperones, signaling scaffolds, ion channels and the like. The protein can be an activatable protein or a protein differentially expressed or activated in diseased or aberrant cells, including but not limited to transcription factors, DNA and/or RNA-binding and modifying proteins, nuclear import and export receptors, regulators of apoptosis or survival and the like.

### Assays

Assay systems utilizing a binding partner and a fluorescent label to quantify bound molecules are well known. Examples of such systems include flow cytometers, scanning cytometers, imaging cytometers, fluorescence microscopes, and confocal fluorescent microscopes.

In some embodiments, flow cytometry is used to detect fluorescence. A number of devices suitable for this use are available and known to those skilled in the art. Examples include BCI Navios, Gallios, Aquios, and CytoFLEX flow cytometers.

In other embodiments, an assay is used. The assay can be an immunoassay. Examples of immunoassays useful in the disclosure include, but are not limited to, fluoroluminescence assay (FLA), and the like. The assays can also be carried out on protein arrays.

When the binding partners are antibodies, antibody or multiple antibody sandwich assays can also be used. A sandwich assay refers to the use of successive recognition events to build up layers of various binding partners and reporting elements to signal the presence of a particular analyte. Examples of sandwich assays are disclosed in U.S. Pat. No. 4,486,530 and in the references noted therein.

### V. Examples

### Example 1: Preparation of Fused DHP Fluorescent Monomer

A fused DHP monomer (compound 8) was prepared according to Scheme (I) as described above.

Synthesis of Methyl 2-(2,5-bis(9,9-dimethyl-9H fluorene-2 yl) phenyl) acetate (compound 3): 2.25 g of 2-(9,9-dimethyl-9H-fluorene-2-yl)-4,4,5,5-tetramethyl-1,3,2-dioxaborolane 1, (7.01 mmol) and 0.8 g of methyl 2-(2,5-dibromophenyl) acetate 2 (2.6 mmol) were dissolved in 20 mL DME in 100 mL RBF and then 3.0 g of KF (52 mmol) dissolved in 20 mL water were added. The mixture was purged with N₂ for 5 minutes then 219 mg of Pd (PPh₃)₂Cl₂ (0.31 mmol) dissolved in 1 ml of DME was added. The reaction mixture was then placed in an oil bath with a condenser for 19 hours at 82° C. The reaction mixture was cooled down to room temperature and filtered through a celite bed. The solvents were evaporated, and the residue was purified by column chromatography eluting with a gradient composed of Ethyl acetate/Hexane using a medium-size silica column with a Yamazen automated system. The fractions containing the product were combined to afford 0.43 g of white solid (31%, MW=534.7). Purity was confirmed by ¹H-NMR spectroscopy. 1H NMR (500 MZ, CDCl₃); δ=1.53 (s, 6H), 1.56 (s, 6H), 3.66 (s, 3H), 3.75 (s, 2H), 7.32-7.38 (m, 5H), 7.44-7.47 (m, 4H), 7.63-7.69 (m, 4H), 7.76-7.81 (m, 4H).

Synthesis of 2-(2,5-bis(9,9-dimethyl-9H fluorene-2 yl) phenyl) acetic acid (compound 4): 0.42 g of Methyl 2-(2,5-bis(9,9-dimethyl-9H-fluorene-2-yl) phenyl) acetate 3 (0.785 mmol) was dissolved in 10 mL of THE in a 100 mL RBF fitted with condenser. Added 8 mL of KOH (12M) to the reaction mixture and stirred the reaction mixture at 75° C.; for 19 hours. The reaction mixture was cooled down to room temperature and added 100 mL (2M) HCl solution and partitioned with CHCl₃ X 3. The CHCl₃ layer was separated and dried with sodium sulfate. The solvents were evaporated to get 0.405 g of a white solid (99%, MW=520.7). Purity was confirmed by ¹H-NMR spectroscopy. 1H NMR (500 MZ, DMSO); δ=1.48 (s, 6H), 1.53 (s, 6H), 3.67 (s, 2H), 7.32-7.39 (m, 5H), 7.43 (d, J=8 Hz, 1H), 7.53 (br s, 1H), 7.58 (dt, J=2 & 6.76 Hz, 2H), 7.72 (ddd, J=2, 8 & 18 Hz, 2H), 7.78 (d, J=2 Hz, 1H), 7.88 (dt, J=2 & 7 Hz, 2H), 7.9-7.94 (m, 3H).

Synthesis of 3-(9,9-dimethyl-9H fluorene-2-yl)-12,12-dimethyl-12H-indeno[1,2-b]phenanthrene-6-ol (compound 5): To the 0.4 g of carboxylic acid 4 (0.768 mmol) taken in a 25 mL RBF added 8 mL trifluoroacetic anhydride and cooled down the reaction mixture to 0° C. Slowly added 2 mL trifluoroacetic acid and stirred the reaction mixture for 15 mins at room temperature. The reaction mixture was then placed in an oil bath with a condenser for 19 hours at 70° C. The reaction mixture was decomposed with crushed ice and extracted with CHCl₃ thoroughly. The organic layer was washed with cold aq. NaHCO₃ solution, cold brine solution, and dried (anhyd. Na₂SO4). The solvents were evaporated, and the residue was purified by column chromatography eluting with a gradient composed of Ethyl acetate/Hexane using a medium-size silica column with a Yamazen automated system. The fractions containing the product were combined to afford 0.3 g of orange solid (78%, MW=502.2). Purity was confirmed by ¹H-NMR spectroscopy. 1H NMR (500 MZ, CDCl₃); 1H NMR (500 MZ, DMSO); δ=1.54 (s, 6H), 1.66 (s, 6H), 7.34-7.40 (m, 2H), 7.44-7.49 (m, 2H), 7.6 (dd, J=1.74 & 6.5 Hz, 1H), 7.70 (ddd, J=1.75, 8.0 &13.63 Hz, 2H), 7.87-7.91 (m, 3H), 7.94-8.0 (m, 3H), 8.88 (s, 1H), 9.11 (d, J=9 Hz, 1H), 9.16 (s, 1H), 11.36 (s, 2H).

Synthesis of 3-(9,9-dimethyl-9H fluoren-2-yl)-12,12-dimethyl-5H-indeno[1,2-b]phenanthrene-5,6(12H)-dione (compound 6): 0.28 g of 3-(9,9-dimethyl-9H fluorene-2 yl)-12,12-dimethyl-12H-indeno[1,2-b]phenanthrene-6-ol 5 (0.55 mmol) was dissolved in 1 mL DMF. Added 18 mg N, N′-Bis(Salycilidene)ethylene-diamino cobalt (II) hydrate (0.055 mmol). Stirred the reaction mixture at RT with air bubbling for 16 hours. The reaction mixture was diluted with CHCl₃, washed with water, and dried (anhyd. Na₂SO4). The solvents were evaporated, and the residue was purified by column chromatography eluting with a gradient composed of Ethyl acetate/Hexane using a medium-size silica column with a Yamazen automated system. The fractions containing the product were combined to afford 0.06 g of orange solid (21%, MW=516.64). Purity was confirmed by ¹H-NMR spectroscopy. 1H NMR (500 MZ, DMSO); δ=1.55 (s, 6H), 1.60 (s, 6H), 7.36-7.39 (m, 1H), 7.42-7.43 (m, 1H), 7.59 (dd, J=2.2 & 6.5 Hz, 1H), 7.63-7.64 (m, 2H), 7.82 (dd, J=1.73 & 8 Hz, 1H), 7.90 (dd, J=1.94 & 6.3 Hz, 1H), 7.98 (d, J=8.0 Hz, 1H), 8.03-8.07 (m, 2H), 8.21 (dd, J=2.2 & 8.2 Hz, 1H), 8.31 (s, 1H), 8.36 (d, J=2.15 Hz, 1H), 8.49 (s, 1H), 8.60-8.63 (m, 2H).

Synthesis of 10-bromo-3-(7-bromo-9,9-dimethyl-9H fluoren-2 yl)-12,12-dimethyl-5H-indeno[1,2-b]phenanthrene-5,6(12H)-dione (compound 7): 0.056 g of 3-(9,9-dimethyl-9H fluoren-2 yl)-12,12-dimethyl-5H-indeno[1,2-b] phenanthrene-5,6(12H)-dione 6 (0.108 mmol) was dissolved in 2 mL Conc. H₂SO₄ and cooled the reaction mixture at 0° C. Added 43 mg N-Bromosuccinimide (0.24 mmol) to the reaction mixture and stirred the reaction mixture at 0° C. for 1 hour and then at room temperature for 5 hours. The reaction mixture was diluted with CHCl₃ and washed with cold aq. NaHCO₃ solution, cold brine solution, and dried (anhyd. Na₂SO₄). The solvents were evaporated, and the residue was purified by column chromatography eluting with a gradient composed of Ethyl acetate/Hexane using a medium-size silica column with a Yamazen automated system. The fractions containing the product were combined to afford 0.01 g of orange solid (14%, MW=674.4). Purity was confirmed by ¹H-NMR spectroscopy. 1H NMR (500 MZ, DMSO); δ=1.56 (s, 6H), 1.60 (s, 6H), 7.42 (brs, 1H), 7.55-7.68 (m, 2H), 7.80-7.87 (m, 1H), 7.92 (d, J=8.2 Hz, 1H), 7.97-8.09 (m, 2H), 8.12 (s, 1H), 8.17-8.27 (m, 1H), 8.34-8.44 (m, 2H), 8.51 (d, J=11.5 Hz, 1H), 8.58-8.67 (m, 2H).

Synthesis of 10-bromo-3-(7-bromo-9,9-dimethyl-9H fluoren-2-yl)-5,6,12,12-tetramethyl-6,12-dihydro-5H-indeno[1,2-b] phenanthrene-5, 6-diol (compound 8): 0.008 g of 10-bromo-3-(7-bromo-9,9-dimethyl-9H fluoren-2 yl)-12,12-dimethyl-5H-indeno[1,2-b]phenanthrene-5,6(12H)-dione 7 (0.011 mmol) was dissolved in 1 mL THE and cooled the reaction mixture at 0° C. Added methyl magnesium bromide (3M in diethyl ether) 16 uL to the reaction mixture and stirred the mixture at 0° C.; for 2 h. The reaction mixture was diluted with CHCl₃ and washed with cold aq. NH₄C₁ solution, cold brine solution, and dried (anhyd. Na₂SO₄). The solvents were evaporated, and the residue was purified by column chromatography eluting with a gradient composed of Ethyl acetate/Hexane using a medium-size silica column with a Yamazen automated system. The fractions containing the product were combined to afford 0.05 g of orange solid (60%, MW=706.52). Purity was confirmed by ¹H-NMR spectroscopy. 1H NMR (500 MZ, DMSO); δ=1.23 (s, 3H), 1.24 (s, 3H), 1.51 (s, 6H), 1.54 (s, 6H), 5.12 (s, 2H), 7.3-7.4 (m, 3H), 7.5-7.6 (m, 2H), 7.71 (ddd, J=1.7, 7.8 &10 Hz, 2H), 7.78-7.91 (m, 3H), 7.94 (d, J=8 Hz, 1H), 7.99-8.06 (m, 2H), 8.08-8.12 (m, 1H).

### Example 2: Preparation of Fused DHP Fluorescent Monomers

Fused DHP monomers (compounds 32 and 33) were prepared according to exemplary Scheme (III) as described above.

Compounds 9 and 10 were prepared in an analogous fashion to the experimental procedure set forth in Example 1.

Compound 26 was prepared as follows: Compound 10 (0.61 mmoles, 0.2 g) was dissolved in THE (3 mL) and DMF (10 μL) added. The reaction mixture was cooled with an ice bath and then COCl₂ added (1.22 mmoles, 0.6 ml of 2M solution in dichloromethane). The reaction was stirred for 1.5 hours and then the solvents evaporated. The residue was dissolved in dichloromethane (4 mL) and AlCl₃ (0.8 mmoles, 0.106 g) added. After 16 hours the reaction mixture was diluted with dichloromethane and washed with water. The impure product was purified by automated column chromatography using silica gel as stationary phase and hexanes/ethyl acetate as mobile phase to afford compound 26 (0.115 g, 61%).

Compound 27 was prepared as follows: compound 26 (0.306 mmoles, 0.095 g) was dissolved in 4 mL of DMF and CO(SALEN)₂ (0.0306 mmoles, 10 mg) added. The reaction mixture was left to react uncapped for 16 hours and then poured into H₂O (80 mL), the mixture was filtered and washed with more H₂O to afford compound 27 as a red solid (0.084 g, 85%)

Compound 28 was made as follows: NBS was added to Compound 27 in sulfuric acid and the mixture was kept at 40° C. for overnight. Compound 28 precipitated from water.

Compound 29 was prepared as follows: In a conical flask, NaBH₄ was added into a stirring water-ethanol mixture. To this solution, Compound 28 was added portion-wise but quickly (within 5 min). The reaction mixture was allowed to stir for a day. The reaction was stopped and neutralized with diluted HCl acid. After the neutralization, the precipitate was filtered and washed with excess water. The resulted white precipitate was washed with very cold (<−15° C.) ethanol and methanol to obtain Compound 29.

Compound 30 was prepared as follows: In a 2 neck round bottom flask was added Compound 29 and 18-Crown-6 in THF. The solution was purged with nitrogen for 20 minutes and was added while nitrogen purging continues. In another RB, 1,3 propane sultone was added in THF and purged with nitrogen. This sultone solution was added to the solution containing Compound 29 by addition funnel over a period of 20-30 minutes. The reaction was stirred at RT for 4-5 hrs. The solvents were evaporated off and the precipitate was dissolved in water. Acetone was added to obtain white precipitate in the form of disodium salt. The precipitate was filtered and re-dissolved in water (minimal amount), neutralized with HCl, and precipitated again in acetone. Compound 30 was obtained after repeated precipitation (2-3 times) followed by centrifugation.

Compound 31 was prepared as follows: In a round bottom flask, Compound 30 was mixed with DMF. To this, SOCl₂ was added dropwise and the mixture was allowed to stir overnight. The next morning, the reaction mixture was poured into water and filtered, and the precipitate was dried to obtain Compound 31.

Compound 32 was prepared as follows: Compound 31 was mixed with 2.2 equivalent of PEG amine in a dichloromethane/TEA mixture. The reaction was sonicated for 3 hours and the crude product was extracted in dichloromethane followed by column chromatography (silica gel, MeOH—CHCl₃) to obtain Compound 32.

Compound 33 was prepared as follows: Compound 32 was mixed with DMSO under nitrogen. To this mixture, 3 equivalents of bispinacolatodiboron was added. The reagents was reacted with 12 equivalent of potassium acetate and 4 equivalents of Pd(dppf)Cl₂ catalyst for 5 hours at 80° C. The reaction mixture was cooled down and extracted with CHCl₃/water. The organic layer was concentrated and purified by column chromatography (silica gel, MeOH—CHCl₃) to obtain Compound 33.

### Example 3: Preparation of Double-Fused DHP Fluorescent Monomers

Double Fused DHP monomers (compounds 24 and 25) were prepared according to exemplary Scheme (II) as described above.

Compound 16 was prepared by Suzuki coupling reaction of methyl 2-(2-(4,4,5,5-tetramethyl-1,3,2-dioxaborolan-2-yl)phenyl)acetate with 2,7-dibromo-9,9-dimethyl-9H-fluorene and a similar experimental procedure as described for the synthesis of Compounds 32 and 33 in Example 2 was used to obtain Compounds 24 and 25.

### Example 4: Preparation of Fluorescent Fused DHP Polymer

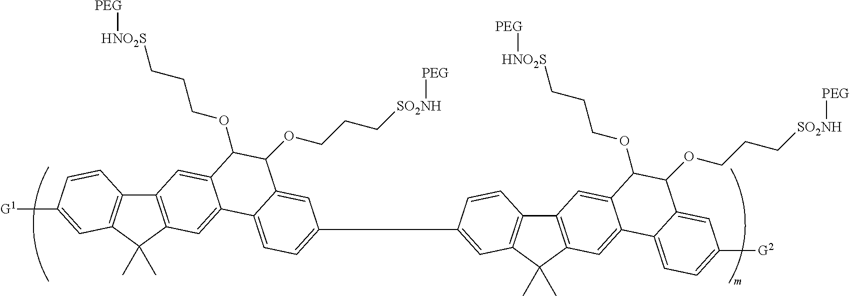

Method 1: In a round bottom flask add both a fused dibromo DHP monomer (compound 32) and a fused diboronic DHP monomer (compound 33) (1:1) in a DMF-water mixture and purge the mixture with nitrogen for 10 minutes. Mix about 20 equivalent of CsF and 10% of Pd(OAc)₂ under nitrogen and heat at 80° C. Monitor polymerization using UV-Vis spectroscopy and SEC chromatography. Later, add a capping agent (selected from G¹) containing an appropriate functional group to the reaction mixture. Three hours later, add a second capping agent (selected from G²) to the reaction mixture. After the reaction is complete, evaporate off the crude reaction mixture and pass it through a gel filtration column to remove small organic molecules and low MW oligomers. Later, pass the crude polymer through a Tangential flow filtration system equipped with a 100K MWCO membrane, and wash using 20% ethanol until the absorption of the filtrate diminishes.

Method 2: Alternatively, the polymerization can be accomplished by self-polymerizing a bromo-boronic ester of a fused DHP molecule. In a round bottom flask add fused DHP bromo-boronic ester to a DMF-water mixture and purge with nitrogen for 10 minutes. Mix about 10 equivalents of CsF and 5% of Pd(OAc)₂ under nitrogen and heat at 80° C. Monitor polymerization using UV-Vis spectroscopy and SEC chromatography. Later, add a capping agent (selected from G¹) containing appropriate functional group to the reaction mixture. Three hours later, add a second capping agent (selected from G²) to the reaction mixture. After the reaction, evaporate off the crude reaction mixture and pass it through a gel filtration column to remove small organic molecules and low MW oligomers. Later, pass the crude polymer through a Tangential flow filtration system equipped with a 100K MWCO membrane. Wash using 20% ethanol until the absorption of the filtrate diminishes.

Method 3: In a round bottom flask, dissolve both a fused dibromo DHP monomer and a fused diboronic DHP monomer (1:1) in a THE-water (4:1) mixture containing 10 equivalent of K₂CO₃ and 3% Pd(PPh₃)₄. Put the reaction mixture on a Schlenk line and degas with three freeze-pump-thaw cycles and then heat to 80° C. under nitrogen with vigorous stirring for 18 hours. Later, add a capping agent (selected from G¹) containing an appropriate functional group to the reaction mixture via a cannula under excess nitrogen pressure. Three hours later, add a second capping agent (selected from G²) to the reaction mixture. After the reaction, evaporate the crude reaction mixture off and pass through a gel filtration column to remove small organic molecules and low MW oligomers. Later, pass the crude polymer through a Tangential flow filtration system equipped with a 100K MWCO membrane. Wash using 20% ethanol until the absorption of the filtrate diminishes.

Method 4: Alternatively, the polymerization can be accomplished by self-polymerizing a bromo-boronic ester of a fused DHP molecule. In a round bottom flask, dissolve a bromo-boronic ester of fused DHP in THE-water (4:1) mixture containing 10 equivalent of K₂CO₃ and 3% Pd(PPh₃)₄. Put the reaction mixture on a Schlenk line and degas with three freeze-pump-thaw cycles and then heat to 80° C. under nitrogen with vigorous stirring for 18 hours. Later, add a capping agent (selected from G¹) containing an appropriate functional group to the reaction mixture via a cannula under excess nitrogen pressure. Three hours later, add a second capping agent (selected from G²) to the reaction mixture. After the reaction, evaporate off the crude reaction mixture and pass through a gel filtration column to remove small organic molecules and low MW oligomers. Later, pass the crude polymer through a Tangential flow filtration system equipped with a 100K MWCO membrane. Wash using 20% ethanol until the absorption of the filtrate diminishes.

### Example 5: Preparation of Fluorescent Copolymers Containing Fused DHP-Fluorene and DHP

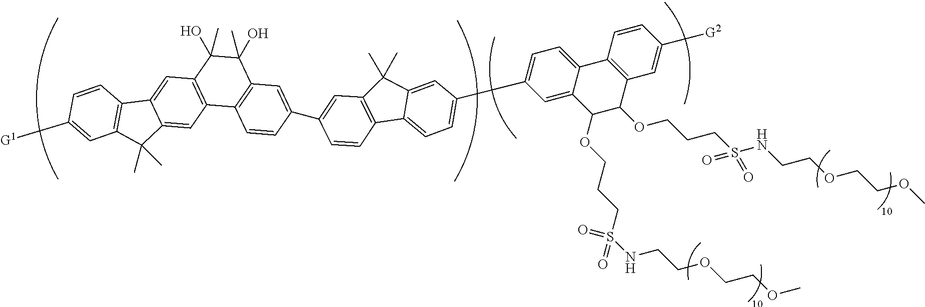

Method 1: In a round bottom flask, dissolve both a dibromo fused DHP-fluorene monomer (compound 8) and a diboronic DHP monomer (or, alternatively, a diboronic fused DHP-fluorene monomer and a dibromo DHP monomer) (1:1) in a DMF-water mixture and purge with nitrogen for 10 minutes. Mix about 20 equivalents of CsF and 10% of Pd(OAc)₂ under nitrogen and heat at 80° C. Monitor polymerization using UV-Vis spectroscopy and SEC chromatography. Later add a capping agent (selected from G¹) containing an appropriate functional group to the reaction mixture. Three hours later, add a second capping agent (selected from G²) to the reaction mixture. After the reaction, evaporate off the crude reaction mixture and pass through a gel filtration column to remove small organic molecules and low MW oligomers. Later, pass the crude polymer through a Tangential flow filtration system equipped with a 100K MWCO membrane. Wash using 20% ethanol until the absorption of the filtrate diminishes.

Method 2: In a round bottom flask dissolve both a dibromo fused DHP-fluorene monomer (compound 8) and a diboronic DHP monomer (or, alternatively, a diboronic fused DHP-fluorene monomer and a dibromo DHP monomer) (1:1) in a THE-water (4:1) mixture containing 10 equivalents of K₂CO₃ and 3% Pd(PPh₃)₄. Put the reaction mixture on a Schlenk line and degas with three freeze-pump-thaw cycles and then heat to 80° C. under nitrogen with vigorous stirring for 18 hours. Later, add a capping agent (selected from G¹) containing an appropriate functional group to the reaction mixture via a cannula under excess nitrogen pressure. Three hours later, add a second capping agent (selected from G²) to the reaction mixture. After the reaction, evaporate off the crude reaction mixture and pass through a gel filtration column to remove small organic molecules and low MW oligomers. Later, pass the crude polymer through a Tangential flow filtration system equipped with a 100K MWCO membrane. Wash using 20% ethanol until the absorption of the filtrate diminishes.

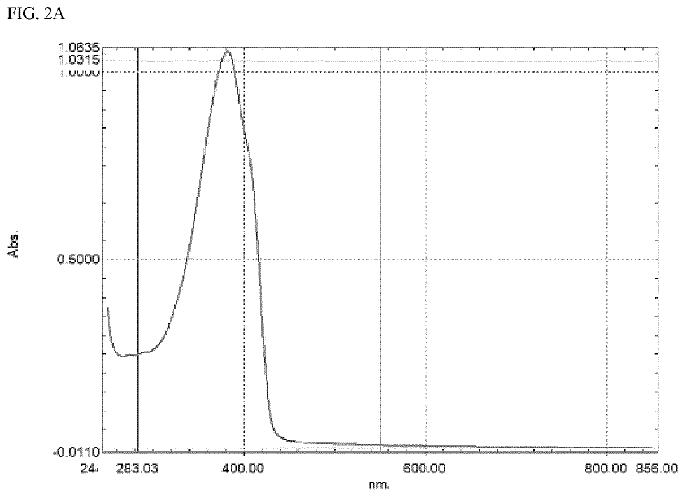

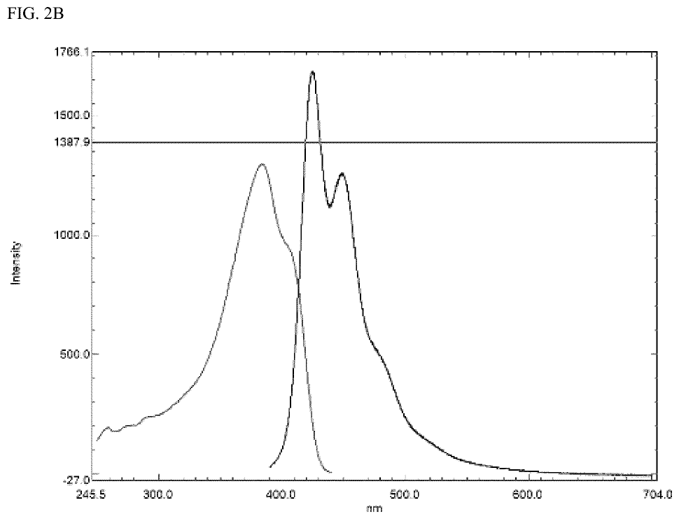

It is believed that the fluorescent polymers of the present disclosure possess certain physical and chemical characteristics of absorption, fluorescence, brightness, molecular weight, polydispersity, dye to protein ratio when conjugated to a binding partner (e.g., antibody etc.). In some instances, the ranges of these parameters are those shown in FIGS. 2A, 2B, and Table 1.

TABLE 1
Photophysical properties of fluorescent polymer containing
fused DHP monomer according to the present disclosure.

| | |
|---|---|
| Number Averaged Molecular | 20K to 200K (e.g., 40K) |
| Weight (Mn, Dalton) | |
| Polydispersity | 1.1-2 (e.g., 1.13) |
| Extinction Coefficient at 375 nm | 100K to 3,500K (e.g., 254K) |
| QY factor | 0.2-0.9, e.g., 0.344 |
| Brightness | 100K to 3,200K |
| F/P | 1-12 |
| Absorption/Emission Max | λₘₐₓ390-420 nm; 335-370 nm |
| | λₑₘ 425-445 nm; 370-395 nm |

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

We claim:

1. A fused dihydrophenanthrene (DHP) fluorescent polymer comprising at least one monomer or co-monomer having a structure of any one of Formula (A1)-(A6): 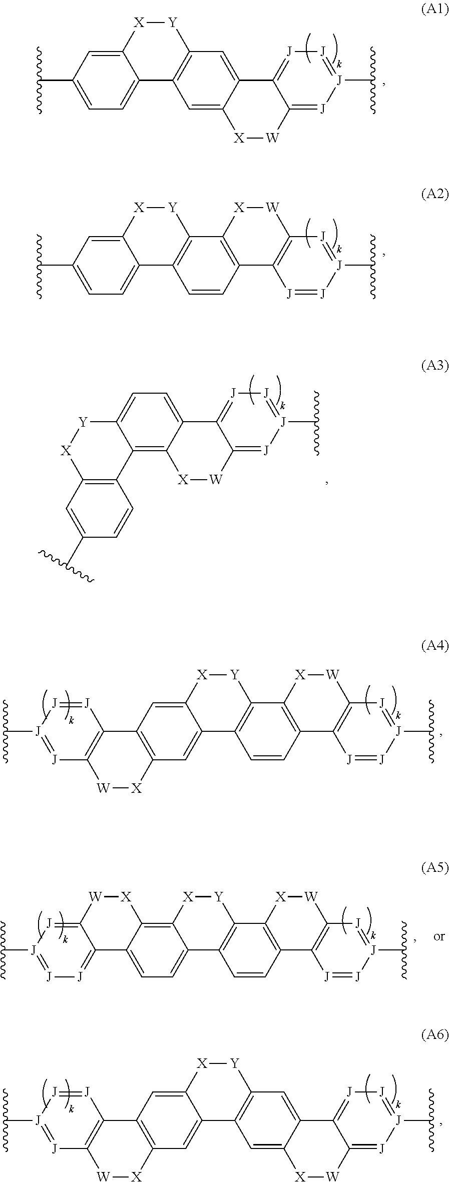
wherein
each [symbol] in A1-A6 is a site for covalent attachment to the unsaturated backbone of the fluorescent polymer;
each X is independently selected from the group consisting of CH₂, CR¹R², CHR¹, CHR², X′R¹R², NH, NR¹, O, S, SO, SO₂, SONHR², PR⁷, PO(R⁷)₂, POR², P(O)OH, PONHR², and SiR¹R²;
each Y is independently selected from the group consisting of X, CH₂, CR¹R², CHR¹, CHR², X′R¹R², NH, NR¹, O, S, SO, SO₂, SONHR², PR⁷, PO(R⁷)₂, POR², P(O)OH, PONHR², and SiR¹R²;
each X′ is independently selected from the group consisting of a C and Si;
each W is independently selected from the group consisting of a bond and Y; when W is a bond X is directly bonded to both rings;
and at least one of W, X, X′, or Y comprises a water-solubilizing moiety;
each J is independently selected from the group consisting of CH, N, NH, S, O, Se, and Si;
each R¹ is independently selected from the group consisting of a water-solubilizing moiety, alkyl, alkene, alkyne, cycloalkyl, haloalkyl, (hetero)aryloxy, (hetero)arylamino, aryl, heteroaryl, a PEG group, carboxylic acid, ammonium alkyl salt, ammonium alkyloxy salt, ammonium oligoether salt, sulfonate alkyl salt, sulfonate alkoxy salt, sulfonate oligoether salt, sulfonamido oligoether, sulfonamide, sulfinamide, phosphonamidate, phosphinamide, 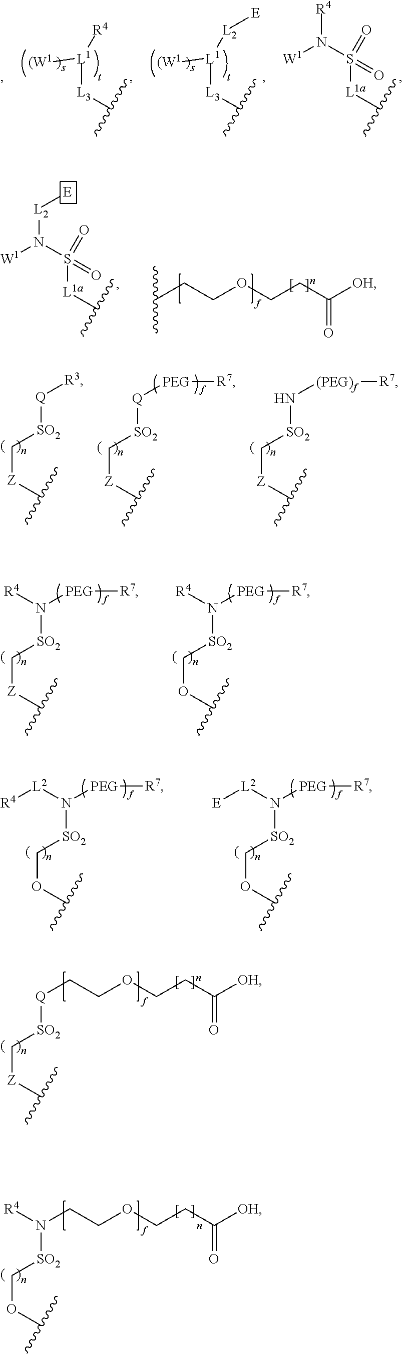 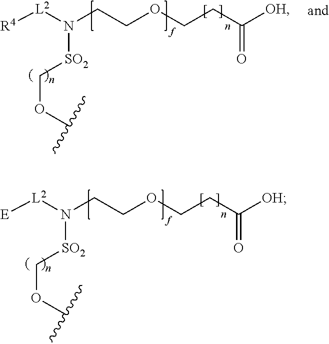
each R² is independently selected from the group consisting of a water-solubilizing moiety, a linker moiety, hydrogen, alkyl, alkene, alkyne, cycloalkyl, haloalkyl, (hetero)aryloxy, aryl, heteroaryl, (hetero)arylamino, sulfonamide-PEG, phosphoramide-PEG, ammonium alkyl salt, ammonium alkyloxy salt, ammonium oligoether salt, sulfonate alkyl salt, sulfonate alkoxy salt, sulfonate oligoether salt, sulfonamido oligoether, sulfonamide, sulfinamide, phosphonamidate, phosphinamide, 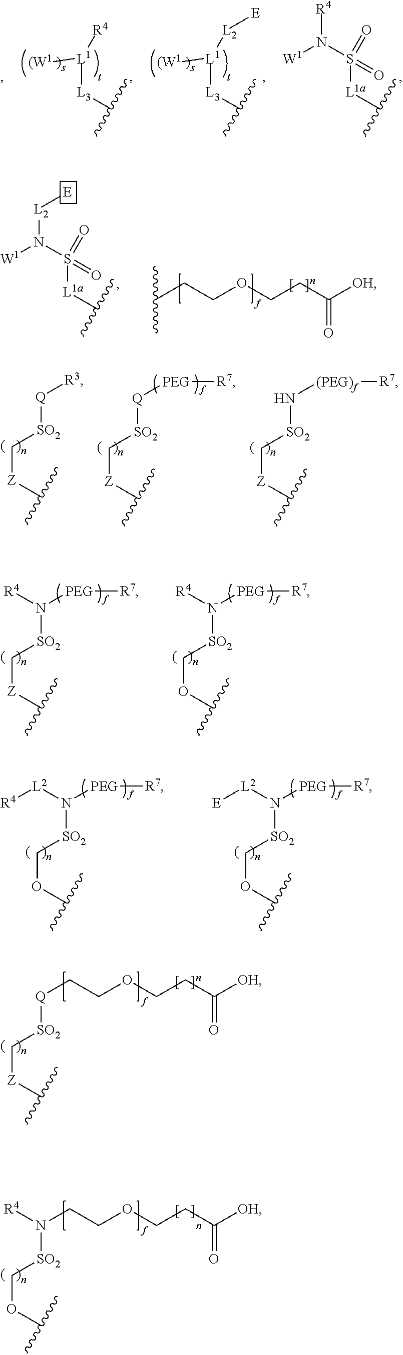 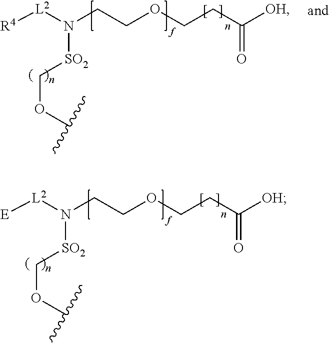
each R³ is independently a water-solubilizing moiety;
Q is a bond, NR⁴, CHR⁴, or —CH₂;
Z is CH₂, O, CHR⁴, or NR⁴;
R⁴ is H, alkyl, PEG, a water-solubilizing moiety, a linked water-solubilizing moiety, a linker moiety, a chromophore, a linked chromophore, a binding partner, a linked binding partner, functional moiety, a linked functional moiety, a PEG group, a linked PEG group, L²-E, carboxylic amine, amine, carbamate, carboxylic acid, carboxylate ester, maleimide, activated ester, N-hydroxysuccinimidyl, hydrazine, hydrazide, hydrazone, azide, alkyne, alkene, tetrazine, aldehyde, thiol, or protected groups thereof;
W¹ is a water-solubilizing moiety;
L¹, L², and L³ are linker moieties;
each E is an independently selected chromophore, functional moiety, substrate, or binding partner;
each R⁷ is independently selected from the group consisting of H, hydroxyl, C₁-C₁₂ alkyl, C₂-C₁₂ alkene, C₂-C₁₂ alkyne, C₃-C₁₂ cycloalkyl, C₁-C₁₂ haloalkyl, C₁-C₁₂ alkoxy, C₂-C₁₈ (hetero)aryloxy, C₂-C₁₈ (hetero)arylamino, C₂-C₁₂ carboxylic acid, C₂-C₁₂ carboxylate ester, and C₁-C₁₂ aralkyloxy;
at least one of R¹, R², R³, or R⁴ comprises a water-solubilizing moiety;
each f is independently an integer from 0 to 50;
each k is independently 0, 1, or 2;
each n is independently an integer from 1 to 20;
s is 1 or 2; and
t is 0, 1, 2, or 3.

2. The fluorescent polymer according to claim 1, wherein the fluorescent polymer is a water-soluble fluorescent polymer.

3. The fluorescent polymer according to claim 1, having the structure of Formula (I): 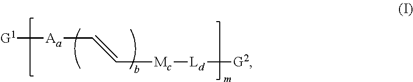
wherein
A is selected from the group consisting of Formula (A1) to (A6);
each optional M is a polymer modifying unit evenly or randomly distributed along the polymer main chain and is optionally substituted with one or more optionally substituted R¹, R², R³, or R⁴ groups;
each optional L is a linker;
G¹ and G² are each independently selected from an unmodified polymer terminus and a modified polymer terminus, optionally conjugated to E;
a, c, and d define the mol % of each unit within the structure which each can be evenly or randomly repeated and where each a is a mol % from 10 to 100%, each c is a mol % from 0 to 90%, and each d is a mol % from 0 to 25%;
each b is independently 0 or 1;
m is an integer from 1 to about 10,000.

4. The fluorescent polymer according to claim 3, having a structure selected from the group consisting of Formula (IIIa), (IIIb), (IIIc), (IIId), (IIIe), (IIIf), (IIIg), (IIIh), (IIIi), (IVa), (IVb), (IVc), (IVd), (IVe), (IVf), (IVg), (IVh), and (IVi):

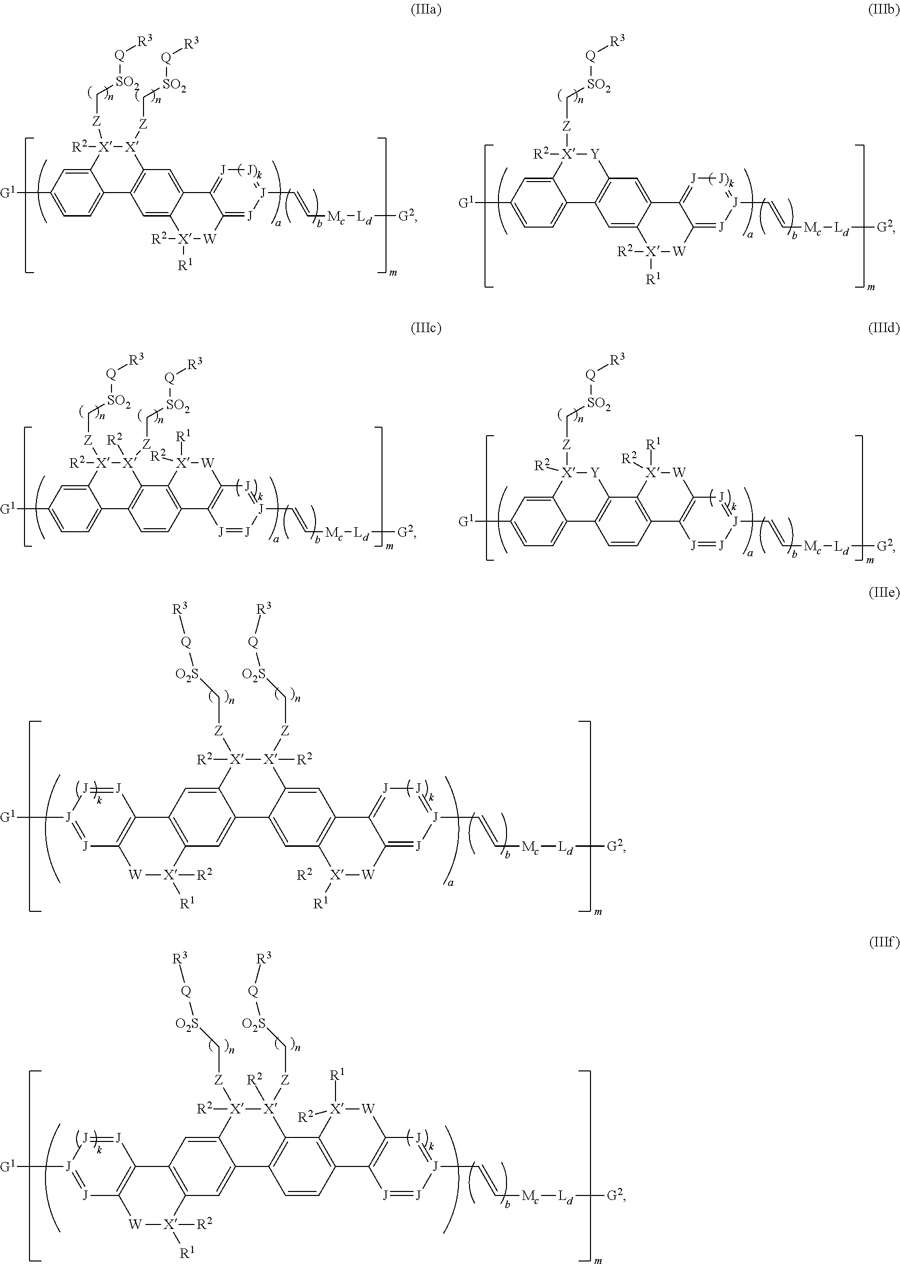

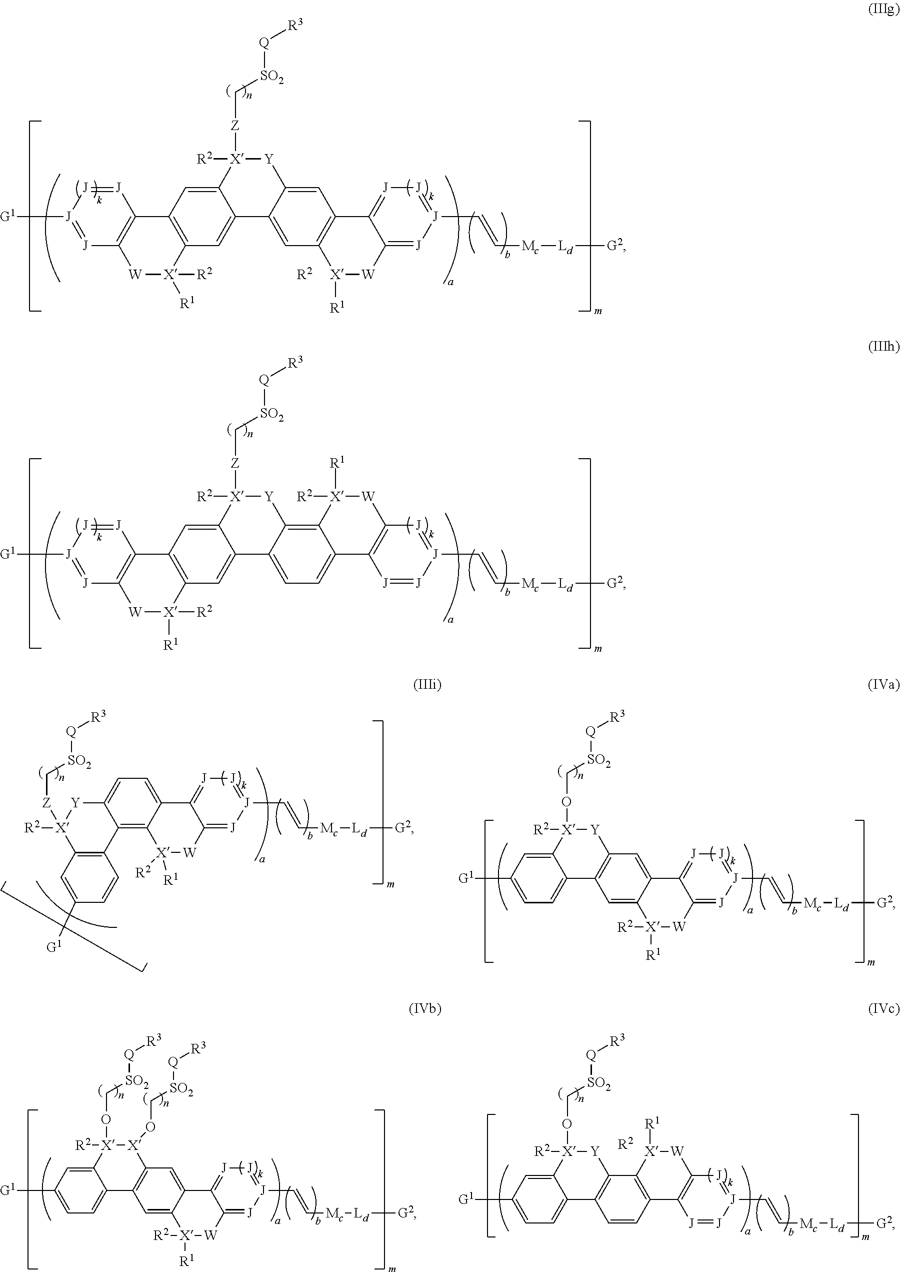

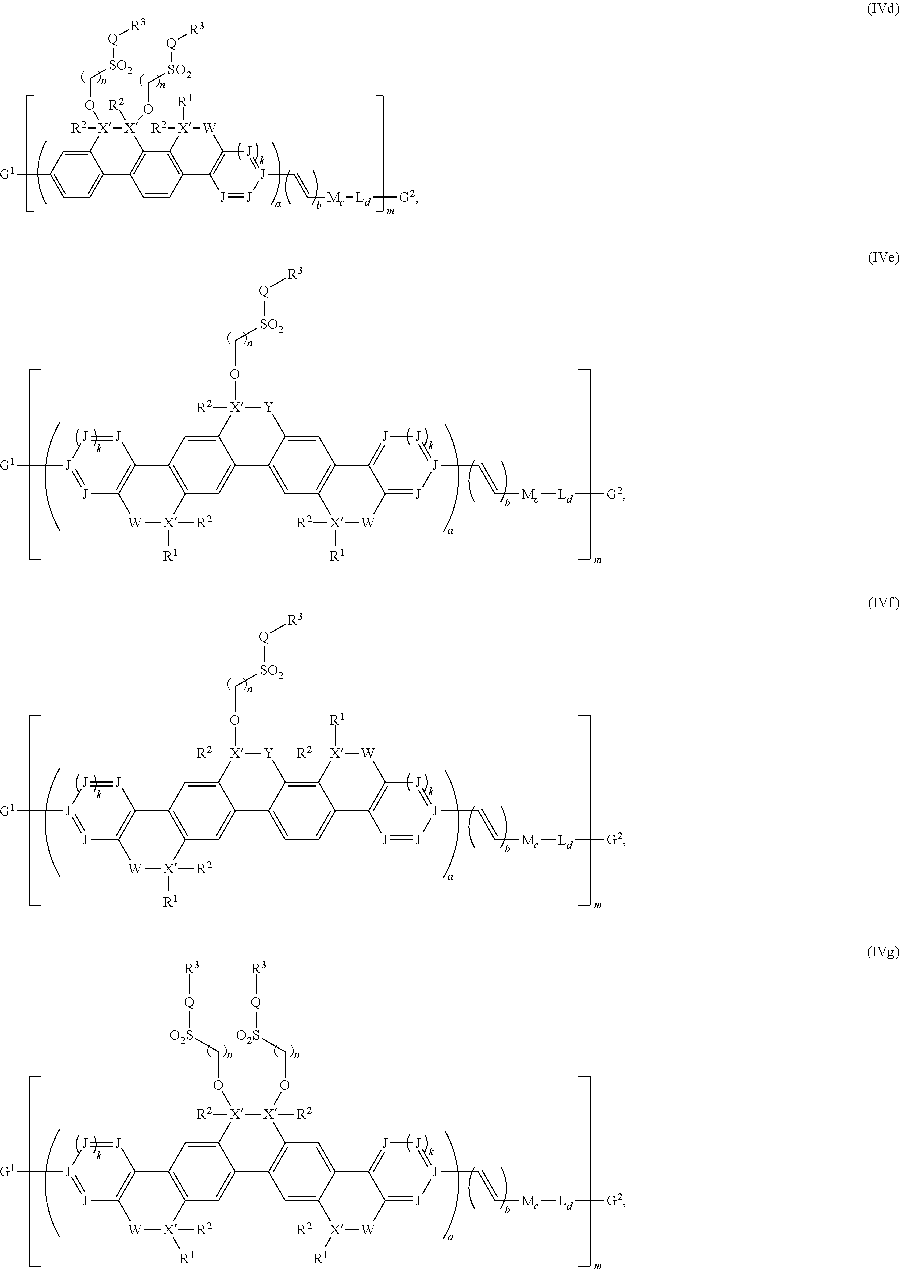

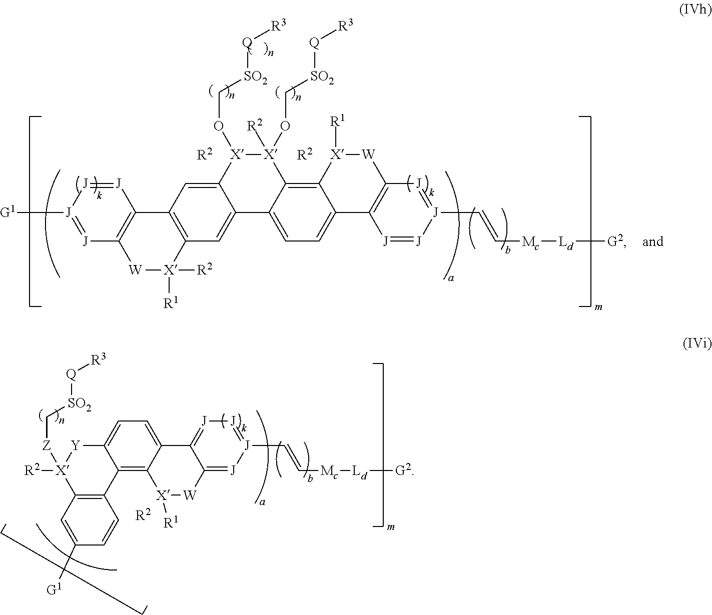

5. The fluorescent polymer according to claim 3, having a structure selected from the group consisting of Formula (Va), (Vb), (Vc), (VIa), (VIb), (VIc), (VId), (VIe), (VIf), (VIg), (VIh), (VIIId), (VIIIh), and (VIIIj):

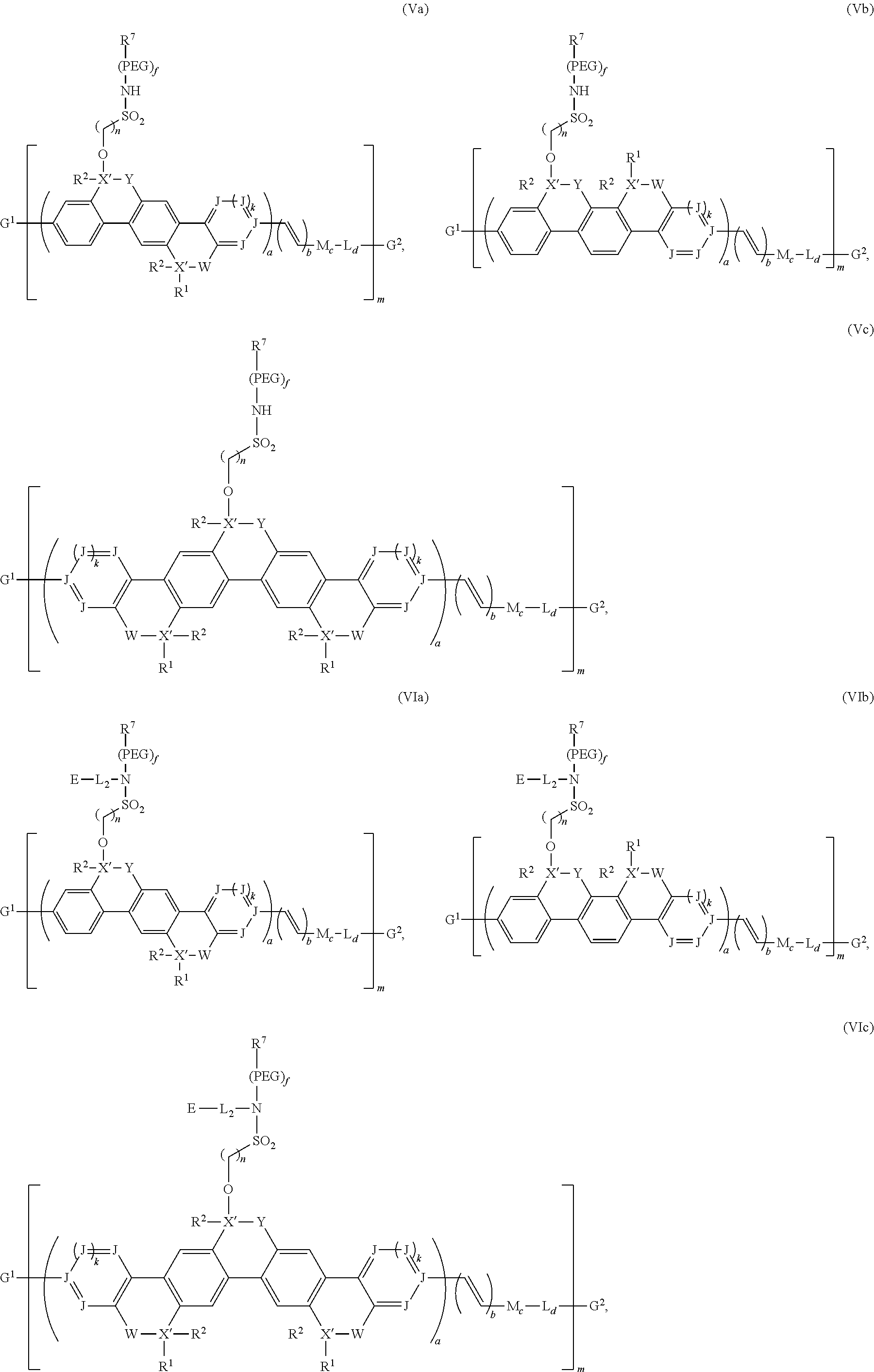

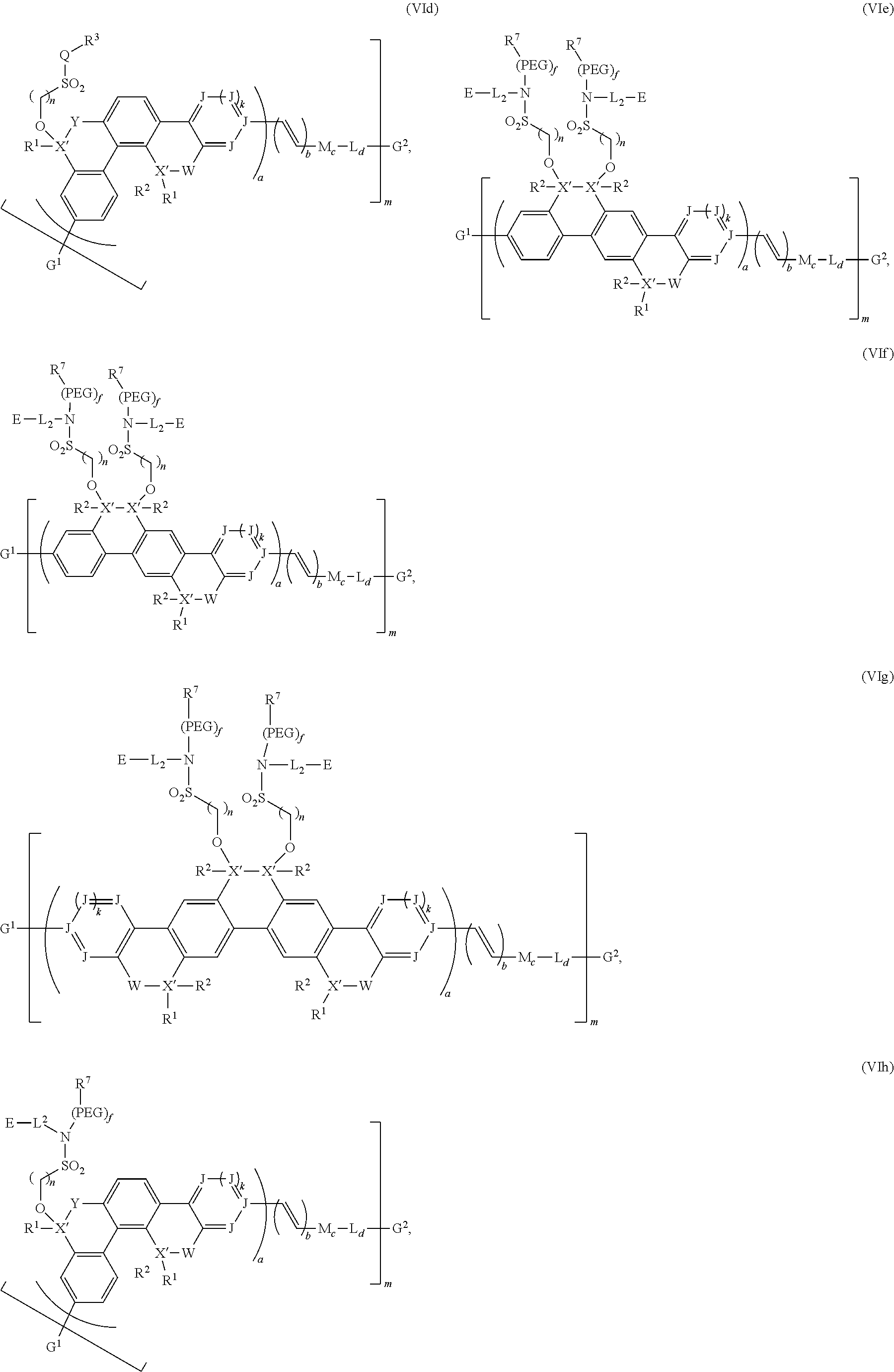

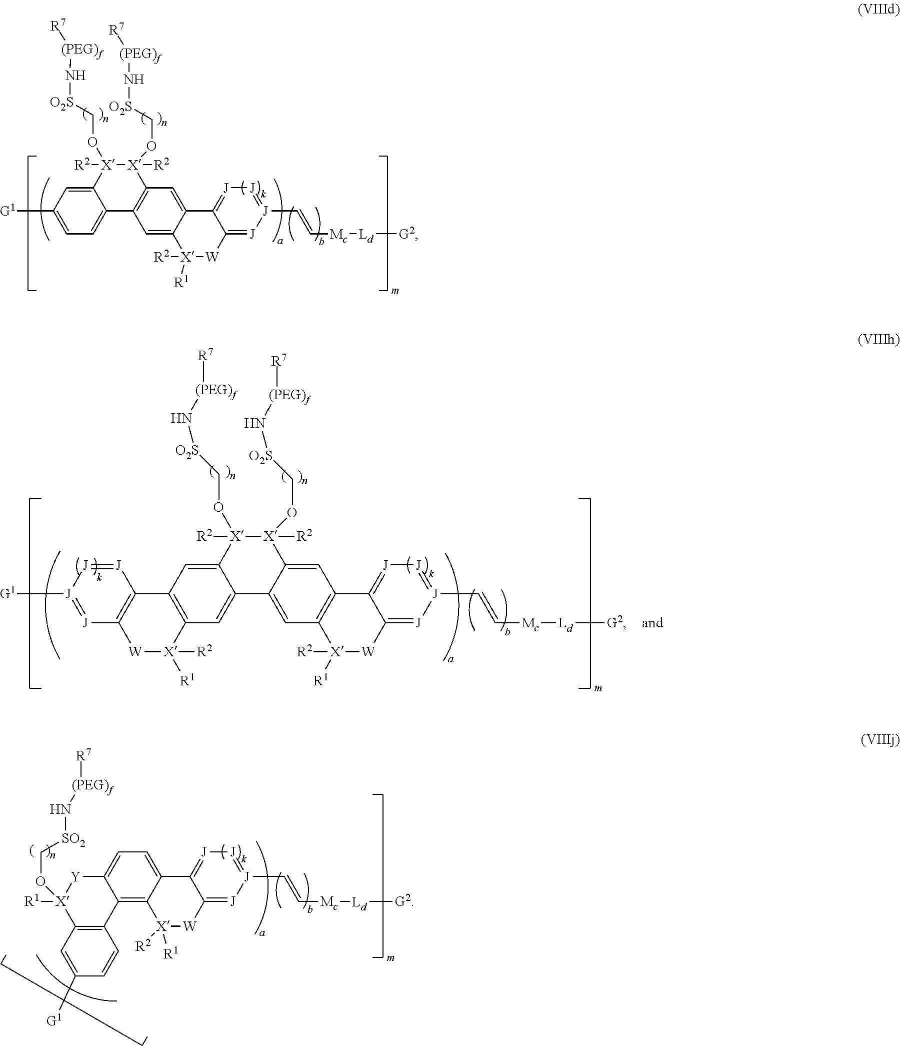

6. The fluorescent polymer according to claim 3, having a structure selected from the group consisting of Formulas (VIIa), (VIIb), (VIIc), (VIIIf), (VIIIi), and (VIIIk):

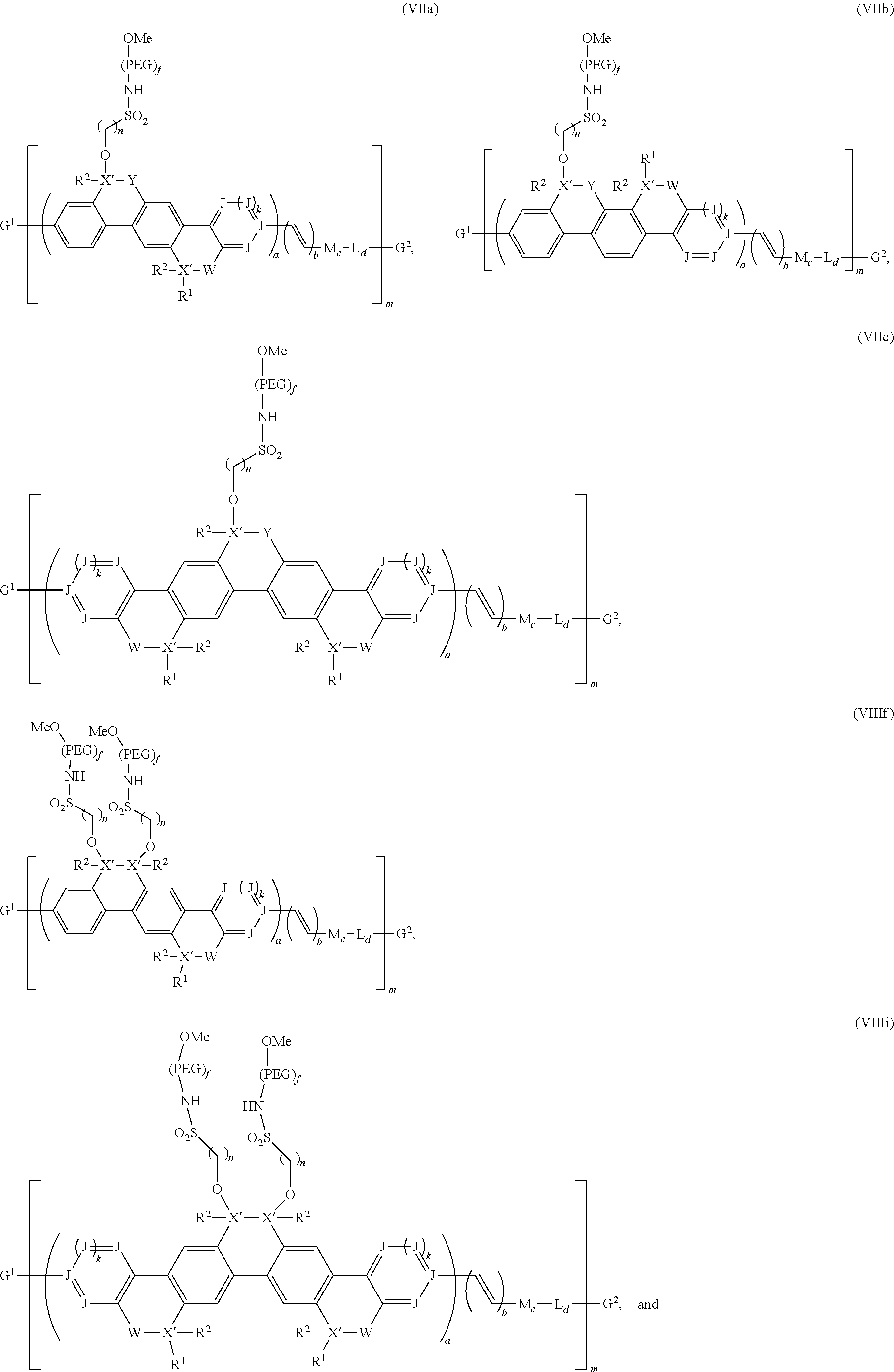

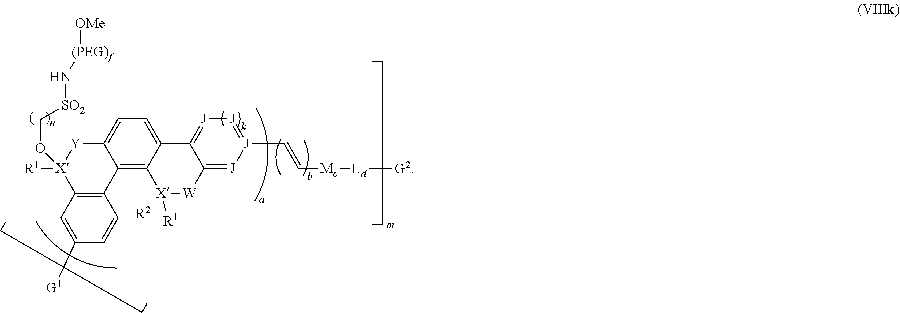

7. The fluorescent polymer according to claim 3, wherein each optional linker L is independently selected from the group consisting of an aryl or heteroaryl group evenly or randomly distributed along the polymer main chain and that is substituted with one or more pendant chains terminated with a functional group selected from amine, carbamate, carboxylic acid, carboxylate, maleimide, activated ester, N-hydroxysuccinimidyl, hydrazine, hydrazide, hydrazone, azide, alkyne, alkene, tetrazine, aldehyde, thiol, and protected groups thereof optionally conjugated to E.

8. The fluorescent polymer according to claim 7, wherein L is a linker independently selected from the group consisting of: 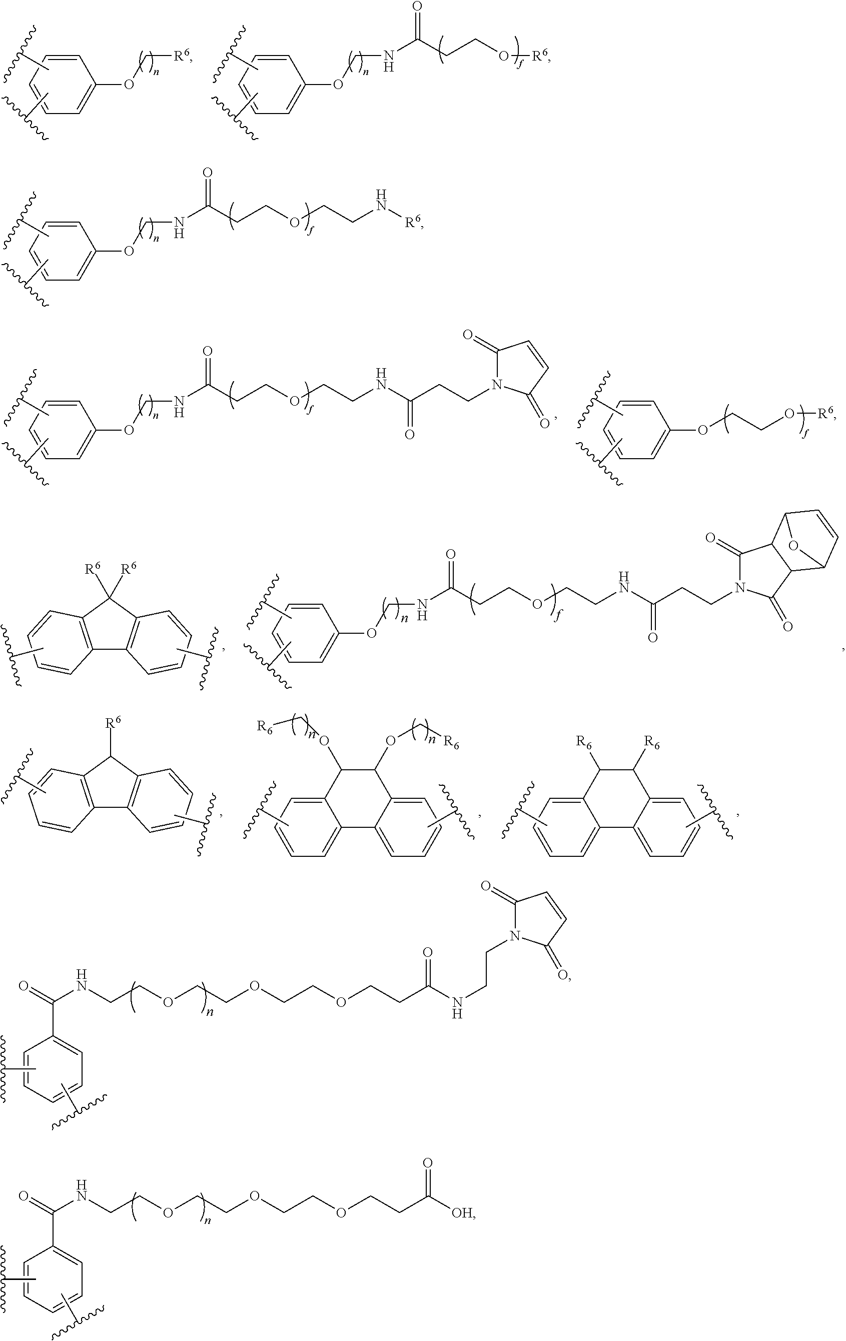 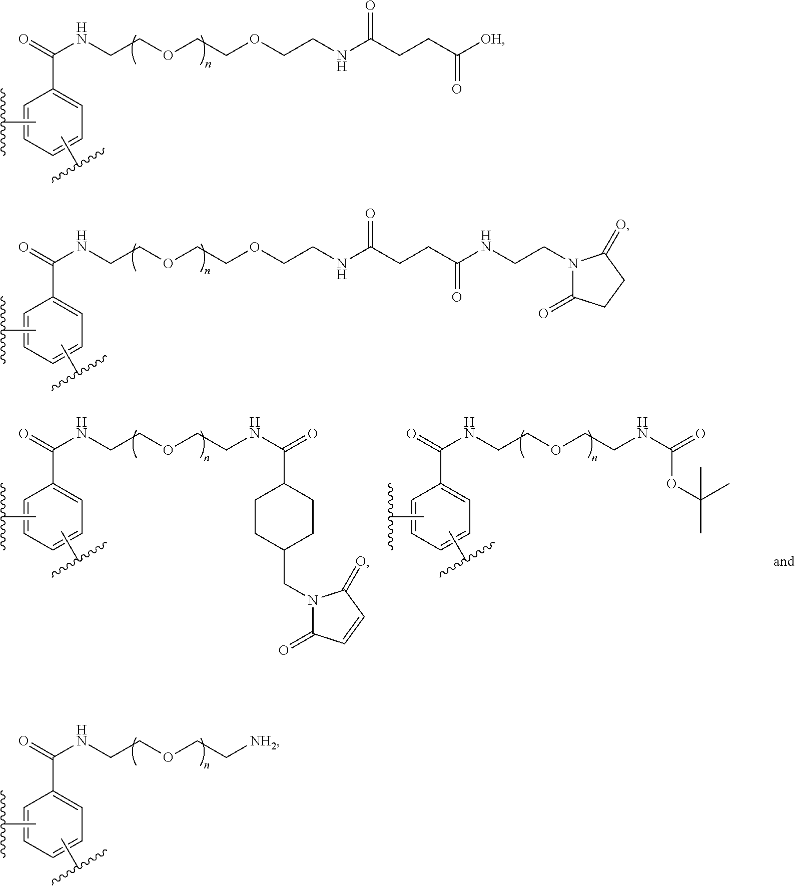
wherein
each R⁶ is independently selected from the group consisting of H, OH, SH, NHCOO-t-butyl, (CH₂)ₙCOOH, (CH₂)ₙCOOCH₃, (CH₂)ₙNH₂, (CH₂)ₙNH—(CH₂)ₙ—CH₃, (CH₂)ₙNHCOOH, (CH₂)ₙNHCO—(CH₂)ₙ—CO—(CH₂)ₙ—CH₃, (CH₂)ₙNHCOO—(CH₂)ₙ CH₃, (CH₂)ₙNHCOOC(CH₃)₃, (CH₂)ₙNHCO(C₃-C₁₂)cycloalkyl, (CH₂)ₙNHCO(CH₂CH₂O)_{f} C₁-C₆ alkyl, (CH₂)ₙNHCO(CH₂)ₙCOOH, (CH₂)ₙNHCO(CH₂)ₙCOO(CH₂)ₙCH₃, (CH₂)ₙ(OCH₂CH₂)_{f}OCH₃, N-maleimide, halogen, C₂-C₁₂ alkene, C₂-C₁₂ alkyne, C₃-C₁₂ cycloalkyl, C₁-C₁₂ halo alkyl, C₁-C₁₂ (hetero)aryl, C₁-C₁₂ (hetero)arylamino, benzyl optionally substituted with one or more halogen, hydroxyl, C₁-C₁₂ alkoxy, or (OCH₂CH₂)_{f}OCH₃,

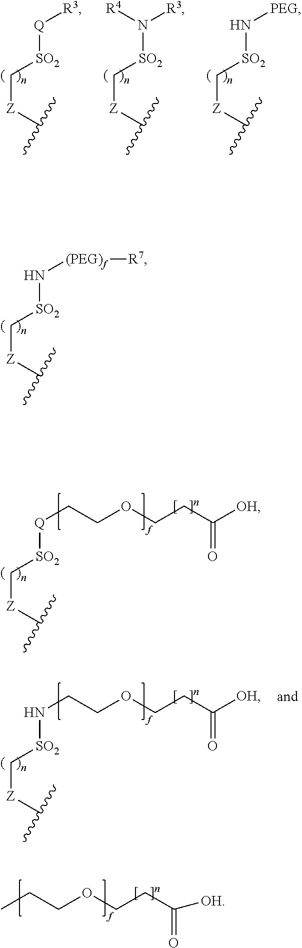

9. The fluorescent polymer according to claim 3, wherein each M is independently an optionally substituted arylene or optionally substituted heteroarylene.

10. The fluorescent polymer according to claim 9, wherein M is independently selected from the group consisting of: 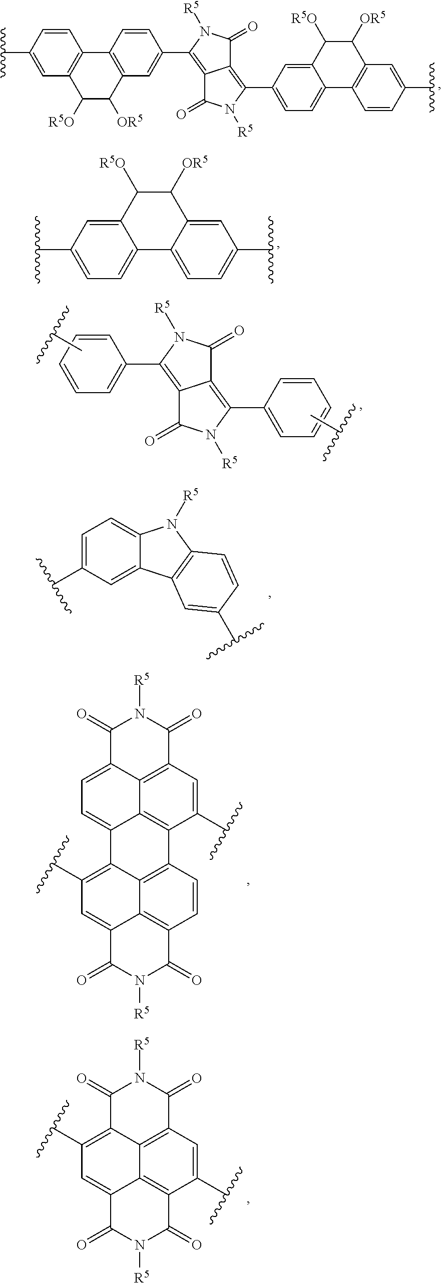 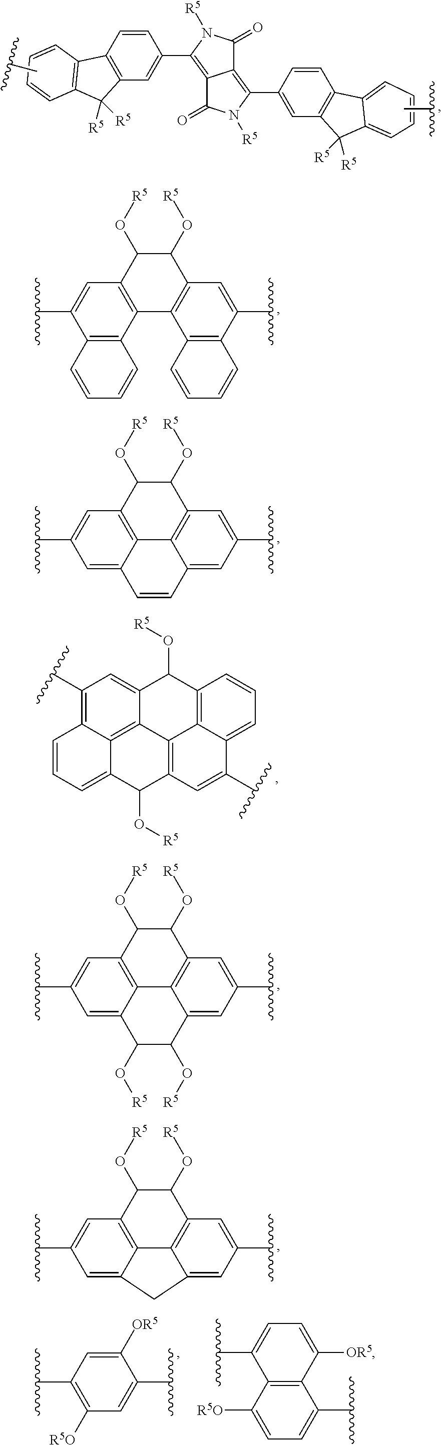 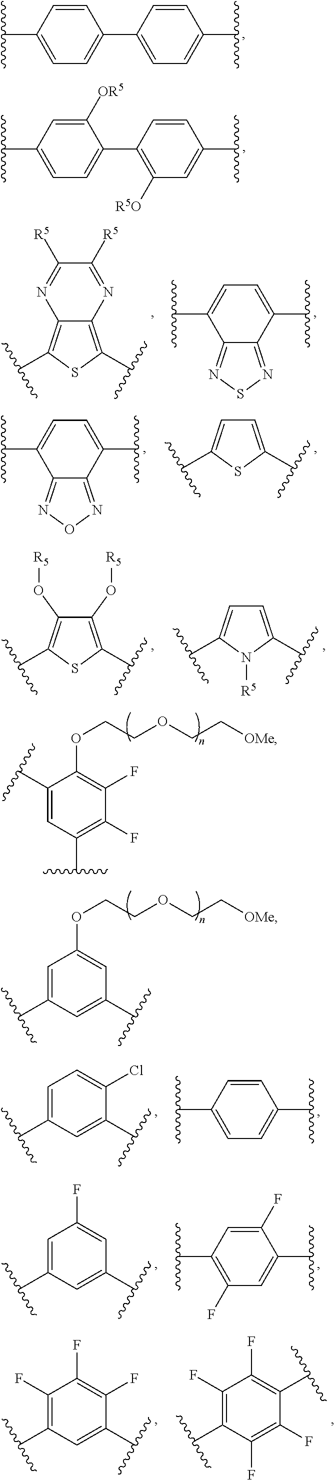 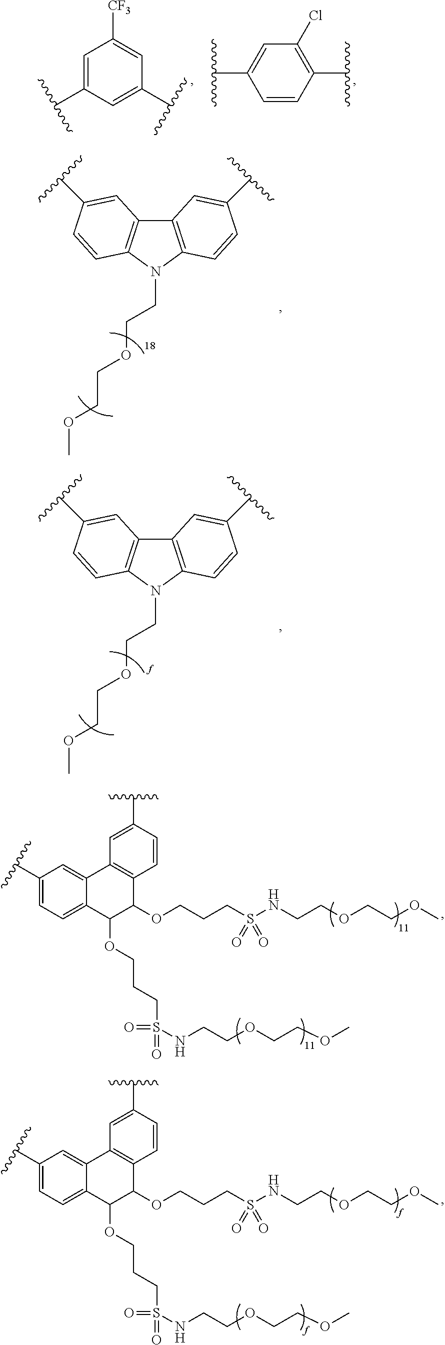 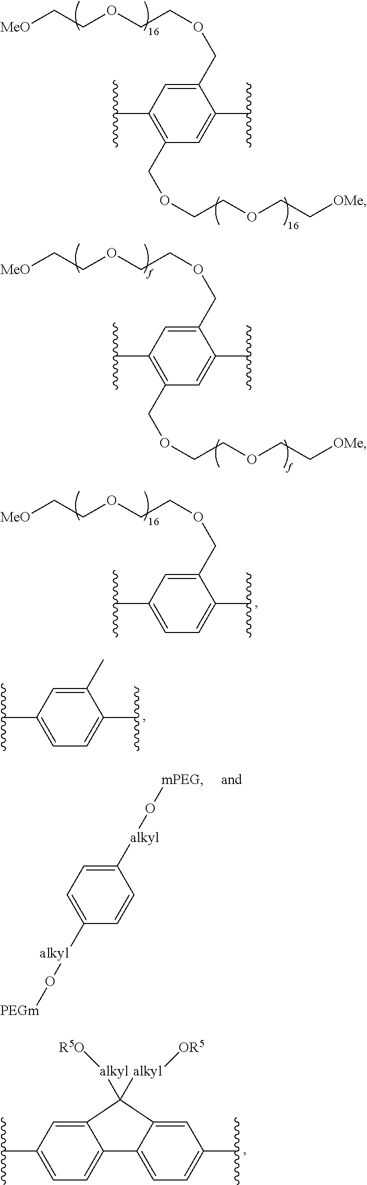
wherein each M can be substituted, and terminated with a functional group selected from amine, carbamate, carboxylic acid, carboxylate, maleimide, activated ester, N-hydroxysuccinimidyl, hydrazine, hydrazide, hydrazone, azide, alkyne, aldehyde, thiol, amide, sulfonamide, ether, thioether, thiocarbamate, hydroxyl, iodoacetyl, hydrazido, hydrazino, ketone, phosphine, epoxide, urea, thiourea, thioester, imine, disulfides, and protected groups thereof, optionally conjugated to a substrate, acceptor dye, or specific binding partner, and
wherein each R⁵ is independently selected from the group consisting of halogen, hydroxyl, C₁-C₁₂ alkyl, C₂-C₁₂ alkene, C₂-C₁₂ alkyne, C₃-C₁₂ cycloalkyl, C₁-C₁₂ haloalkyl, C₁-C₁₂ alkoxy, a C₂-C₁₈ (hetero)aryl group, C₂-C₁₈ (hetero)aryloxy, C₂-C₁₈ (hetero)arylamino, carboxylic acid, carboxylate ester, (CH₂)_{x′}(OCH₂—CH₂)_{y′}OCH₃, and (CH₂)_{x′}(OCH₂—CH₂)_{y′}OCF₃ where each x′ is independently an integer from 0-20 and each y′ is independently an integer from 0-50.

11. The fluorescent polymer according to claim 1, wherein G¹ and G² are each independently selected from the group consisting of hydrogen, halogen, alkyne, halogen substituted aryl, silyl, diazonium salt, triflate, acetyloxy, azide, sulfonate, phosphate, boronic acid substituted aryl, boronic ester substituted aryl, boronic ester, boronic acid, optionally substituted aryl, optionally substituted heteroaryl, optionally substituted dihydrophenanthrene (DHP), optionally substituted fluorene, and optionally substituted tetrahydropyrene (THP),
wherein the substituted aryl, heteroaryl, fluorene, DHP, or THP are substituted with one or more pendant chains terminated with a functional group, optionally conjugated to E.

12. The fluorescent polymer according to claim 11, wherein the functional group is selected from the group consisting of amine, carbamate, carboxylic acid, carboxylate, maleimide, activated ester, N-hydroxylsuccinimidyl, hydrazine, hydrazide, hydrazone, azide, alkyne, alkene, tetrazine, aldehyde, thiol, and protected groups thereof.

13. The fluorescent polymer according to claim 1, wherein G¹ and G² are each independently selected from the group consisting of: 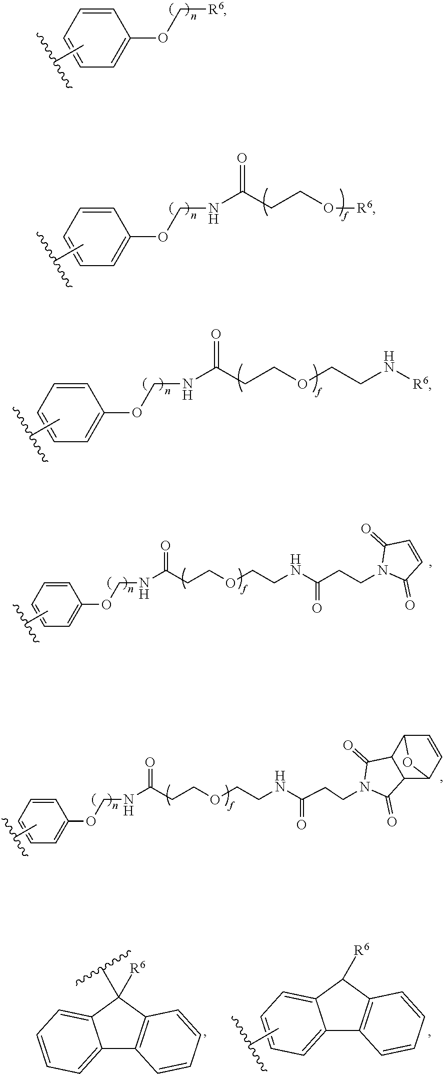 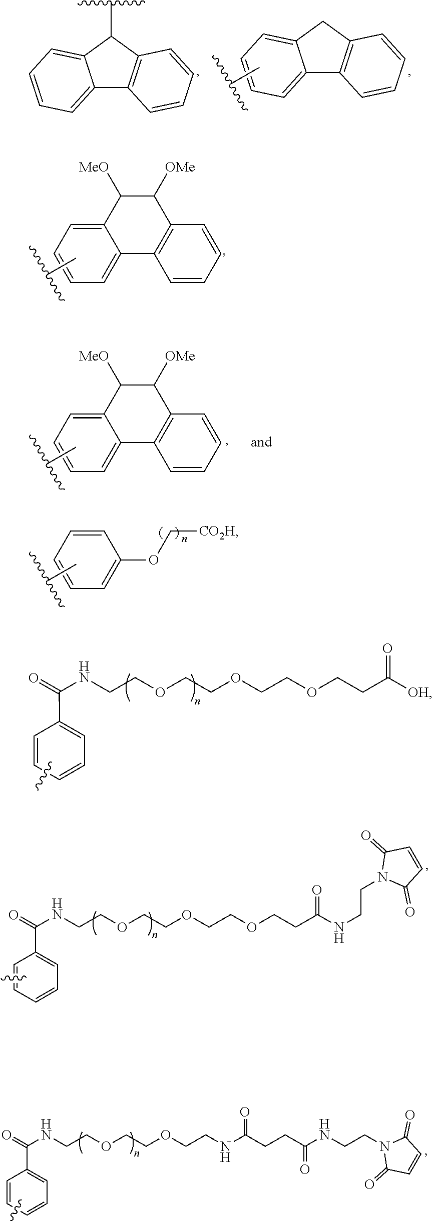 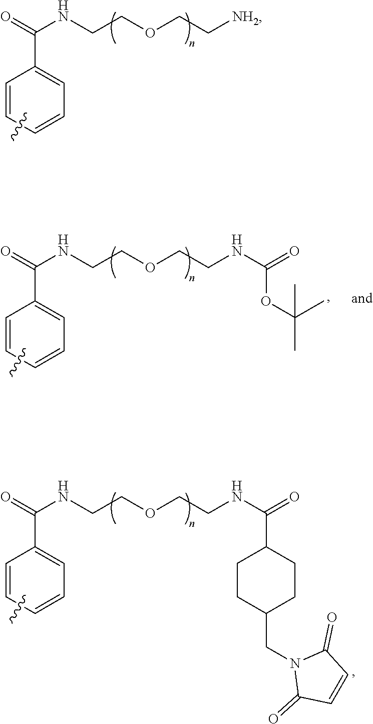
wherein
each R⁶ is independently selected from the group consisting of H, OH, SH, NHCOO-t-butyl, (CH₂)ₙCOOH, (CH₂)ₙCOOCH₃, (CH₂)ₙ(CH₂CH₂O)_{f}COOH, (CH₂)ₙNH₂, (CH₂)ₙNH—(CH₂)ₙ—CH₃, (CH₂)ₙNHCOOH, (CH₂)ₙNHCO—(CH₂)ₙ CO—(CH₂)ₙ—CH₃, (CH₂)ₙNHCOO—(CH₂)ₙ—CH₃, (CH₂)ₙNHCOOC(CH₃)₃, (CH₂)ₙNHCO(C₃-C₁₂)cycloalkyl, (CH₂)ₙNHCO(CH₂CH₂O)_{f} (C₁-C₆) alkyl, (CH₂)ₙNHCO(CH₂)ₙCOOH, (CH₂)ₙNHCO(CH₂)ₙCOO(CH₂)ₙCH₃, (CH₂)ₙ(OCH₂CH₂)_{f}OCH₃, N-maleimide, halogen, C₂-C₁₂ alkene, C₂-C₁₂ alkyne, C₃-C₁₂ cycloalkyl, C₁-C₁₂ halo alkyl, C₁-C₁₂ (hetero)aryl, C₁-C₁₂ (hetero)arylamino, azide, tetrazine, and benzyl optionally substituted with one or more halogen, hydroxyl, C₁-C₁₂ alkoxy, or (OCH₂CH₂)_{f}OCH₃,

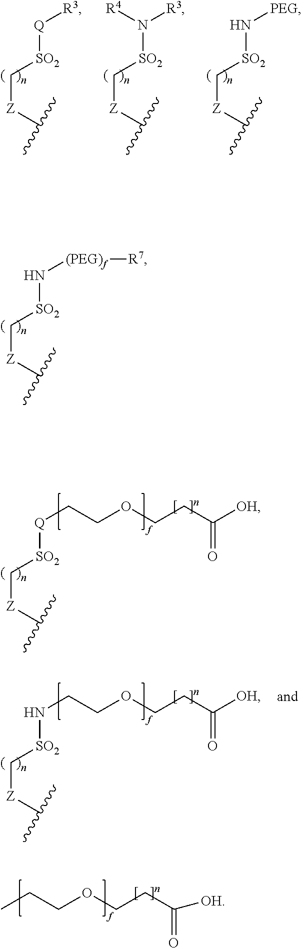

14. A fluorescent tandem polymer, comprising:
a fluorescent polymer according to claim 1; and
a signaling chromophore covalently linked to the polymeric dye in energy-receiving proximity therewith.

15. A fluorescent copolymer according to claim 3 having the structure of Formula (I), wherein A comprises at least two different monomeric units selected from the group consisting of Formula (A1), (A2), (A3), (A4, (A5), (A6), and (A7):

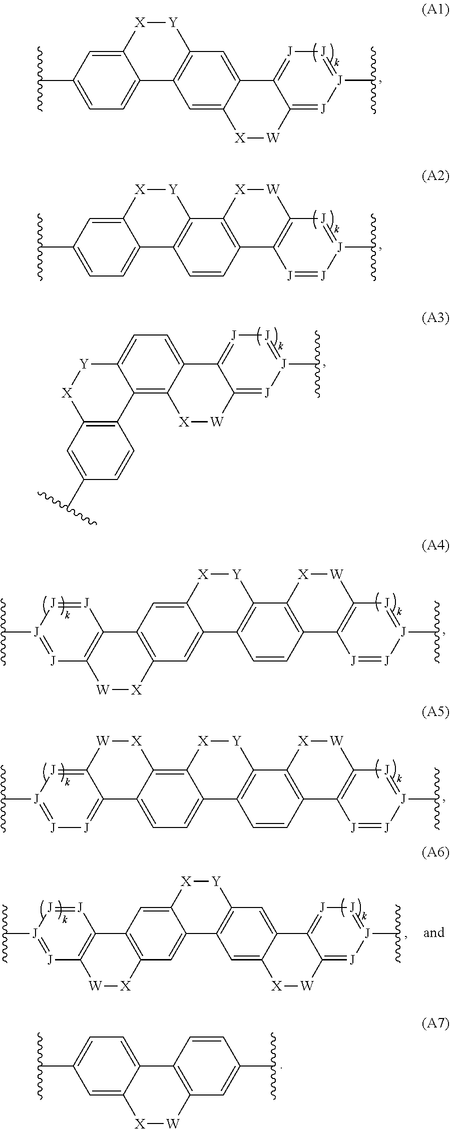

16. A fluorescent copolymer according to claim 15 comprising a structure selected from the group consisting of Formula (XIa), (XIb), (XIc), (XId), (XIe), (XIf), (XIg), and (XIh):

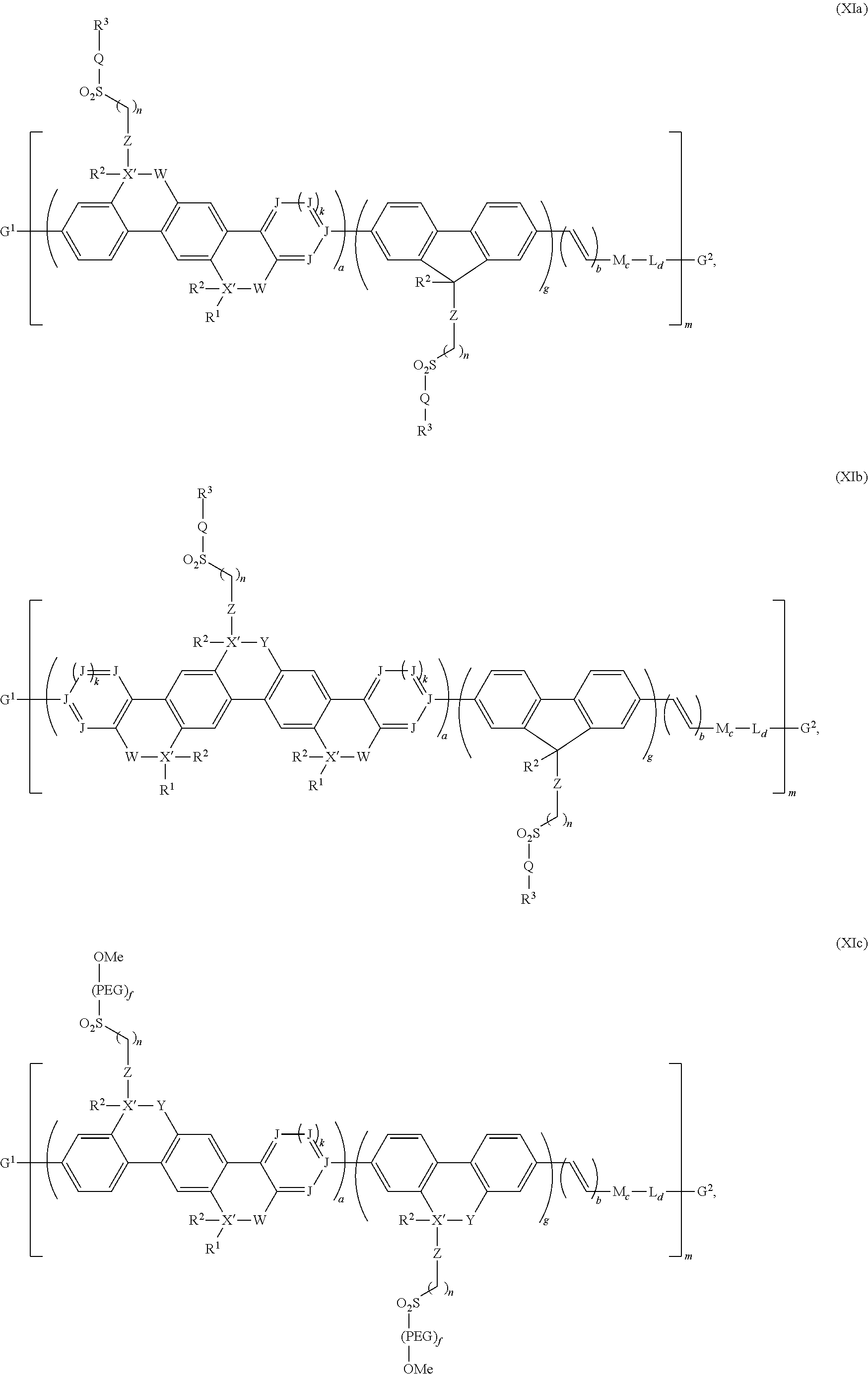

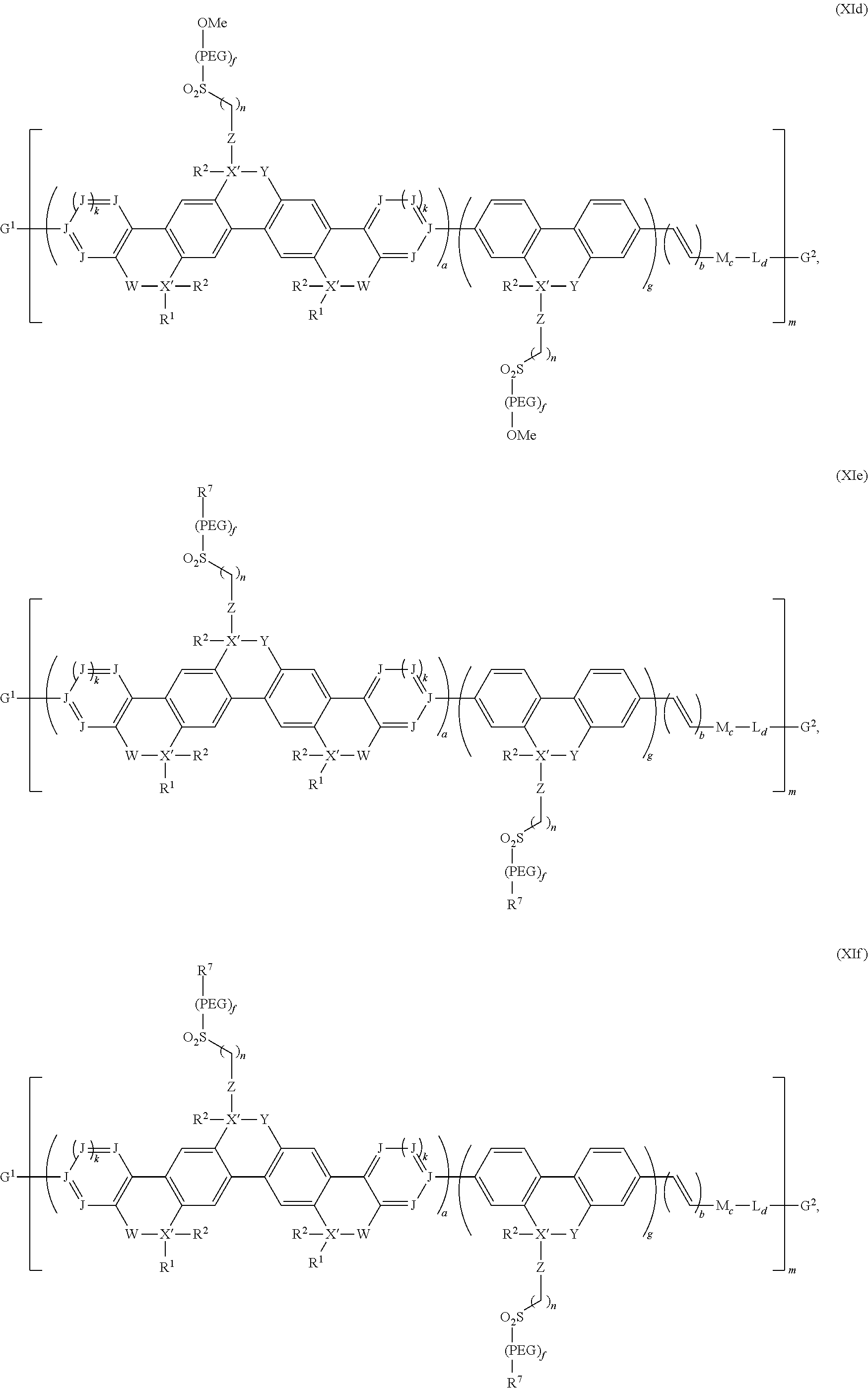

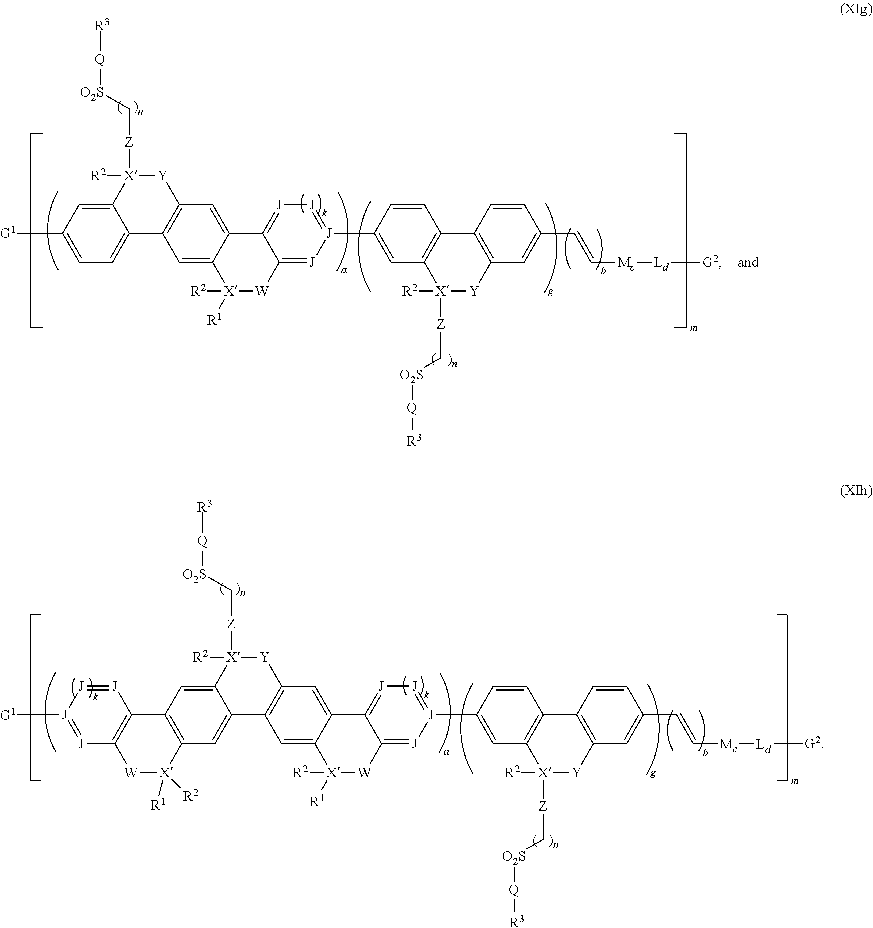

17. A labeled specific binding partner, comprising:
the fluorescent polymer according to claim 1; and
a specific binding partner covalently linked to the polymer.

18. The labeled specific binding partner of claim 17, wherein the fluorescent polymer is a tandem polymer covalently linked to one or more acceptor dyes.

19. The labeled specific binding partner according to claim 17, wherein the specific binding partner is selected from the group consisting of a protein, peptide, affinity ligand, antibody, antibody fragment, carbohydrate, lipid, nucleic acid, and an aptamer.

20. The labeled specific binding partner according to claim 19, wherein the specific binding partner is an antibody.

21. A method for detecting an analyte in a sample comprising:
providing a sample that is suspected of containing the analyte; and
contacting the sample with a specific binding partner conjugated to a fluorescent polymer as defined in claim 1, wherein the specific binding partner is capable of interacting with the analyte.

22. The method of claim 21, wherein the polymer is a tandem polymer covalently linked to one or more acceptor dyes.

23. The method of claim 21, wherein the binding partner is a protein, peptide, affinity ligand, antibody, antibody fragment, carbohydrate, lipid, nucleic acid or an aptamer.

24. The method of claim 21, wherein the specific binding partner is an antibody, optionally wherein:
a. the method is configured for flow cytometry;
b. the fluorescent polymer is bound to a substrate;
c. the analyte is a protein expressed on a cell surface;
d. the method is configured as an immunoassay; or
e. the method further comprises providing additional specific binding partners for detecting additional analytes simultaneously.

25. A kit comprising at least one fluorescent polymer according to claim 1.

26. A kit comprising at least one tandem polymer according to claim 14.

27. A kit comprising at least one labeled specific binding partner according to claim 17.
